(19) United States
(12) Patent Application Publication
(10) Pub. No.: US 2026/0093109 A1
(43) Pub. Date: Apr. 2, 2026

(54) APPARATUS AND METHODS FOR AMPLIFYING SCAN ANGLE AND PHASE MODULATION AND APPLICATIONS THEREOF

(71) Applicant: The Regents of the University of California, Oakland, CA (US)

(72) Inventors: Spencer LaVere Smith, Santa Barbara, CA (US); Che-Hang Yu, Santa Barbara, CA (US)

(21) Appl. No.: 19/257,338

(22) Filed: Jul. 1, 2025

Related U.S. Application Data
(60) Provisional application No. 63/676,267, filed on Jul. 26, 2024.

(51) Int. Cl. G02B 26/10; G02B 26/08

(52) U.S. Cl. CPC G02B 26/101; G02B 26/0833

(57) ABSTRACT

Systems are provided for amplifying the maximum scan angle of a beam scanner without compromising the scan frequency or the size of the mirror aperture. Some design yields a two-fold increase in scan angle, while in others, an N-fold (e.g. 4-fold) increase is possible. Similar concepts can be employed to produce phase doublers or phase multipliers that double or otherwise increase the phase shift of a wavefront reflected from a phase modulator such as a liquid crystal spatial light modulator or deformable mirror.

### CROSS-REFERENCE TO RELATED PATENT APPLICATIONS

This application claims the benefit of priority of U.S. Provisional Application No. 63/676,267 titled “APPARATUS AND METHODS FOR AMPLIFYING SCAN ANGLE AND PHASE MODULATION AND APPLICATIONS THEREOF,” filed Jul. 26, 2024. The entirety of each application referenced in this paragraph is incorporated herein by reference.

### FEDERALLY SPONSORED RESEARCH OR DEVELOPMENT

This invention was made with Government support under MH-136563 awarded by The National Institutes of Health. The Government has certain rights in the invention.

### BACKGROUND

### Field

The present disclosure relates generally to scanning light beams, for example, scanning a laser beam with a rotating mirror, such as employed in laser scanning microscopy, as well as modulating the phase of light beams, for example, with a deformable mirror, liquid crystal spatial light modulator, MEMs mirrors, etc., and systems and methods related thereto.

### Description of the Related Art

The capability to image in vivo at a high speed and with a large field of view has been of interest in microscopies, including laser scanning microscopy. In many laser scanning microscopes, the scan of laser beam has been achieved using galvanometer scan mirrors, whose scan frequency and scan angle determine the imaging speed and the field of view, respectively.

Operating at a linear (non-resonant) mode, galvanometer scan mirrors can scan the laser beam in a constant speed and stall the beam at any spot within the accessible scan range. To meet the need of the high-speed acquisition, operating the galvanometer scan mirrors at a resonant mode can increase the scan frequency by 4-fold or beyond. In order to pursue an even higher imaging speed, a smaller range of the scan angle may be used to increase the scan frequency; however, this approach has a trade-off, a reduced field-of-view. Due to the trade-offs between the scan frequency and the scan angle of the resonant scan mirrors, increasing the imaging speed and the field-of-view simultaneously is difficult to achieve. In addition, inertia also imposes a trade-off between the size of the scan mirror and the scan frequency.

Therefore, there remains a need for increasing the scan angle without reducing the scan frequency, or vice versa.

### SUMMARY

The present disclosure relates generally to methods and apparatus of increasing the scan angle of a laser scanner. Various methods, devices and systems described herein, for example, include a passive unit such as a passive add-on unit that increases, e.g., doubles, the scan angle range of laser scan engines. Such can be accomplished in an inertia-free manner (e.g., without reducing the size of the mirror in order to increase the scan rate) and maintain the cycle time.

With various designs provided herein, the scan angle may be increased without decreasing the size of mirror to preserve scan rate. Reducing the mirror size, for example, to maintain the scan rate when the scan angle is increased can results in the net reduction in etendue, which make it difficult to achieve a high NA and a large field-of-view simultaneously. Various designs described herein achieve large field-of-view by increasing the scan angle. Yet scan rates are maintained without needing to reducing mirror size. Compact angle doublers, implemented with dispersion-free or wavelength independent components, having diffraction limited performance across a wide scan angle over a broad wavelength bandwidth (e.g., from visible band to near infrared such as from 350 nm to 2000 nm) can be realized. Whether half angle or full angle, the angle over which the beam is scanned can be doubled by the angle doublers described herein. Adapted from angle doubling, a phase doubling unit can increase (e.g., double) the maximal phase range of the phase modulators. Additionally, an angle multiplier that can increase the scan angle by N times, where N is an integer such as 2, 3, 4, etc. is also described. Whether half angle or full angle, the angle over which the beam is scanned can be multiplied by N by the angle multipliers described herein.

For example, in one design, a beam scanner comprising a first reflective optical element, a first lens, and a second reflective optical element. The first reflective optical element is disposed to receive a light beam and reflect the light beam a first time. The first reflective optical element is configured to cause the light beam reflected therefrom the first time to be scanned over first range of angles. The first lens is disposed to receive the light beam reflected from the first reflective optical element such that the light beam is transmitted through the first lens. The second reflective optical element is disposed to receive the light beam transmitted through said first lens and to reflect said light back to said first lens such that the light is transmitted through the first lens back to the first reflective optical element to be reflected therefrom a second time thereby being scanned over a second range of angles larger than the first range of angles.

Also disclosed herein, is a phase modulation system comprising a phase modulator, a first lens and a reflective optical element. The phase modulator is disposed to receive a light beam a first time and is configured to impart different phase shifts on different portions of the light beam. The first lens is disposed to receive the light beam from the phase modulator such that the light beam is transmitted through the first lens and exits the first lens. The reflective optical element is disposed to receive the light beam from the first lens and to reflect the light back to the first lens such that the light that is transmitted through the first lens is transmitted through the first lens back toward the phase modulator a second time. The phase shift of the phase modulator causes the light received and modulated by the phase modulator the second time to have phase shifts larger than the phase shifts imparted by the phase modulator the first time.

Also disclosed herein, is a beam scanner comprising a first reflective optical element, a first lens, a second lens, and a second reflective optical element. The first reflective optical element is disposed to receive a light beam and reflect the light beam a first time. The first reflective optical element is configured to cause the light beam reflected therefrom the first time to be scanned about a first axis directed in a first direction over a first range of angles. The first lens is disposed to receive the light beam reflected from the first reflective optical element such that the light beam is transmitted through the first lens. The second lens is disposed to receive the light beam from the first lens such that the light beam is transmitted through the second lens. The second reflective optical element is disposed to receive the light beam from the second lens and to reflect the light back to the second lens. The first and second lenses are aligned with respect each other such that the light beam reflected off the second reflective optical element to the second lens is transmitted through the second lens and propagates onto and through the first lens such that the light beam is transmitted through the second lens and the first lens back to the first reflective optical element to be reflected therefrom a second time. The second reflective optical element is tilted about a second axis that is directed along a different second direction than said first direction of the first axis.

Also disclosed herein, a beam scanner comprising first and second reflective surfaces facing different directions and a plurality of reflectors. The first reflective surface is disposed to receive a light beam and reflect the light beam. The first reflective surface is configured to cause the light beam to be scanned through a first range of angles. The plurality of reflectors is arranged to reflect the light beam reflected from the first reflective surface to the second reflective surface. The second reflective surface is configured to cause the light beam reflected from the second reflective surface to be scanned over a second range of angles larger than the first range of angles.

Other designs are also disclosed herein.

### BRIEF DESCRIPTION OF THE DRAWINGS

The drawings described herein are for illustrative purposes only of selected embodiments and not all possible implementations and are not intended to limit the scope of the present disclosure.

Corresponding reference numerals indicate corresponding parts throughout the several views of the drawings.

FIG. 1 is a schematic view of an example of laser scanning microscope comprising a laser, a beam scanner or scan engine, a microscope objective and a detector.

FIGS. 2A and 2B are schematic drawings of scanning mirrors used in an example scan engine to scan a laser beam. FIGS. 2A and 2B illustrate how rotation of one of the mirrors by an angle, Δθ, causes a deflection of the beam by an angle, 2Δθ.

FIGS. 3A-3C are schematic drawings of a beam scanning system including an angle doubler or angle doubling unit. The beam scanning system comprises a first reflective optical element, a scanning mirror configured to rotate and scan the light beam. The beam steering system further comprises an angle doubler comprising first and second lenses forming an afocal relay (e.g., a 4-f relay) and a second reflective optical element, e.g., a second mirror. FIGS. 3A-3C illustrate how rotation of the first scanning mirror by ±Δθ results in a beam deflection of ±4Δθ (e.g., for the chief ray).

FIG. 4 is a schematic representation of light incident on and reflecting from a scanning mirror illustrating the angle convention used for the derivation presented.

FIG. 5A depicts a configuration for measuring the amount of beam deflection caused by rotating the first scanning mirror.

FIG. 5B is a plot on axes of displacement after angle doubling (in units of millimeters) versus displacement before angle doubling (also in units of millimeters) produced by optically modeling an angle doubler such as described herein. The plot shows the amount of resultant deflection produced by rotating the first scanning mirror thereby demonstrating the angle doubling achieved by the beam scanning system presented herein.

FIG. 6 is a schematic illustration of a laser scanning microscope including the beam scanning system comprising the angle doubler such as in FIGS. 3A-3C and 5A.

FIG. 7A is a schematic perspective view of a beam scanning system comprising an angle doubler comprising a retroreflector such as a roof mirror.

FIG. 7B is a schematic perspective view of a beam scanning system comprising an angle doubler comprising a telecentric lens.

FIG. 7C is a schematic perspective view of a beam scanning system comprising an angle doubler comprising a curved mirror such as a parabolic mirror.

FIG. 8A is a schematic perspective view of a beam scanning system comprising a first scanning mirror and a beam multiplier comprising first and second lenses and a second mirror tilted a fixed amount with respect to the first and second lenses and/or a central axis (e.g., axis of symmetry) and/or an optical axis thereof.

FIG. 8B is a schematic view illustrating the scanning of the beam propagating within the angle multiplier of FIG. 8A for different passes through the angle multiplier.

FIG. 8C is a schematic perspective view of a beam scanning system comprising a first scanning mirror and a beam multiplier comprising first and second lenses and a second mirror, wherein the optical axes or central axes (e.g., axes of symmetries) of the first and second lenses are offset laterally with respect to each other.

FIG. 9 is a schematic illustration of a phase modulation system comprising a phase modulator and a phaser doubler comprising first and second lenses and a mirror.

FIGS. 10A-10C depict another angle doubler design that employs a reflective optical relay (instead of a lens relay) thereby reducing the effects of chromatic dispersion. A two-sided mirror having first and second sides, both configured to reflect light, is rotated to provide a scanning beam. An input beam reflects off the first side of the rotating two-sided mirror to a plurality of reflective optics configured to direct the beam reflected off the first side of the double-sided mirror to the second side of the two-sided mirror to reflect off the second side as well. With reflection off both the first and the second sides of the two-sided mirror, the effect of rotation of the double-sided mirror is doubled.

FIG. 10A shows the double-sided mirror in an angular position so as to direct the light beam to the left on the image plane.

FIG. 10B shows the double-sided mirror in an angular position so as to direct the light beam to a central location on the image plane.

FIG. 10C shows the double-sided mirror in an angular position so as to direct the light beam to the right on the image plane.

### DETAILED DESCRIPTION

As discussed above, many commercial resonant scanning mirrors sacrifice scan angle to provide increased in scan frequency. Furthermore, some commercial resonant scanning mirrors use decreasing mirror sizes to provide for increased scan frequencies increase.

This trade-offs among mirror size, scan angle, and scan frequency may be considered an unavoidable limitation of the physics law due to the inertia. Accordingly, fundamental laws oppose the design and construction a resonant scanner with a 4-30 kHz (e.g. 12 kHz) scan frequency, a scan angle of ±3 to ±30, e.g., a ±5 degree scan angle, and a metal coated mirror having a diameter of 3-15 mm, e.g., 5 mm. However, as described herein, a passive add-on may amplify the scan angle beyond a resonant scanner's built-in and/or maximum scan angle. This process of amplification of the scan angle is independent of the scan frequency and the mirror size.

Provided herein is approach for amplifying the scan angle, e.g., maximal scan angle, of a beam scanner comprising a mirror scanner such as a resonant scanner without compromising the scan frequency of the scanner nor the size of the mirror aperture. In particular, an example scan angle amplification unit is described and shown to increase the scan angle of a galvanometer (linear and resonant) scanner by a factor of two and possibly more. Such an angle doubling unit or angle multiplying unit can be incorporated into a laser scanning microscope or system that employs laser scanning such as a laser scanning confocal microscope, a two-photon microscope, a three-photon microscope, a harmonics generation microscope, a stimulated Raman scattering microscope, a coherent anti-stoke Raman scattering microscope, a photoacoustic microscope, a light sheet microscope, an optical coherent microscope, or a system for 3D printing/polymerization/machining or ranging with laser illumination. The angle doubler and multiplier can be used for galvanometer scanners, linear scanners, and resonant scanners that may oscillate, e.g., back and forth, as well as polygonal mirrors that revolve, e.g., unidirectionally, as well as potentially other types of scanning mirror or reflector configurations. Other reflectors may include MEMs mirrors as well as dual scan mirrors or 2-D scan mirrors. Control electronics may provide signals to control the scanning of the mirror, which may scan over a range of angles and cause the light reflected from such mirror to scan over a range of angles. Furthermore, the angle doubler and multiplier can be used beyond microscopy, such as for laser remote sensing, laser machining, laser polymerization and other applications where laser scanners are employed. The devices, systems and methods described herein may be employed in imaging applications, for example, that utilize beam scanning, 3D imaging, in LIDAR (light detection and ranging), in medical applications such as medical imaging or diagnostics, and medical treatment that use laser and/or light beams including in ophthalmology, in displays in 3D printing, laser cutting, welding and/or treating or processing materials although other applications are possible.

In one example, such an angle doubler unit is shown to amplify the maximal scan angle of a 12-kHz resonant scanner two-fold, e.g., from ±5 degrees to ±10 degrees. This example imaging system can be raster scanned across a square field-of-view up to 1.05×1.05 mm after angle doubling, using a 16×/0.8 NA water immersion objective at a frame rate of 45 frames per seconds (512×512 pixels per frame). Various implementations of the angle doubler design comprise a folded, compact architecture that can be readily constructed with off-the-shelf components and can have diffraction limited performance across the doubled scan angle. Furthermore, some implementations of the folded, compact angle doubler may comprise all reflective components and surfaces thereby reducing wavelength dispersion while other implementations employ refractive elements such as lenses. Both options are available and can provide diffraction limited performance over a wide spectrum such as from 900 nm-1300 nm and possibly beyond. Variations are possible. As discussed herein below, lenses, mirrors, curved mirrors, retroreflectors (e.g., roof prism mirrors), etc., may potentially be employed in the design. In some configurations, increases in scan angle beyond a factor of two may be achieved by an angle multiplier, for example, comprising a plurality of lenses and a tilted reflector. For example, a 4-fold increase in scan angle may be provided, although the scan angle can be increased more or less. Additionally, the concept of angle doubling is applied to a phase modulator to produce a phase doubler that doubles the phase of the wavefront from a phase modulator (such as a liquid crystal spatial light modulator or deformable mirror). Other designs and applications, however, are possible.

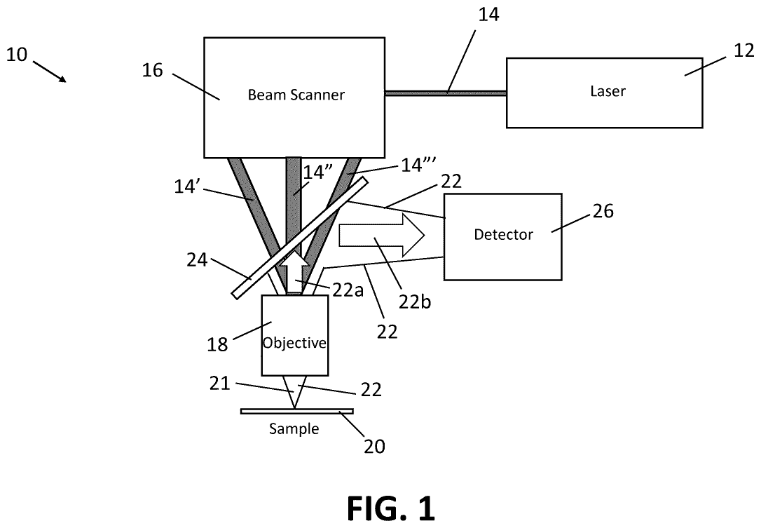

One application for an angle doubler or angle multiplier configured to increase the scan angle of a beam scanning system such as described herein can be employed in a laser scanning microscope. A schematic block diagram of a laser scanning microscope 10 is presented in FIG. 1. The laser scanning microscope 10 includes a laser light source, e.g., a laser, 12 which may comprise, for example, a solid-state laser or fiber laser or other type of laser. The laser 12 may be a pulsed laser in various implementations and may include a pulse compressor possibly based on chirped pulse compression. A wide variety of options, however, are possible. For example, the light source may also comprise a continuous wave (CW) laser. Additionally, the beam may have different spatial profiles. For example, the laser may be a Gaussian laser that provides a laser beam having a Gaussian spatial distribution, a Bessel laser producing a laser beam with a Bessel spatial profile, an Airy laser producing a laser beam with an Airy spatial light profile or comprise a laser providing another type of beam having a different spatial profile.

The laser 12 is shown outputting a laser beam 14. The laser scanning microscope 10 further comprises a beam scanner or scan engine 16. The laser beam 14 output by the laser 12 is shown being directed to the beam scanner or scan engine 16. As discussed more fully below, the scan engine 16 may include one or more scanning mirrors to deflect the beam 14 in different directions and more particularly to scan the beam across a range of angles. Laser beams 14′, 14″, 14′″ output at different angles are used to illustrate the capability of the beam scanner 16 to redirect the laser beam 14 in different directions and, namely, at different angles. The beam scanner 16 may be controlled by control electronics configured to drive motor or actuators to move, e.g., rotate, the mirror(s). In various implementations, the mirror(s) may rotate (e.g., tip or tilt) back and forth or may rotate around (e.g., revolve) through 360° degrees.

The laser scanning microscope 10 further includes a microscope objective 18 configured to focus the laser beam 14 input into the microscope objective onto a sample 20. In various implementations, the microscope objective 18 may comprise one or more lenses that together has a focal length such that collimated laser light will be focused down a short distance from the microscope and/or microscope objective onto a sample plane where a sample 20 may be located. The microscope objective 18 may have a positive focal length and positive optical power.

Laser light 21 focused by the microscope objective 18 is incident on a portion of the sample. As a result, the sample 20 may emit, reflect, and/or scatter light 22 therefrom. In the example design shown in FIG. 1, the laser scanning microscope 10 further comprises a beamsplitter 24 disposed with respect to the microscope objective 18 such that light 22 from the sample 20 is incident thereon and directed (e.g., reflected) to an optical sensor or detector 26 configured to detect the light and/or quantify the amount of light from the sample. Arrows 22a and 22b illustrate the propagation of the light 22 from the sample 20 to and off the beamsplitter 24 and onward to the optical detector 26. In the example shown, the beamsplitter 24 also transmits the light beam 14, 14′, 14″, 14′″ from laser 12 scanned by the beam scanner or scan engine 16 through a range of angles. In various implementations the beamsplitter 24 is a dichroic beamsplitter, reflecting a first wavelength or group of wavelengths and transmitting a second wavelength or group of wavelengths. Although in the example shown, the beamsplitter 24 is transmissive to the wavelength of light 14 from the laser 12, and reflects the light 22 from the sample 20, in other designs, the beamsplitter may reflect the light 14 from the laser 12 and transmit light from the sample. Still other variations are possible.

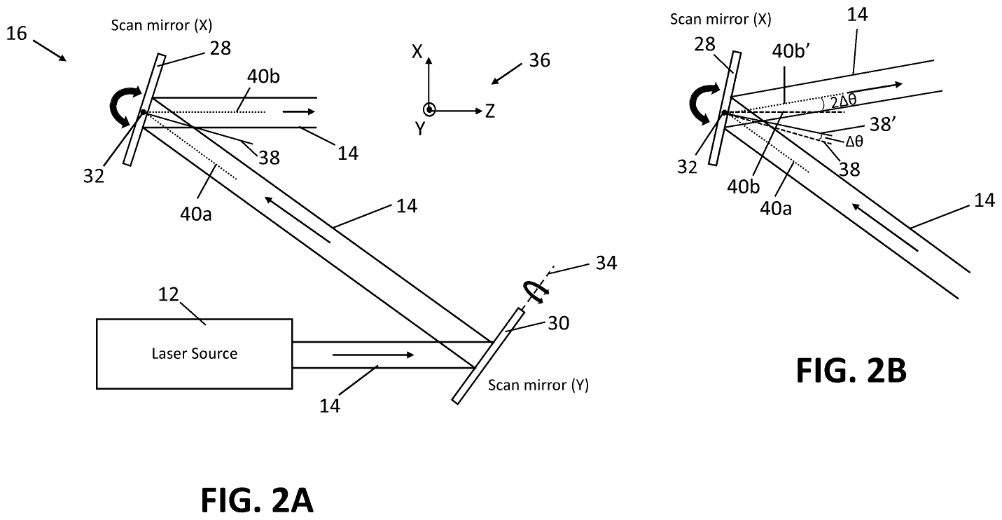

FIGS. 2A and 2B show how the beam scanner or scan engine 16 may be configured in various implementations. As illustrated in FIG. 2A, the beam scanner or scan engine 16 may comprise X and Y beam steerers 28, 30 comprising scanning mirrors configured to scan the beam 14 in orthogonal X and Y directions. An X, Y, Z coordinate system 36 is shown in FIG. 2A for reference. In FIGS. 2A and 2B, scanning in the X direction corresponds to scanning within the plane of the paper while scanning in the Y direction corresponds to scanning out of and/or into the paper. Scan axes 32, 34 about which the mirrors 28, 30 are scanned are also shown. As illustrated, these scan axes 32, 34, which are also out of the paper and parallel to the plane of the paper, respectively, are orthogonal to each other and to the direction of the scans. Consequently, one mirror 28 can scan the beam 14 such that the beam sweeps out an angle and scans in the X direction while the other mirror 30 sweeps out an angle in the orthogonal direction and scans in the Y direction.

A comparison of FIGS. 2A and 2B illustrate how rotating the scan mirror 28 by an amount Δθ results in a deflection of the beam by an angle 2Δθ. This range of angles through which this beam is deflected upon being reflected once from the scanning mirror may be referred to herein as Δθ_{beam}. In this example, Δθ_{beam}=2Δθ. (As referred to herein, Δθ and Δθ_{beam} represents a change in angle, regardless of whether the scan is symmetric or asymmetric, e.g. ±10° or −5° to +15°. However, the scan may be symmetric about some reference, reference line or axis and thus be referred to as ±Δθ, +2Δθ, or ±Δθ_{beam}, in some cases). FIG. 2A, for example, shows a normal 38 to the scan mirror 28 and incident and reflected beam directions 40a, 40b. Consistent with Snell's law of reflection, the angle of incidence as measured with respect to the normal 38 is equal to the angle of reflection.

In FIG. 2B, the mirror 28 is rotated slightly producing a new normal 38′ and a causing the beam to be reflected in a different direction 40b′. FIG. 2B shows both the normal 38 to the mirror 28 prior to being rotated as well as the normal 38′ to the mirror when rotated. FIG. 2B also shows both the beam direction 40b prior to the mirror 28 being rotated as well as the beam direction 40b′ with the mirror rotated. A comparison between the angular change in the normal 38, 38′ with mirror rotation and the angular change in the beam direction 40b, 40b′ with mirror rotation shows that a change in the angle of the mirror, Δθ, results in a change in beam direction of twice that amount, e.g., Δθ_{beam}=2Δθ.

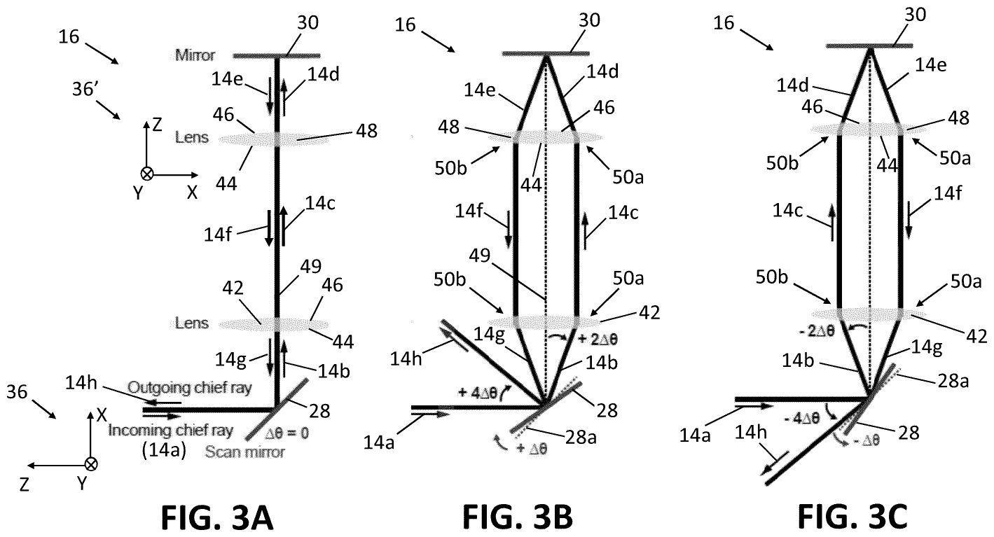

The scan doubler described herein can increase that change in beam direction, 2Δθ, by another factor of two such that the resultant change in angle of the beam is, for example, 4Δθ. FIGS. 3A-3C illustrate this additional two-fold increase in scan angle.

FIGS. 3A-3C, for example, depict a beam scanner 16 comprising first and second reflective optical elements or reflectors (e.g., mirrors) 28, 30 and first and second lenses 42, 48. The first reflective optical element or reflector 28 may comprise a beam steerer such as a scanning mirror. The first reflective optical element 28 may be configured to be scanned through the range of angles, Δθ. (As discussed above, Δθ represents a change in angle, regardless of whether the scan is symmetric or asymmetric with respect to a particular direction, e.g. ±20° or −15° to +25°. However, the scan may be symmetric about some reference, reference line or axis and thus be referred to as ±Δθ or ±2Δθ in some cases.) In various implementations, the first reflective optical element 28 may be scanned in the lateral direction, e.g., within a plane parallel to the X-Z plane shown in FIGS. 2A and 3A. However, in other designs, the first reflective optical element 28 may be scanned in other directions, e.g., within a plane parallel to the Y-Z plane. Still other variations are possible.

In various implementations, the first reflective optical element or reflector 28 may be mounted or secured to a rotatable mount, stage, platform, base, or other support, for example, rotating rod, axel, column, etc. configured to rotate (e.g., tilt, tip, and/or spin) the first reflective optical element. In various designs, the first reflective optical element or mirror 28 is attached to, and/or supported by a mount, stage, platform, base or support (e.g., rod, axel, column, etc.) having a galvanometer, linear scanner, resonant scanner, motor or actuator (e.g., piezoelectric actuator) configured to rotate (e.g., tilt, tip and/or spin) the first reflective optical element. Accordingly, in various implementations, the first reflective optical element or reflector 28 may be scanned using a galvanometer, linear scanner, resonant scanner, motor, or actuator (e.g., piezoelectric actuator) configured to rotate (e.g., tilt, tip and/or spin) the first reflective optical element. The first reflective optical element 28 may, for example, be mounted on or otherwise attached to the galvanometer, linear scanner, resonant scanner, motor or actuator (e.g., piezoelectric actuator) such that the first reflective optical element/reflector can rotate (e.g., tilt, tip and/or spin) the first reflective optical element to scan the first reflective optical element/reflector through the range of angles, Δθ. As discussed above, the devices, systems, and methods described herein are applicable to a wide range of rotating (tilting, tipping and/or revolving) reflectors or mirrors including but not limited to rotating polygonal mirror (e.g., that rotate around multiple or many times such as at high speeds), dual scan mirrors, dual axis scanner, or 2-D scan mirrors, MEMs (microelectromechanical systems) mirrors or movable singular mirrors or mirrors in mirror arrays whether on centimeter scale, millimeter scale, micrometer scale, or nanometer scale. In various implementations, such scanning of such reflectors or mirrors may be controlled by control electronics configured to drive motor or actuators to move, e.g., rotate, the mirror(s). In various implementations, the mirror(s) may rotate (e.g., tip or tilt) back and forth or may rotate around (e.g., revolve) through 360° degrees.

As discussed above, the first reflective optical element or reflector 28 may comprise a mirror. In various implementations, the mirror comprises a metal reflecting surface for reflecting the incident light beam 14 although other types of mirrors such as dielectric mirrors comprising dielectric material, e.g., with reflective dielectric coatings such as interference coatings, may be employed. In various implementations, the first reflective optical element 28 is a planar scanning mirror. The planar mirror may have a planar optical surface configured to reflect light incident thereon. Such reflection will be governed by Snell's law of reflection in various implementations. The angle of reflection will be the same as the angle of incidence, for example, as measured with respect to the normal to the mirror. As discussed above in connection with FIGS. 2A and 2B, the mirror 28 may rotate, e.g., through an angle range, Δθ, and cause a light beam incident thereon to be reflected or deflected through an angle 2Δθ.

The first reflective optical element or reflector 28 may comprise a resonant scanning mirror although the mirror or mirror scanner (e.g., galvanometer, polygonal mirror, dual axis scanner or 2-D scan mirror, etc.) need not be operated in resonance. Nevertheless, in various implementations, the first reflective optical element 28 may be configured to scan through the first range of angles, Δθ, at a scan rate of at least 1 kHz. The first reflective optical element may, for example, be scanned at a scan rate of at least 50 Hz, 100 Hz, 200 Hz, 500 Hz, 750 Hz, 1 kHz, 2 kHz, 3 kHz, 4 kHz, 5 kHz, 6 kHz, 8 kHz, 9 kHz, 10 kHz, 12 kHz, 15 kHz, 16 kHz, 18 kHz, 20 kHz, 24 kHz, 25 kHz, 30 kHz, 35 kHz, 40 kHz, 45 kHz, 50 kHz, 60 kHz, 70 kHz, 75 kHz, 80 kHz, 90 kHz, 100 kHz, 120 kHz, or in any range formed by any of these values or possible at faster or slower rates. As discussed above, in various implementations, such scanning of such reflectors or mirrors may be controlled by control electronics configured to drive motor or actuators to move, e.g., rotate, the mirror(s). In various implementations, the mirror(s) may rotate (e.g., tip or tilt) back and forth or may rotate around (e.g., revolve) through 360° degrees.

The second reflective optical element or reflector 30 also may comprise a mirror. In various implementations, the mirror comprises a metal reflecting surface for reflecting the incident light beam 14 although other types of mirrors such as dielectric mirror comprising dielectric material, e.g., with reflective dielectric coatings such as interference coatings, may be employed. In various implementations, the second reflective optical element 30 is a planar mirror. The planar mirror may have a planar optical surface configured to reflect light incident thereon. Such reflection will be governed by Snell's law of reflection in various implementations. The angle of reflection will be the same as the angle of incidence, for example, as measured with respect to the normal to the mirror.

In some designs, the second reflective optical element or reflector 30 is not configured to scan (e.g., at a rate of at least 2 Hz, 5 Hz, 10 Hz, 20 Hz, 50 Hz, 100 Hz, or 200 Hz, or 500 Hz, or 750 Hz, or 1 kHz, 5 kHz, or 10 kHz, or 20 kHz or 30 kHz or 40 kHz or 50 kHz or 60 kHz or 70 kHz or 80 kHz or 90 kHz or 100 kHz or any range formed by any of these values or possible larger or smaller values) or is not configured to scan along the same direction or within the same plane as the first reflective optical element 28 (e.g., at a rate of at least 2 Hz, 5 Hz, 10 Hz, 20 Hz, 30 Hz, 40 Hz, 50 Hz, 100 Hz, or 200 Hz or 500 Hz, or 750 Hz, or 1 kHz, 5 kHz, or 10 kHz, or 20 kHz or 30 kHz or 40 kHz or 50 kHz or 60 kHz or 70 kHz or 80 kHz or 90 kHz or 100 kHz or any range formed by any of these values or possible larger or smaller values). For example, in some designs the second reflective optical element 30 comprises a non-scanning reflector or mirror. In some implementations, the mirror may be mounted on a mount or support configured to tip and/or tilt, for example, to adjust orientation, however, the mount or mirror may not be configured to scan, e.g., at a rate of at least 2 Hz, 5 Hz, 10 Hz, 20 Hz, 30 Hz, 40 Hz, 50 Hz, 100 Hz, 200 Hz, 300 Hz, 400 Hz, 500 Hz, 600 Hz, 750 Hz, 800 Hz, 1 kHz, 5 kHz, or 10 kHz, or 20 kHz or 30 kHz or 40 kHz or 50 kHz or 60 kHz or 70 kHz or 80 KHz or 90 kHz or 100 kHz or any range formed by any of these values or possible larger or smaller values. Use of a non-scanning mirror may, for example, simplifies the angle doubler 16. In some such cases, the scan doubler 16 may be referred to as a passive device or passive add-on device. The angle doubler 16 may comprise solely static optics in some such implementations. The second reflective optical element or reflector 30 and the static first and second lenses 42, 48 may, for example, comprise static optics not scanned by applying electrical signals to motors, galvanometers, actuators (e.g., piezoelectric actuator such as a bimorph), etc., for example, to rotate (e.g., tilt, tip, revolve, etc.) and/or move the optical elements. Such static optical elements may be added as an add-on, e.g., a passive add-on, to a laser scanner 16 comprising the first reflective optical element or reflector 28, which may comprise a scanning mirror, e.g., a mirror mounted on a rotation mount comprising a motor, galvanometer, actuator, (e.g., piezoelectric actuator such as a bimorph) etc., that receives an electrical signal from electronic circuitry such as control electronics to accomplish scanning.

In some designs, however, the second reflective optical element or reflector 30 may be configured to be scanned through a range of angles. The second reflective optical element 30 may, for example, be scanned in a direction orthogonal to the scan direction of the first reflective optical element 28, for example, to provide a raster scan. For example, in various implementations, when the first reflective optical element 28 is scanned in the lateral direction, e.g., within a plane parallel to the X-Z plane, the second reflective optical element 30 may, be scanned in the vertical direction, e.g., within a plane parallel to the Y-Z plane shown in FIGS. 2A and 3A. Such a configuration where two mirrors are arranged to scan in orthogonal directions is shown in FIG. 2A. Scanning of the first and second reflective optical elements 28, 30 in orthogonal directions may for example facilitate scanning of a laser beam 14 across an area of the sample 20 in a laser scanning microscope 10. The first and second reflective optical elements 28, 30 scanning in orthogonal directions may, for example, cause the laser beam 14 to raster scan in orthogonal (e.g., X and Y) directions across the sample 20. In other designs, however, the second reflective optical element 30 may be scanned in other directions, e.g., within a plane parallel to the X-Z plane. For example, the second reflector 30 can be configured to rotate along the same direction as the first reflective optical element or reflector 28. Such a configuration can shift the center around which the first reflective optical element/reflector 28 scans. Still other variations are possible.

Accordingly, in various implementations, the second reflective optical element or reflector 30 may be mounted or secured to a rotatable mount, stage, platform other support configured to rotate the second reflective optical element. In various designs, the second reflective optical element/reflector 30 is attached to, and/or supported by a stage, mount, platform, base or support having a galvanometer, linear scanner, resonant scanner, motor, actuator (e.g., piezoelectric actuator such as a bimorph) configured to rotate (e.g., tilt, tip or revolve) the first reflective optical element. Accordingly, in various implementations, the second reflective optical element or reflector 30 may be scanned using a galvanometer, linear scanner, resonant scanner, motor, actuator, (e.g., piezoelectric actuator such as a bimorph) etc. configured to rotate (e.g., tilt, tip, or revolve) the second reflective optical element. The second reflective optical element 30 may, for example, be mounted on or otherwise attached to the galvanometer, linear scanner, resonant scanner, motor, actuator (e.g., piezoelectric actuator) such that the second reflective optical element can rotate (e.g., tip, tilt, or revolve) the second reflective optical element to scan the second reflective optical element through the range of angles. As discussed above, the second reflective optical element could also comprise a MEMs mirror or dual axis mirror or a polygonal mirror or other types of mirrors or beam steerers. The second reflective optical element or reflector 30 could be a dual axis mirror, for example, with one axis tilting around the same direction as the element 28 to shift the center of the scan, and with the orthogonal axis scanned to form a raster scan.

The second reflective optical element or reflector 30 may comprise a resonant scanning mirror although the mirror or mirror scanner (e.g., galvanometer, motor, actuator, piezo electric actuator, etc.) need not be operated in resonance. Nevertheless, in various implementations, the second reflective optical element 30 may be configured to scan through said second range of angles, Δθ, at a scan rate of at least 2 Hz, 5 Hz, 10 Hz, 20 Hz, 30 Hz, 40 Hz, 50 Hz, 100 Hz, 200 Hz, 500 Hz or 750 Hz or 1 kHz. The second reflective optical element 30 may, for example, be scanned at a scan rate of at least 2 Hz, 5 Hz, 10 Hz, 20 Hz, 30 Hz, 40 Hz, 50 Hz, 100 Hz, 200 Hz, 500 Hz, 750 Hz, 1 kHz, 2 kHz, 3 kHz, 4 kHz, 5 kHz, 6 kHz, 8 kHz, 9 kHz, 10 kHz, 12 kHz, 15 kHz, 16 kHz, 18 kHz, 20 kHz, 24 kHz, 25 kHz, 30 kHz, 35 kHz, 40 kHz, 45 kHz, 50 kHz, 60 kHz, 70 kHz, 75 kHz, 80 kHz, 90 kHz, 100 kHz, 120 kHz or in any range formed by any of these values or possible at faster or slower rates. As discussed above, in various implementations, such scanning of such reflectors or mirrors may be controlled by control electronics configured to drive motor or actuators to move, e.g., rotate, the mirror(s). In various implementations, the mirror(s) may rotate (e.g., tip or tilt) back and forth or may rotate around (e.g., revolve) through 360° degrees.

In the design shown in FIGS. 3A-3C, the first and second lenses 42, 48 are disposed in an optical path between the first and second reflective optical elements/reflectors 28, 30. In some implementations, the first lens 42 is positioned a distance from the first reflective optical element 28 corresponding to the focal length of the first lens. For example, in some configurations, the first lens 42 is positioned a distance from the axis of rotation of the first reflective optical element 28 corresponding to the focal length of the first lens. Similarly, in some implementations, the second lens 48 is positioned a distance from the second reflective optical elements 30 corresponding to the focal length of the second lens. For example, in some configurations, the second lens 48 is positioned a distance from the axis of rotation of the second reflective optical elements 30 corresponding to the focal length of the second lens.

The first and second lenses 42, 48 shown in FIGS. 3A-3C comprise positive lenses. As illustrated, the second lens 48 is not included in an array of lenses and does not comprise an array of lenses. For example, the second lens 48 is not a lenslet in an array of lenslets and does not comprise an array of lenselets. Similarly, the first lens 42 is not included in an array of lenses and is not a lenslet in an array of lenslets. Nor is the first lens 42 an array of lenses or an array of lenslets. Either or both of the first and/or second lenses not being included in a lens array or comprising a lens array, e.g., not comprising a lenslet in a lenslet array or comprising a lenslet array, may increase the field-of-view. In some implementations, the first and second lenses 42, 48 form an optical relay such as an afocal relay. The first and second lens 42, 48 may have first and second focal lengths, respectively, and in some cases, the first and second lens 42, 48 are separated by a distance that is the sum of the first and second focal lengths. In some implementations, the focal lengths of the first and second lenses 42, 48 are the same. Accordingly, in some designs, the first and second lens 42, 48 form a four focal length relay (4-f) although the design should not be so limited. Other types of relays, for example, are possible. An afocal relay, such as a 4-f relay, provides that an incoming collimating beam exits the relay as a collimated beam as well. Non-afocal relays may also be employed. For example, such a relay may amplify the exit beam angle, but the outgoing beam might not be collimated.

In the examples shown in FIG. 3A-3C, the first lens 42 has an optical axis and/or central axis (e.g., axis of symmetry) 49. Similarly, the second lens 48 has an optical axis and/or central axis (e.g., axis of symmetry) 49. In the example, shown the optical axes or central axes (e.g., axes of symmetry) 49 of the first and second lenses 42, 48 are coincident and will thus be referred to as the optical axis or central axis. As illustrated in FIG. 3A, this optical axis or central axis is parallel to the Z axis in the XYZ coordinate system 36′, which is proximal the second mirror 30. (Note that two XYZ coordinate systems 36, 36′ are shown in FIG. 3A. In the first XYZ coordinate system 36, the Z axis is aligned with the direction of propagation of the input light beam or portion thereof (e.g., a ray such as the chief ray) 14. In the second XYZ coordinate system 36′, the Z axis is aligned with the direction of propagation of the light beam or portion thereof (e.g., a ray such as the chief ray) 14 between the first and second lenses 42, 48 and toward the second mirror 30.) In the example shown, the second mirror 30 is planar and has a normal that is within the same plane (e.g., Y-Z plane of the second XYZ coordinate system 36′ or plane parallel thereto) and/or coincident with the central axis or optical axis 49 of the first and second lenses 42, 48. In some examples where the second mirror 30 is static, the normal to the second mirror may be coincident with the central and/or optical axis 49 of the lenses 42, 48. In the case where the second mirror 30 is rotated so as to scan the light beam 14, for example, in the Y-Z plane of the second XYZ coordinate system 36′ or in a plane parallel thereto, the normal to the second mirror is in the same plane (e.g., Y-Z plane or plane parallel thereto) as the central axis or optical axis 49.

In the examples shown in FIG. 3A-3C, the first reflective optical element or reflector 28 is disposed to receive a light beam 14 and reflect the light beam a first time. In FIG. 3A-3C, a light ray, the chief ray of a light beam, which is a portion of the beam, is shown propagating the beam scanner 16. Accordingly, this light may be referred to herein interchangeably as the light beam, light beam portion, ray, and/or chief ray or variants thereof.

FIG. 3A shows the light beam or laser beam or portion thereof (e.g., a ray such as the chief ray of light beam) 14a directed toward the first reflector 28. The mirror 28 is oriented to reflect the incident light 14a to the first lens 42. As discussed above, according to Snell's law of reflection, the angle of incidence is equal to the angle of reflection. The first mirror 28 is oriented in this example at a 45° angle with respect to the incident light beam or light beam portion (e.g., ray such as the chief ray of light beam) 14a to reflect the incident light at a 45° angle with respect to the normal to the mirror to direct the light beam or light beam portion (e.g., ray such as the chief ray of light beam) 14b to the first lens 42. As such, a reflected beam 14b or beam portion (e.g., ray such as the chief ray of light beam) is shown incident on the first lens. In the example shown in FIG. 3A, the reflected light 14b propagates along the central or optical axis 49 of the first lens 42 and thus is not refracted by the first lens. The light 14b propagates through the first lens 42 and continues onto the second lens 48 as illustrated by arrow 14c. In the example shown in FIG. 3A, the reflected light 14c propagates along the central or optical axis 49 of the first and second lenses 42, 48 and thus is not refracted by these lenses. The light 14c propagates through the second lens 48 and continues onto the second reflector 30 as illustrated by arrow 14d. The second reflector 30 reflects the light beam 14d incident thereon back to the second lens 48 as indicated arrow 14c. This light 14e is transmitted through the second lens 48 and propagates to the first lens 42 as indicated by arrow 14f. The light beam or light beam portion (e.g., ray such as the chief ray of light beam) 14f is transmitted through the first lens 42 and continues onto the first reflector 28 as indicated by arrow 14g. On this return trip in the example shown in FIG. 3A, the reflected light beam or portion thereof, e.g., ray such as chief ray, 14e, 14f propagates along the central or optical axis 49 of the first and second lenses 42, 48 and thus is not refracted by these lenses. The light beam or light beam portion (e.g., ray such as chief ray) 14g transmitted through the first lens 42 is incident on the first mirror 28 and reflected therefrom as indicated by arrow 14h. In this example shown in FIG. 3A, the first mirror 28 is oriented at a 45° angle with respect to the incident light beam (e.g., ray such as chief ray) 14g to reflect the light beam (e.g., ray such as chief ray) 14h at a 45° angle with respect to the normal to the mirror. This light beam 14h represents the output of the angle doubler or beam scanner 16.

FIG. 3B shows the effect of rotating the first mirror 28 by an angle A0, for example, to scan the light beam 14h output by the angle doubler 16. In this example, the input light beam or light beam portion (e.g., ray such as chief ray) 14a is incident on the first reflector 28. As discussed above, the first reflector 28 is configured to rotate such that the light beam 14b reflected therefrom the first time is scanned over a first range of angles, 2Δθ. As illustrated in FIG. 3B, the incident light beam or light beam portion (e.g., ray such as chief ray) 14a is angled with respect to the first reflector 28. Pursuant to Snell's law of reflection, given that the light beam 14a is incident on the first reflector 28 at an angle with respect to the first reflector (e.g., the normal thereto), the reflected light beam 14b is also reflected by the same angle with respect to the first reflector (e.g., the normal thereto) as shown. However, as illustrated in FIGS. 2A and 2B, the change in the direction of reflected light beam 14b with respect to the incident light beam 14a will be 2Δθ, where Δθ is the amount that the first mirror 28 is rotated.

As depicted in FIG. 3B, the first lens 42 has a front 44 and back 46 and first and second sides 50a, 50b (see, e.g., FIGS. 3A and 3B) on each of said front and back. As shown in FIG. 3B, the first lens 42 is disposed to receive the light beam or light beam portion (e.g., ray such as chief ray) 14b reflected from the first reflective optical element 28 on the first side 50a of the front 44 of the first lens. The light beam or light beam portion (e.g., ray such as chief ray) 14b is thus transmitted through the first side 50a of the first lens 42 and exits said first side on the back 46 of the first lens as indicated by arrow 14c.

As discussed above, first lens 42 has a central axis (e.g., axis of symmetry) and/or optical axis 49 and a positive focal length in the example shown in FIG. 3B. Furthermore, the first lens 42 is positioned with respect to the first reflective optical element 28 such that the light beam or light beam portion (e.g., ray such as chief ray) 14b reflected off the first reflective optical element to first side 50a of the front 44 of the first lens the first time is incident on the first side of the front of the first lens at an angle, here 2Δθ as shown. Moreover, this light 14b is refracted by the first lens 42 such that the light beam or portion (e.g., ray or chief ray) that is incident on the first side 50a of the front 44 of the first lens exits the first side of the back 46 of the first lens and propagates parallel to said optical axis 49. Arrow 14c represents this light propagating from the first lens 42 to the second lens 48 parallel to the optical axis 49. Also, like the first lens, the second lens also has a front 44 and back 46 and first and second sides 50a, 50b on each of the front and back of the second lens.

This light beam or beam portion (e.g., ray such as chief ray) 14c transmitted through the first lens 42 is incident on the front 44 of the second lens 48 on the first side 50a of the second lens 48. The second lens 48 is disposed to receive the light beam or portion thereof (e.g., ray such as chief ray) 14b reflected off the first reflector 28 the first time that is transmitted through said first side 50a of the front 44 of the first lens 42. The light beam or light beam portion (e.g., chief ray) 14b reflected off the first reflector 28 and transmitted through the first side 50a of the front 44 of the first lens 42 is incident on and transmitted through said first side 50a of said second lens 48.

As discussed above, in the example shown in FIG. 3B, the second lens 48 has a positive focal length. Consequently, the light beam or light beam portion (e.g., ray such as chief ray) 14b reflected off the first reflector 28 that is transmitted through the first side 50a of the front 44 of the first lens 42 and incident on first side of the second lens 48 parallel to the optical axis 49 of the second lens is refracted by the second lens at an angle toward the central axis (e.g., axis of symmetry) or optical axis 49 of the second lens as indicated by the arrow 14d. This light beam or light beam portion (e.g., ray such as chief ray) 14d refracted by the first side 50a of the second lens 48 is incident on the second reflector 30 at an angle, e.g., 2Δθwith respect to the normal, due to the symmetry of the system, e.g., the first and second lenses 42, 48 having the same focal length and optical power and the distance to and from the first and second reflectors 28, 30 being the same as the respective focal lengths. Pursuant to Snell's law of reflection, the light beam or light beam portion (e.g., ray such as chief ray) 14e is reflected from the second reflector 30 at this angle of incidence, 2Δθ, with respect thereto.

The second reflector 30 reflects the light beam or light beam portion (e.g., ray such as chief ray) 14e back to the second lens 48, this time on the second side 50b of the back 46 of the second lens. As discussed above, this light beam or light beam portion (e.g., ray such as chief ray) 14e reflected from the second reflector 30 at an angle, e.g., 2Δθ, with respect thereto is incident on the second side 50b of the second lens 48 at this angle, 2Δθ. This light 14c transmitted through the second lens 48, is refracted by the second positive powered lens, in this example, such that the light beam or light beam portion (e.g., ray such as chief ray) 14f exiting second lens (a second time) is parallel to the optical axis 49 of the second lens. Again, due to the symmetry of the system, for example, the first and second lenses 42, 48 having the same focal length and/or optical power and the distance to and from the first and second reflectors 28, 30 being the same as the focal lengths, the light beam or light beam portion (e.g., ray such as chief ray) 14e is refracted an amount to cause the light 14f to be parallel to the central axis (e.g., axis of symmetry) and/or optical axis 49 of the second lens 48. This light beam or light beam portion (e.g., ray such as chief ray) 14f is propagated to back to the first lens 42, this time though, the light is incident on the second side 50b of the first lens. As shown, this light beam or light beam portion (e.g., ray such as chief ray) 14f is incident on the first lens 42 parallel to the central axis (e.g., axis of symmetry) and/or optical axis 49 of the first lens.

As discussed above, the first lens 42 has positive optical power and in the example shown, the distance from the first reflector 28 corresponds to the focal distance of the first lens. This first lens 42 thus transmits and refracts this light 14f such that the light beam 14g that exits the first lens (a second time) is incident on said first reflector 28 at an angle, e.g., 2Δθ. Likewise, this light beam 14g is reflected off the first reflector 28 this second time, because of the rotation of the first reflector, at an angle. Although the angle of the reflected beam 14f as measured with respect to the normal of the mirror 28 will be equal to the angle of incidence as measure with respect to the normal, the direction of the reflected beam as measured with respect to the original beam will be greater. As illustrated in FIGS. 2A and 2B, this angle of the light beam 14h with respect to the original light beam 14a will be four times the angle, Δθ, at which the first reflector 28 is rotated. Accordingly, the light beam 14h output by the angle doubler 16 can be scanned over a second range of angles, 4Δθ, that is four times the first range of angles, Δθ. In various implementations, however, scan rate of the output beam is the same scan rate as the input beam is scanned. For example, the scan rate of the output beam is the same scan rate that the first reflective optical element is scanned.

Accordingly, the light beam or light beam portion (e.g., ray such as chief ray) 14c that is transmitted through the first side 50a of the first lens 42 is transmitted back through the second side 50b of the first lens 46 to the first reflective optical element 28 to be reflected therefrom a second time. As a result of reflection off both the first and second reflectors 28, 30, the light beam or light beam portion (e.g., ray such as chief ray) 14h is deflected by four times the angle, e.g., 4Δθ, at which the first reflector is rotated, e.g., Δθ. The rotation of the first reflective optical element 28 thus causes the light beam 14 to be reflected off the first reflective optical element the second time to be scanned over a second range of angles, 4Δθ, that is four times the first range of angles, Δθ, over which the first reflector is rotated.

FIG. 3C depicts that same angle doubler 16 as shown in FIGS. 3A and 3B but with the first reflector 28 rotated in the opposite direction, e.g., −Δθ. Due to the rotation of the first reflector 28 in the opposite direction, the incident light beam or light beam portion (e.g., ray such as chief ray) 14a is directed on an alternative path through the beam scanner 16, namely, on the opposite side of the first and second lenses 42, 48. Furthermore, the result is a beam deflection of −4Δθ as opposed to ±4Δθ, which was the deflection for the opposite mirror rotation shown in FIG. 3B.

In this example, the input light beam or light beam portion (e.g., ray such as chief ray) 14a is again incident on the first reflector 28. Pursuant to Snell's law of reflection, given that the light 14a is incident on the first reflector 28 at an angle with respect to the first reflector (e.g., the normal thereto), the reflected light 14b is also reflected by the same angle with respect to the first reflector (e.g., the normal thereto) as shown. However, as illustrated in FIGS. 2A and 2B, the change in the direction of reflected light beam 14b with respect to the incident light beam or light beam portion (e.g., ray such as chief ray) 14a will be −2Δθ, where −Δθ is the amount that the first mirror 28 is rotated.

As discussed above and further depicted in FIG. 3C, the first lens 42 has a front 44 and back 46 and first and second sides 50a, 50b on each of said front and back. As shown in FIG. 3C, the first lens 42 is disposed to receive the light beam or light beam portion (e.g., ray such as chief ray) 14b reflected from the first reflective optical element 28 on the second side 50b of the front 44 of the first lens. The light beam or light beam portion (e.g., ray such as chief ray) 14b is thus transmitted through the second side 50b of the first lens 42 and exits the second side on the back 46 of the first lens as indicated by arrow 14c.

As discussed above, the first lens 42 has a central axis (e.g., axis of symmetry) and/or optical axis 49 and a positive focal length in the example shown in FIG. 3C. The second lens 48 also has a front 44 and back 46 and first and second sides 50a, 50b on each of the front and back of the second lens. Furthermore, the first lens 42 is positioned with respect to the first reflective optical element 28 such that the light beam or light beam portion (e.g., ray such as chief ray) 14b reflected off the first reflective optical element to second side 50a of the front 44 of the first lens the first time is incident on the second side of the front of the first lens at an angle, here −2Δθ as shown. Moreover, this light 14b is refracted by the first lens 42 such that the light beam or light beam portion (e.g., ray such as chief ray) that is incident on the second side 50b of the front 44 of the first lens exits the second side of the back 46 of the first lens and propagates parallel to said central axis (e.g., axis of symmetry) and/or optical axis 49. Arrow 14c represents this light propagating from the first lens 42 to the second lens 48 parallel to the central axis or optical axis 49.

This light beam or light beam portion (e.g., ray such as chief ray) 14c is incident on the front 44 of the second lens 48 on the second side 50b of the second lens. The second lens 48 is disposed to receive the light beam or light beam portion (e.g., ray such as chief ray) 14b reflected off the first reflector 28 the first time that is transmitted through the second side 50b of the front 44 of the first lens 42. The light beam or light beam portion (e.g., ray such as chief ray) 14b reflected off the first reflector 28 and transmitted through the second side 50b of the front 44 of the first lens 42 is incident on and transmitted through said second side 50b of said second lens 48.

As discussed above, in the example shown in FIG. 3C, the second lens 48 has a positive focal length. Consequently, the light beam or light beam portion (e.g., ray such as chief ray) 14b reflected off the first reflector 28 that is transmitted through the second side 50b of the front 44 to the first lens 42 and incident on second side of the second lens 48 parallel to the central axis (e.g., axis of symmetry) and/or optical axis 49 of the second lens is refracted by the second lens at an angle toward the central axis or optical axis as indicated by the arrow 14d. This light beam or light beam portion (e.g., ray such as chief ray) 14d refracted by the second side 50b of the second lens 48 is incident on the second reflector 30 at an angle, e.g., −2Δθ, with respect to the normal, due to the symmetry of the system, e.g., the first and second lenses 42, 48 having the same focal length and optical power and the distance to and from the first and second reflectors 28, 30 being the same as the focal lengths. Pursuant to Snell's law of reflection, the light 14c is likewise reflected from the second reflector 30 at an angle, −2Δθ, with respect thereto.

The second reflector 30 reflects the light beam or light beam portion (e.g., ray such as chief ray) 14e back to the second lens 48, this time on the first side 50a of the back 46 of the second lens. As discussed above, this light beam or light beam portion (e.g., ray such as chief ray) 14e reflected from the second reflector 30 at an angle, e.g., −2Δθ, with respect thereto is incident on the first side 50a of the second lens 48 at an angle, at this angle −2Δθ. This light beam or light beam portion (e.g., ray such as chief ray) 14e transmitted through the second lens 48 is refracted by the second positive powered lens in this example such that the light beam or light beam portion (e.g., ray such as chief ray) 14f exiting second lens a second time is parallel to the central axis (e.g., axis of symmetry) and/or optical axis 49 of the second lens. Again, due to the symmetry of the system, for example, the first and second lenses 42, 48 having the same focal length and/or optical power and the distance to and from the first and second reflectors 28, 30 being the same as the focal lengths, the light 14e is refracted an amount to cause the light 14f to be parallel to the optical axis 49. This light beam or light beam portion (e.g., ray such as chief ray) 14f is propagated back to the first lens 42, this time though, the light is incident on the first side 50a of the first lens. As shown, this light 14f is incident on the first lens 42 parallel to the central axis (e.g., axis of symmetry) and/or optical axis 49 of the first lens.

As discussed above, the first lens 42 has positive optical power in this example shown, and the distance from the first reflector 28 corresponds to the focal distance of the first lens. This first lens 42 transmits and refracts this light 14f such that the light 14g that exits the first lens a second time is incident on the first reflector 28 at an angle, e.g., −2Δθ. Likewise, this light beam or light beam portion (e.g., ray such as chief ray) 14g is reflected off the first reflector 28 this second time, because of the rotation of the first reflector, at an angle. Although the angle of the reflected light 14f as measured with respect to the normal of the mirror 28 will be equal to the angle of incidence as measure with respect to the normal, the direction of the reflected light as measured with respect to the original beam will be greater. In particular, this angle of the light beam or light beam portion (e.g., ray such as chief ray) 14h with respect to the original light beam or light beam portion (e.g., ray such as chief ray) 14a will be four times the angle, Δθ, at which the first reflector 42 is rotated. Accordingly, the light beam 14h output by the angle doubler 16 can be scanned over a second range of angles, −4Δθ, that is four times the first range of angles, −Δθ.

More particularly, the light beam or light beam portion (e.g., ray such as chief ray) 14c that is transmitted through the second side 50a of the first lens 42 is transmitted back through the first side 50b of the first lens 46 to the first reflective optical element 28 to be reflected therefrom a second time. As a result of reflection two times off the first reflector 28 and the effects thereof, for example, each reflection providing a two-fold increase in beam deflection (see, e.g., FIGS. 2A and 2B), the light beam or light beam portion (e.g., ray such as chief ray) 14h is deflected by four times the angle, e.g., −4Δθ, at which the first reflector is rotated, e.g., −Δθ. The rotation of the first reflective optical element 28 thus causes the light beam or light beam portion (e.g., ray such as chief ray) 14 to be reflected off the first reflective optical element the second time to be scanned over a second range of angles, −4Δθ, that is four times the first range of angles, −Δθ, over which the first reflector is rotated. As discussed above, in various implementations, however, scan rate of the output beam is the same scan rate as the input beam is scanned. For example, the scan rate of the output beam is the same scan rate that the first reflective optical element is scanned.

Accordingly, FIGS. 3A-3C illustrate the schematic representation of an angle-doubling unit. In this example, the beam scanner 16 comprises an afocal optical relay, in particular, a four focal length (4-f) optical relay. The beam scanner includes the first mirror comprising a scan mirror 28, a pair of first and second lenses 42, 48 that form the afocal (4-f) relay, and a second mirror comprising a flat mirror 30 perpendicular to the optical axis 49 of the relay. When the first scan mirror 28 is at its neutral scan angle (Δθ=0), an incident ray reflected by the scan mirror travels through the center line (e.g., optical axis) of the relay, gets reflected off the second flat mirror 30, and returns through the same relay along the same path of the incoming ray as illustrated in FIG. 3A. As the first scan mirror 28 rotates clockwise by +Δθ, which is depicted in FIG. 3B, the incoming ray 14a is thus reflected off the scan mirror by +2Δθ, and refracted by the pair of lenses 42, 48 to reach the second flat mirror 30. After the light beam or light beam portion (e.g., ray such as chief ray) 14d hits the second flat mirror 30, the light 14c, 14f, 14g returns along a route that is mirror-symmetric to the center line or optical axis 49 of the relay (e.g., 4-f relay) this time, and hits the first scan mirror 28 again. Because the light 14g is not returning along the same route, the outgoing light beam or light beam portion (e.g., ray such as chief ray) 14h is not overlapping with the incoming light beam or light beam portion (e.g., ray such as chief ray) 14a. Instead, the outgoing light beam or light beam portion (e.g., ray such as chief ray) 14h exits at an angle of +4Δθ relative to the incoming ray 14a. Following the same analysis, as the first scan mirror 28 rotates counter-clockwise by −Δθ, the final outgoing light beam or light beam portion (e.g., ray such as chief ray) 14h is reflected by −4Δθ relative to the incoming ray as shown in FIG. 3C. As a result, the outgoing light beam or light beam portion (e.g., ray such as chief ray) 14h scans over a peak-to-peak optical range of ±4Δθ while the first scan mirror 28 scans ±Δθ mechanically. This result is in contrast to the case where a scan mirror with a scan range of ±Δθ only offers a ±2Δθ peak-to-peak scan angle optically as illustrated in FIGS. 2A and 2B. Therefore, the method and apparatus disclosed herein increase, for example, doubles the scan angle from ±2Δθ to ±4Δθ, and this amplification process (e.g., doubling process) is independent of, and thus decoupled from, the scan frequency and the scanner size (e.g., aperture or mass). As discussed above, in various implementations scan rate of the output beam is the same scan rate as the input beam is scanned. For example, the scan rate of the output beam is the same scan rate that the first reflective optical element is scanned.

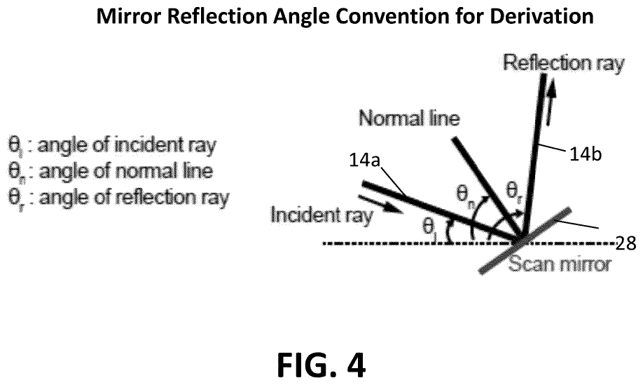

The angle doubling can be derived mathematically. FIG. 4 illustrates the convention employed in this derivation for the light reflection on a mirror, where θᵢ, θᵣ, θₙ are angles of incidence, reflection, and mirror normal line relative to the horizontal. To satisfy Snell's law of reflection, the reflection angle is equal to the incident angle, as the equation shows below.

θᵣ−θₙ=θₙ−θᵢ

Knowing the θᵣ and θₙ, θᵣ can be calculated as the equation shows below.

θᵣ=2θₙ−θᵢ

In the angle doubling system shown in FIG. 3A-3C, the light 14a-14h interacts with the first scanning mirror 28 two times. For the first reflection of the first scanning mirror 28 shown in FIGS. 3A-3C, the incident angle of the light is θᵢ=0 (based on the convention shown in FIG. 4), and the normal line of the first scanning mirror 28 is scanning over a range of θₙ=45°+Δθ. The resultant angle of reflection, θᵣ, can be computed below.

θᵣ=2(45°±Δθ)−0°=90°±2Δθ

After the light propagates round-trip in the angle doubling system and returns to the first scanning mirror 28, the incident angle is changed to θ′ᵢ=90° ∓2Δθ, while the angle of the mirror normal line stays the same as θ′ₙ=θₙ=45°±Δθ. Hence, the second angle of reflection, θ′ᵣ, is as follows.

θ′ᵣ=2θ′ₙ−θ′ᵢ=2(45°±Δθ)−(90°∓2Δθ)=±4Δθ

This derivation formulates that the scan angle of the light is ±4Δθ when the first scanning mirror 28 scans over a range of ±Δθ mechanically in an angle doubling scanning system 16. ±4Δθ is two times larger than the optical scan range that a scan mirror 28 can originally provide without the angle doubling unit such as shown in FIGS. 2A and 2B. With doubled scan angle integrated, a larger field-of-view laser scanning system 10 can be achieved with the imaging area increased by four-fold (4×) while maintaining a high frame rate.

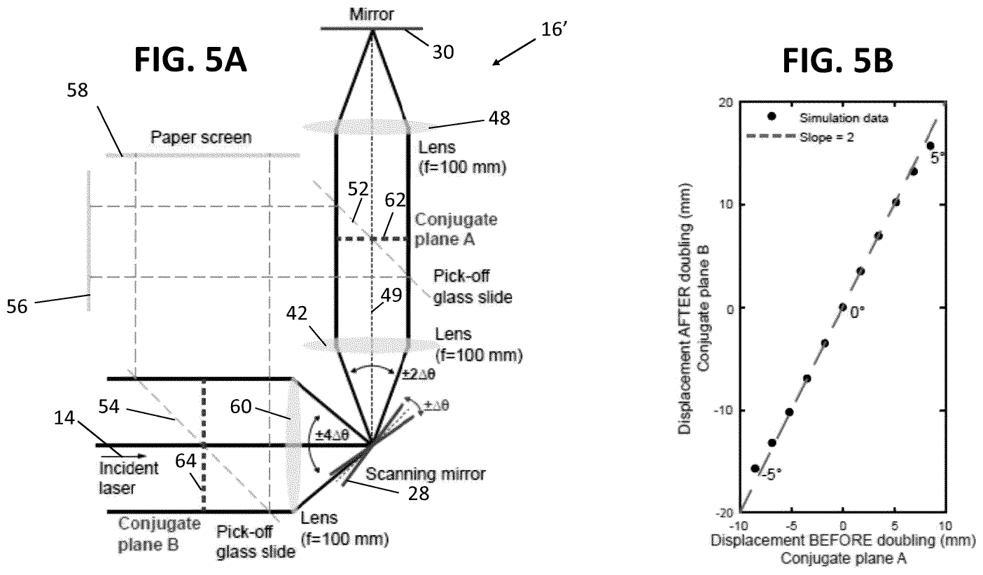

To verify the concept of angle doubling, an angle-doubling beam system 16 was constructed to measure the doubling effect. FIG. 5A shows an experimental set-up comprising an angle doubling unit 16 comprising a first mirror comprising a scanning mirror 28, first and second lenses 42, 48, and a second mirror comprising a planar mirror 30. The first and second lenses 42, 48 form a relay having an optical axis or center line that is colinear with the normal to the second planar mirror 30. The first and second lenses 42, 48 shown in the design in FIG. 5A form an afocal relay and more particularly, in this example, a 4-F afocal relay. In this example, the separation is 200 MM (twice the 100 mm focal length). Additionally, the distance of the first lens 42 is a focal length (e.g., 100 mm) from the first scanning reflector 28. Furthermore, the distance of the second lens 40 is a focal length (e.g., 100 mm) from the second scanning reflector 30. As discussed above, the relay need not be a 4-F relay although the relay can be an afocal relay. Additionally, the relay need not be an afocal relay in some designs. As shown, the first and second lenses 42, 48 are within an optical path formed by the first and second mirrors 28, 30. An additional lens 60, often referred to herein as a scan lens, is positioned at the input/output of the beam scanner 16. In the example shown in FIG. 5A, this lens 60 is configured to redirect the light reflected from the scanning mirror 28 the second time, parallel to the optical axis of the first scanning mirror 28. Accordingly, the scan lens 60 may have a focal length and may be positioned a distance from the first scanning mirror 28 that is equal to the focal length of the first scanning lens.

A pair of beamsplitters or pick-off reflectors (e.g., glass microscope slides) 52, 54 reflect and redirect a portion of the light beams 14c, 14h incident thereon to a pair of screens 56, 58. The first pick-off reflector 52 is included in the optical path between the first and second lenses 42, 48 to redirect a portion of the light beam 14c propagating from the first lens 42 to the second lens 48. The second pick-off reflector 54 is positioned to redirect a portion of the light beam 14h output by the angle doubled beam scanner 16. The first and second pick-off reflectors 52, 54 are disposed with respect to the first and second screens 56, 58 to redirect light to the first and second screens, respectively. As shown in FIG. 5A, the first and second pick-off reflectors 52, 54 are positioned at conjugate planes (conjugate plane A and B) 62, 64 of the optical system 16. These first and second conjugate planes 62, 64 are conjugates of each other and are located at the Fourier planes of the first lens 42 and the scanning lens 60, respectively.

When the incident light beam 14a is scanned by the first scanning mirror 28, scanning lines are formed at first and second conjugate planes 62, 64 of the beam scanner 16. According to the geometry, the length of the scanning lines is approximately linear and proportional to the scan angle. Accordingly, by measuring the line length in these conjugate planes 62, 64, the scan angles before and after the angle doubling is applied can be inferred. In the set-up shown in FIG. 5A, the scanning lines are picked-off from the conjugate planes 62, 64 using the first and second pick-off reflector (e.g., glass slides) 52, 54, and these lines are projected onto the first and second screens 62, 64, respectively. As the first scan mirror 28 scans in this example at ±5 degrees optically, the length of the line from after the angle-doubling unit (˜32 mm) is two times longer than that of the line from before the angle doubling unit (˜17 mm). Nearly doubling in the lengths of the lines demonstrates that the scan angle is doubled. Results of optical modeling shown in FIG. 5B also verify the doubling effect. FIG. 5B is a plot on axes of displacement after angle doubling (in units of millimeters) versus axis of displacement before angle doubling (also in units of millimeters) produced by optically modeling an angle doubler such as described herein. The plot shows simulation data corresponding to the amount of resultant deflection produced by rotating the first scanning mirror 28 thereby demonstrating the angle doubling achieved by the beam scanning system. These results matched the prediction of angle doubling, confirming the validity of the disclosed method and apparatus.

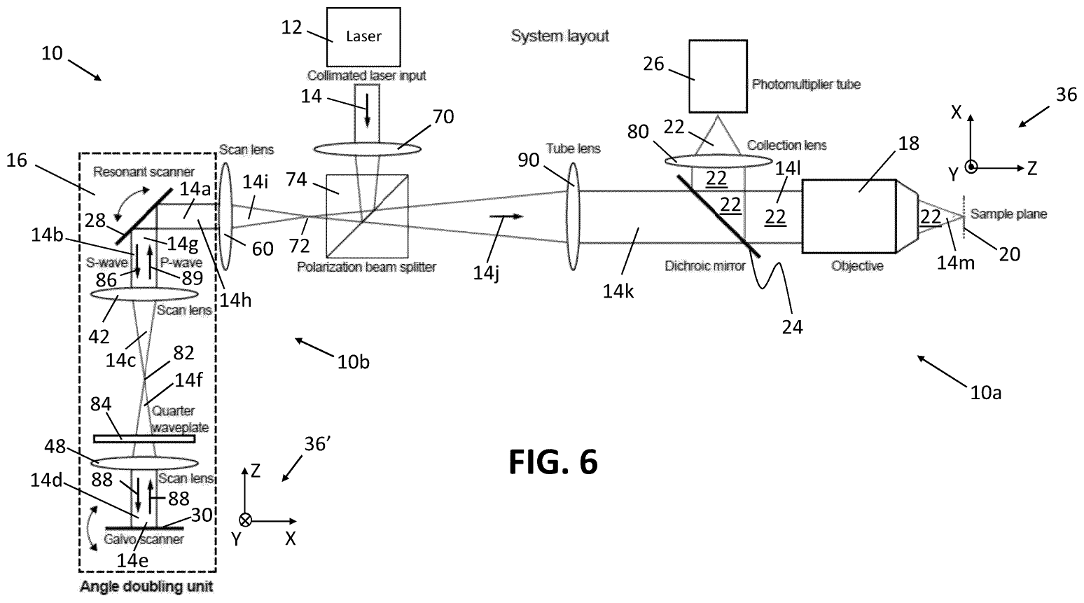

Advantageously, the beam scanner, e.g., angle doubling unit, 16 can be integrated into a laser scanning microscope 10 as shown in FIG. 6. The system 10 shown in FIG. 6 includes two portions, a first portion 10a including a laser light source 12, microscope objective 18 and detector 26 and a second portion 10b comprising a beam scanner 16 with an angle doubler unit.

An optical path extends from the laser light source 12 to the beam scanner 16. As discussed above, the beam scanner 16 comprises first and second beam steerers elements 28, 30 in an optical path thereof. The first and second beam steerers comprise first and second reflective optical elements 28, 30. In the example shown, the beam scanner 16 also includes first and second lenses 42, 48 in the optical path, between the first and second reflective optical elements 28, 30.

In the example shown, the first reflective optical element 28, a first beam steerer, comprises a planar scanning mirror configured to scan in a first direction (e.g., in the X-Z plane or in a plane parallel thereto). The second reflective optical element 30, another beam steerer, also comprises a planar scanning mirror configured to scan in a second direction (e.g., in the Y-Z plane or in a plane parallel thereto) that is orthogonal to the first direction. The first and second lenses 42, 48 form an optical relay and, in particular, an afocal relay in the example shown. For example, the first and second lenses 42, 48 comprise positive lenses having focal lengths, and the distance separating the first and second lenses is equal to the sum of the focal lengths of the first and second lenses.

The laser scanning microscope 10, namely the first portion, further comprises the microscope objective 18 configured to focus light 14m from the laser 12 onto a sample plane 20 where the sample would be located. Accordingly, an optical path extends from the beam scanner 16 to the microscope objective 18. In the example shown in FIG. 6, a beamsplitter 24 is included in the optical path between the beam scanner 16 and the microscope objective 18. Light 14h, 14i, 14j, 14k from the beam scanner 16 is transmitted through this beamsplitter 24 to the microscope objective 18. Conversely, light 22 from the sample 20 propagates in reverse through the microscope objective 18. This light 22 from the sample 20 is reflected by the beamsplitter 24 to the optical detector or sensor 26. In some implementations, the beamsplitter 24 comprises a dichroic beamsplitter, which transmits light of a first wavelength and reflects light of another wavelength. A focusing lens 80 is shown positioned to collect light 22 from the sample 20 and to focus this light onto the optical detector or sensor 26.

The first portion 10a of the laser scanning microscope 10 further includes a focusing lens 70 positioned with respect to the laser 12 to receive the laser beam 14 output by the laser and focus the laser beam down at a focal plane 72. The first portion 10a also includes a beamsplitter such as a polarizing beamsplitter 74, for example, that reflects a first polarization (e.g., s-polarized light) and transmits a second polarization (e.g., p-polarized light). (In other implementations, the beamsplitter may comprise a non-polarizing beamsplitter such as a power beamsplitter that reflects a portion of the optical power or intensity and transmits a portion of the optical power or intensity, e.g., 50:50). In the example shown, light reflected by the beamsplitter 74 is directed into the second portion 10b of the laser scanning microscope 10, the beam scanner 16, which includes the angle doubler. In the design shown in FIG. 6, the polarization beamsplitter 74 reflects s-polarized light such that the light injected into the beam scanner/scan doubler 16 is s-polarized light. In some implementations, the laser light source 12 may output primarily s-polarized light so as to efficiently couple light through the beamsplitter 74 into the beam scanner/scan doubler 16.

The beam scanner 16 includes a scan lens 60 positioned to receive the light from laser light source 12, for example, that is reflected by the beamsplitter 74. In the example shown, laser light 14 from the laser light source 12 that is incident on the focusing lens 70 is collimated. This collimated light 14 is focused down by the focusing lens 70, presumably at a location 72 that is a distance from the focusing lens equal to the focal length of the focusing lens. In this example, the scan lens 60 collimates the light from the laser light source 12. Accordingly, in the example design shown in FIG. 6, the scan lens 60 is positioned a distance from the focal plane of the focusing lens that equals the focal length of the scan lens. As a result, the light 14a transmitted through the scan lens 60 and directed to the first scanning mirror 28 is collimated in this implementation.

As discussed above, the beam scanner 16 comprises first and second reflective optical elements or reflectors (e.g., mirrors) 28, 30. In the example shown in FIG. 6, both the first and second reflective optical elements or reflectors 28, 30 comprise scanning mirrors. In the example, however, the first scanning mirror 28 is configured to scan in a different, orthogonal direction than the second scanning mirror 30. The first reflecting optical element or reflector 28, for example, comprises a scanning mirror having an axis of rotation parallel to the Y axis and configured to scan in the X-Z plane or a plane parallel thereto. By contrast, the second optical element or reflector 30 in this example comprises a scanning mirror having an axis of rotation parallel to the X axis and configured to scan in the Y-Z plane or a plane parallel thereto. The orthogonal scan directions enable the laser beam 14 focused by the microscope objective 18 onto sample 20 to be scanned, e.g., raster scanned, in orthogonal directions (e.g., X and Y directions) across the sample to illuminate an area on the sample. As discussed above, in various implementations, such scanning of such reflectors or mirrors may be controlled by control electronics configured to drive motor or actuators to move, e.g., rotate, the mirror(s). In various implementations, the mirror(s) may rotate (e.g., tip or tilt) back and forth or may rotate around (e.g., revolve) through 360° degrees.

The beam scanner 16 shown in FIG. 6 also includes first and second lenses 42, 48 such as described above. The first and second lenses 42, 48 may comprise positive lenses. As illustrated, the second lens 48 is not included in an array of lenses. For example, the second lens 48 is not a lenslet in an array of lenslets. Similarly, the first lens 42 is not included in an array of lenses and is not a lenslet in an array of lenslets. Either or both of the first and/or second lenses not being included in a lens array, e.g., not comprising a lenslet in a lenslet array, may increase the field-of-view. The first and second lenses 42, 48 in this example form an afocal relay. Accordingly, in various implementations, the first and second lenses 42, 48 have positive focal lengths and the longitudinal distance (e.g., in the Z direction) separating the lenses is equal to the sum of the focal lengths. A focal plane 82 is between the first and second lenses 42, 48. FIG. 6 shows the collimated light 14a from the laser 12 incident on and reflected by the first scanning mirror 28. This reflected light 14b is depicted incident on the first lens 42 as a collimated beam. The first lens 42 focuses this collimated laser beam 14b down onto the focal plane 82 between the first and second lenses 42, 48. The second lens 48 again collimates the laser beam 14c such that a collimated beam 14d is incident on the second scanning mirror 30. This collimated laser beam 14d incident on the second scanning mirror 30 is reflected therefrom back to the second lens 48. The second lens 48 is shown focusing the collimated laser beam 14e reflected from the second scanning mirror 30 onto the focal plane 82 between the first and second lens 42, 48 once again. The beam 14f continues onto the first lens 42, which collimates the laser beam to be directed again onto the first scanning mirror 28. The collimated laser beam 14g is reflected once again from the first scanning mirror 28. This reflected laser beam 14h is directed to the scan lens 60, which focuses the beam again to the focal plane 72 between the beamsplitter 74 and the scan lens. This focal plane 72 and the focal plane 82 between the first and second lenses 42, 48 are conjugate planes.

The beam scanner 16 shown in FIG. 6 includes polarization optics to control the passage of the light through the polarization beamsplitter 74. The beam scanner 16, for example, includes a quarter wave retarder or quarter waveplate 84 configured to rotate the polarization state of the laser beam 14 after two passed therethrough. A half wave of retardation will rotate the orientation of linearly polarized light (e.g., from s-polarization to p-polarization and vice versa). Accordingly, in the design show in FIG. 6, the laser beam 14 will propagate twice through the quarter wave retarder 84 thereby providing a half wave of phase shift between orthogonal polarization states and rotating the polarization, e.g., from s to p polarized light.

FIG. 6, for example, shows s-polarized light represented by an arrow 86 which is directed into the beam scanner 16 by the polarization beamsplitter 74, which reflects s-polarized light from the laser 12 into the beam scanner. The s-polarized light 86 propagates through the first lens 42 and then through the quarter wave retarder 84 a first time. A quarter (24) wave of phase shift between orthogonal polarization states will convert the s-polarized light 86 into circularly polarized light (represented by arrow 88). This light 88 passes through the second lens 48, is reflected by the reflector 30 back through the second lens again and then through the quarter wave retarder 84 again. With this second pass through the quarter wave retarder, the light 88 is converted back to linearly polarized light. However, the orientation of the linear polarized light is rotated with respect to the orientation of the s-polarized light incident on the quarter wave retarder 84 the first time. In various designs, such as the one shown in FIG. 6, the light 86 will be rotated a full 90° to convert the light into p-polarized light 90. This p-polarized light 89 will continue through the first lens 42 again and be reflected off that first reflector 28 and through the scanning lens 60. This p-polarized light 89 will be incident on and transmitted through the polarizing beam splitter 74 that reflects s-polarized light and transmits p-polarized light. The quarter wave retarder 84 is thus used to cause the light 14i/89 that passed through the angle doubler 16 to be transmitted through the polarization beamsplitter 74 to the microscope objective 18 instead of being reflected back to the laser 12. Other configurations, however, are possible.

In addition to the microscope objective 18, the laser scanning microscope 10 includes a tube lens 90. The tube lens 90 is in the optical path between the polarization beamsplitter 74 and the microscope objective 18 in the laser scanning microscope 10 shown in FIG. 6. Moreover, the tube lens 90 is in the optical path between the polarization beamsplitter 74 and the dichroic beamsplitter 24 in the laser scanning microscope 10 shown in FIG. 6. In the example shown, the tube lens 90 comprises a positive lens. The tube lens 90 also has a focal length and is positioned a focal length away from the focal plane 72 from the focal plane so as to provide collimation.

FIG. 6, for example, shows the laser light 14h reflected from the first reflector 28 a second time and transmitted through the scan lens 60. This light 14i is transmitted through the polarization beamsplitter 74. The light 14j transmitted through the polarization beamsplitter 74 is incident on the tube lens and transmitted therethrough. The light 14k that passes through the tube lens 90 is collimated by the tube lens as discussed above. This collimated light 14k passes through the dichroic beamsplitter 24. This light 14l after passing through the dichroic beamsplitter 24 reaches the microscope objective 18, which focus the light 14m onto the sample plane and the sample 20.

To demonstrate the compatibility of the angle-doubling beam scanning unit 16 with the laser scanning imaging microscope 10, an angle-doubling beam scanning unit was integrated into a custom-built two-photon laser scanning microscope. This system 10 is shown in FIG. 6 and includes of the two portions (here two perpendicular arms): the first portion 10a including a laser light source 12, microscope objective 18 and detector 26 in a first arm and the second portion 10b comprising a beam scanner 16 with an angle doubler unit in a second arm. In this example design, both portions (arms) 10a, 10b include a 4-f relay. The angle-doubling arm 10b includes two scan lenses (LSM54-1050, Thorlabs) 42, 48 with an equal effective focal length (EFL) of 54 mm. The beam scanner 16 also includes a 12-kHz resonant scan mirror (CRS 12 KHz, Cambridge Technology) 28 with a ±5° peak-to-peak optical scan angle at one end and a galvanometer scan mirror (±20° scan angle maximally; 6220H, Cambridge Technology) 30 at the other end of the angle-doubling arm 10b. The other arm 10a is the two-photon imaging arm, which includes a scan lens (EFL=54 mm, LSM54-1050, Thorlabs) 60 and a tube lens (EFL=200 mm, TTL200MP, Thorlabs) 90 followed by an objective lens (N16XLWD-PF, Nikon) 18. These two perpendicular arms 10a, 10b are set up so that the resonant scan mirror 28 and the galvanometer scan mirror 30 are conjugated to the back aperture of the objective lens 18. The polarization of the laser light 14 is modulated for the laser light 14 to travel through the entire system 10. A collimated s-polarized input laser 12 is first reflected by the polarizing beam splitter (PBS; PBS513, Thorlabs) 74, and coupled into the angle-doubling beam scanning unit 16 where the beam 14 is scanned by the resonant scan mirror 28 to form a lateral line scan. To form a raster scan pattern, the scan axis of the galvanometer scan mirror 30 is perpendicular to that of the resonant scan mirror 28. After the beam 14e is reflected by the galvanometer scan mirror 30, it returns to the resonant scan mirror 28 again where the scan angle of the laser beam 14g provided by the scan of the first scanning mirror 28 is doubled (from ±5° to ±10° optically). As discussed above, however, the range of angles scanned through, Δθ, need not be symmetric or asymmetric with respect to a particular direction but can be asymmetric e.g. −5° to +15°. However, the scan may be symmetric about some reference, reference line or axis and thus be referred to as ±Δθ or ±2Δθ in some cases. To couple the angle-doubled beam 14h into the two-photon imaging arm 10a, a quarter-wave waveplate (39-046, Edmund Optics) 84 is inserted in the angle-doubling arm 10a. After passing through the quarter-wave waveplate 84 twice, the polarization of the laser beam 86 is turned 90 degrees and such that the laser beam becomes p-polarized light 89 when exiting the arm 10b with the angle-doubling unit. The p-polarized beam 89/14i is able to pass through the polarization beamsplitter (PBS) 74 and reach the imaging plane 20 under the objective 18. The signal generated from the imaging plane 20 is collected by the objective 18 and directed to the photomultiplier tube (PMT2102, Thorlabs) 26 via the dichroic mirror (DI03-R785-T1-50.8X50.8, AVR Optics) 24 and the collection lens (LA1050-A-ML and ACL2520U-A, Thorlabs) 80 in series. An anti-reflection coating and the performance of this example system 10 are designed (e.g., optimized) around the wavelength of 800 nm-1100 nm for excitation (possibly 910 nm) and 400-700 nm for emission. The optics and the opto-mechanics used in this system 10 are off-the-shelf, and the dimension of this example system is 65×50×50 cm (length×width×height). The additional angle doubling arm 10b does not occupy much more space than the other arm 10a. Modeling of the system 10 using raytracing software yields a root-mean-square error of the wavefront smaller than 0.07 wavelength suggesting diffraction-limited resolution across the accessible scan range. A fluorescence sample with periodic 5 lines per millimeter was imaged under a 16Δ NA 0.8 water immersion objective (EFL=12.5 mm, Nikon). A square field-of-view was obtained by increasing (e.g., doubling) the scan angle of the resonant scan mirror at ±5°. The measured field-of-view is 1.05×1.05 mm², which virtually corresponds to a ±10° scan angle at the conjugate plane where the resonant scanner is located. While the actual scan angle of the resonant scan mirror here is only ±5°, the increases of scan angle to ±10° is attributed to the angle-doubling unit. By contrast, without the angle doubling, the ±5° resonant scan angle will only provide a 0.53 mm field-of-view along the X direction. In order to obtain a square field-of-view, the scan angle of the galvanometer scan mirror 30 is set at ±10°, further confirming the effective scan angle along the axis of the resonant scanner 28 is doubled. While the scan angle is doubled, neither the scan frequency of the resonant scan mirror 28 nor the beam size at the back aperture of the microscope objective 18 is changed. This result manifests that the angle doubling unit can independently double the field-of-view with no trade-offs in the imaging speed nor the imaging numerical aperture (and associated optical resolution). As discussed above, in various implementations scan rate of the output beam is the same scan rate as the input beam is scanned. For example, the scan rate of the output beam is the same scan rate that the first reflective optical element is scanned. The result also demonstrates the compatibility of the angle doubling scanning system 16 with the two-photon microscope 10.

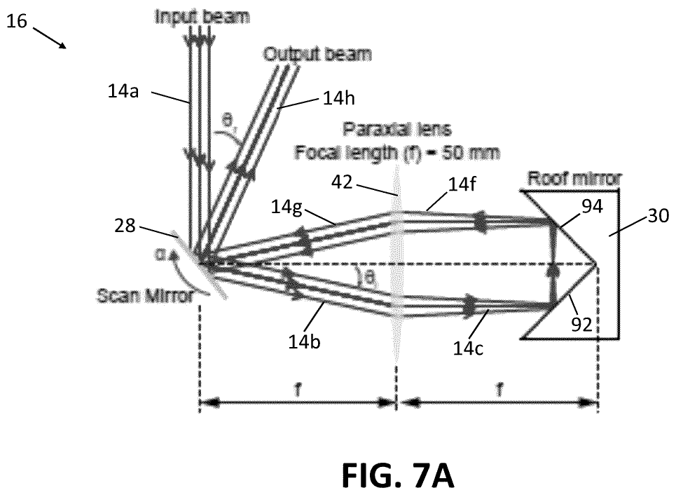

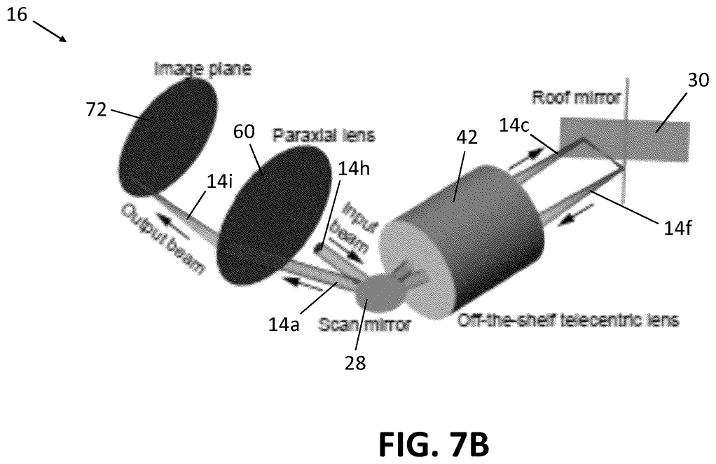

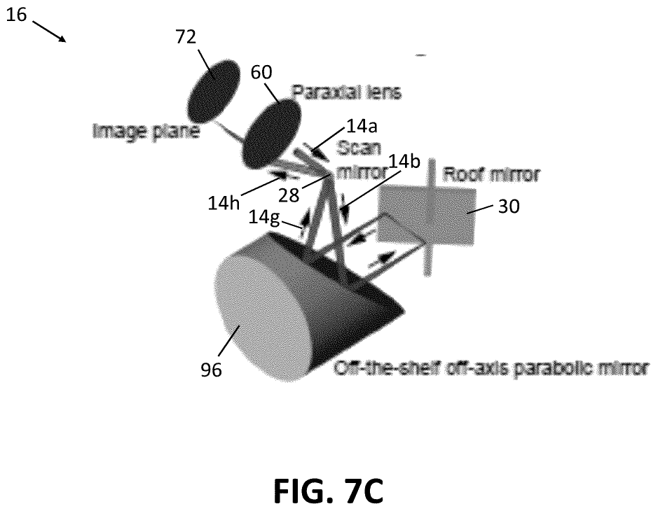

Alternative designs, however, are possible. FIG. 7A, for example, shows a beam scanner 16 comprising a scan doubler wherein the second reflective optical element 30 comprises a retroreflector. The retroreflector in this example comprises a retroreflecting roof mirror such as a hollow roof prism mirror from ThorLabs (e.g., a square retroreflecting hollow roof prism). The retroreflector has a plurality of reflective surfaces, for example, first and second reflective surfaces 92, 94, angled with respect to each other. In some designs for example, the first and second reflective surface 92, 94 are oriented to form a 90° angle with respect to each other. The plurality of reflective surfaces 92, 94 are configured to reflect the incident light beam 10d back in the same direction from which the light beam is incident on the retroreflector. As illustrate, for example, the incident light beam 10c reflects off the first reflective surface 92 to the second reflective surface 94 and back toward the first lens 42 parallel to the direction the light was incident on the first surface of the retroreflector. Consequently, the second lens 48 need not be included in the beam combiner. The retroreflector as the second reflective optical element 30 is sufficient to return the incident light beam 10d transmitted through the first side 50a (or second side 50b) of the first lens 42 back through second side 50b (or first side 50a) of the first lens in the opposite direction such that this light beam 10g is incident on the first reflective optical element 28 a second time at a steeper (or more shallow) angle from which the light was reflected off the first reflective optical element the first time.

Accordingly, FIG. 7A shows that the angle doubling beam scanning system 16 can be folded, for example, the size (e.g., length) of the angle double shown in FIG. 3 can be reduced, e.g., by half, with retroreflector such as a roof mirror. As a result of the use of the retroreflector, in such a design, one of the relay lenses, e.g., the second lens 48, can be removed and the overall size of the system 10 can be reduced. In this example configuration, the scan mirror 28 can be positioned at the front focal plane of the positive powered first lens 42, and the seam of the roof mirror can be positioned at the back focal plane of the first lens. Based on the mirror symmetry of the retroreflector, the collimated input light beam 14a reflects off the first scan mirror 28, travels inside the angle doubler 16, and loops back to the center of the first scan mirror again. When this collimated beam 14g is reflected by the same scanning mirror 28, the second time and leaves the beam scanning system 16, the deflection angle is doubled. One advantage of employing this retroreflector as the second reflective optical element 30 in this design is that the beam scanner 16 can be made more compact. In this design, for example, the second lens 48 is removed. As illustrated in FIG. 7A, the first lens 42 can be positioned a focal length, f, away from the first reflector 28 and the retroreflector 30 can be positioned a focal length away from the first lens. If the focal length of the first lens 42 is f in this example, the distance of the first reflective optical element 28 to the second reflective optical element 30 can be 2f. Consequently, this system 16 may be referred to as a 2-f system. This shorter design can be contrasted with the longer designs shown in FIGS. 3A-3C, 5A and 6, where a 4-f relay is employed with the first lens 42 a focal length away from the first reflective optical element 28, the first and second lenses 42, 48 separated by the sum of the focal lengths of the first and second lenses, and the second reflective optical element 30 positioned a focal length away from the second lens. (In these beam scanners, the focal length of the first and second lenses 42, 48 can be the same; however, the focal lengths can be different in other designs.) Another potential advantage is that removing the second lens 48 may possibly reduce chromatic dispersion in various designs.

FIG. 7B shows another variation, wherein the first lens 42 comprises a plurality of lens elements and, in particular, comprises a telecentric lens. For example, the first lens 42 may comprise an off-the-shelf telecentric lens such as LSM54-1050 from Thorlabs. The use of a telecentric scan lens will get the chief ray of 14c and 14f to travel in parallel with the optical axis and in an opposite direction, so that the collimated beam bounced off the scan mirror will return to the same scan mirror and stay collimated. In the example shown, the second reflective optical element 48 comprises a retroreflector such as a roof mirror or roof prism mirror such as discussed above in connection with FIG. 7A. Still other variations are possible. For example, the second reflector need not be a retroreflector. The system may also include a second lens. This second lens may be telecentric. In particular, any one or more of the lenses in any of these systems such as the angle doubler show in FIGS. 3A-3C, 5A, and 6, described herein may comprise a telecentric lens. The telecentric lens can provide that the chief rays (14c) refracted by the telecentric lens (42) are directed parallel to the optical axis of the telecentric lens.

FIG. 7C shows a design wherein the first lens 42 is replaced with a reflective optical element 92 having optical power. The first lens 42, for example, is replaced by a curved mirror 96 having a curved reflective optical surface. In some implementations, the curved reflective surface has an off-axis shape. In some designs, the curved mirror 96 comprises a parabolic mirror having a parabolically shaped optical surface. This parabolic mirror 96 may, for example, comprise an off-axis parabolic mirror having a reflective optical surface in the shape of an off-axis parabola or paraboloid. Accordingly, the optical system 16 has an off-axis design. The configuration is off axis in that light 14b is directed onto the curved mirror 96 from the first reflective optical element or scanning mirror 28 from one side. In some implementations, the curved reflector 96 may comprise an off-the shelf curved reflector such as an off-the shelf curved parabolic mirror (e.g., an off-axis parabolic mirror). One advantage of replacing the first lens 42 with a mirror 96 is that the effects of wavelength of dispersion of the first lens 42 can be removed as a reflective element does not have such wavelength dispersion.

As illustrated in FIGS. 7A-7C, the second reflective optical element 30 may comprise a retroreflector in various implementations. However, in other designs, the second reflective optical element 30 does not comprise a retroreflector. Likewise, in various implementations, unlike a retroreflector, the light beam transmitted through the second lens 48 is reflected off said second reflective optical element 30 back toward the second lens at an angle with respect to the light beam incident on said second reflective optical element. Furthermore, both the first and second lens 42, 48 may be included in the system 16 as opposed to one of the first and second lenses only (e.g., only the first lens) such as shown in FIG. 7A-7C.

Other variations are possible. For example, angle doubling systems including but not limited to those shown in FIGS. 3A-3B, 5A, and 6 may be used with beam steering technologies other than scanning mirrors, or technologies the employ non-mechanical steering of optical beams. Such technologies may include but are not limited to active diffractive optical elements such as reflective diffractive optical elements that are active as opposed to passive components. Such active diffractive optical elements include reflective acousto-optical modulators (see, e.g., “Reflective acousto-optic modulation with surface acoustic waves”, Applied Optics, Vol. 43, Issue 14, pp. 2920-2924 (2004), https://doi.org/10.1364/AO.43.002920). Other types of beam steering technologies include phase arrays such as reflective 1d or 2d phase arrays including but not limited to liquid crystal spatial light modulators, MEMS mirror arrays and electrowetting prism arrays (see e.g., “A Review of Phased Array Steering for Narrow-Band Electrooptical Systems”, Proceedings of the IEEE, Volume: 97, Issue: 6, pp. 1078-1096, June 2009, DOI: 10.1109/JPROC.2009.2017218). Such beam steerers (e.g., active reflective diffractive optical elements, phase arrays, liquid crystal spatial light modulators, MEMS mirror arrays, electrowetting prism arrays, etc.), like the scanning or rotating mirrors discussed above, can be electrically connected to electrical circuitry that can cause the beam or beams to be reflected from the beam steerer at different angles. The electrical circuitry potentially referred to herein as control electronics may, for example, be configured to direct the light beam at different angles depending on the signal applied by the electrical circuitry thereto. As such, one or more electrical signals from the electrical circuitry or control electronics may be applied to the beams steerer to scan the light beam through a first range of angles, Δθ_{beam}. Likewise, the light beam may reflect off the beam steerer a second time to scan the light beam through a second range of angles twice the first range of angles, e.g., 2Δθ_{beam}. Similar principles apply when the beam steerer comprises an active diffractive optical element, a phase array or a rotating mirror such as discussed above. For example, electrical circuitry may be electrically connected to active diffractive optical elements (e.g., acousto-optical modulators), phase arrays, liquid crystal spatial light modulators, MEMS mirror arrays, electrowetting prism arrays, galvanometers, piezoelectric actuators (piezos), motors or other actuators configured to move mirrors, MEMS mirrors, etc. to provide signals thereto to scan the beam steerer regardless of the type.

As discussed above with regards to FIGS. 3A-3C, the second reflective optical element 30 may be normal to the central axis and/or optical axis 49 of the first and/or second lenses 42, 44. However, as discussed with regard to FIG. 6, the normal of the second reflector 30 need not necessarily be parallel with the optical axis of the first and/or second lenses 42, 48 or of the optical system 10. For example, the second reflective optical element (e.g., mirror) 30 may comprise a beam steerer that can scan in a direction (e.g., in YZ plane or plane parallel thereto) orthogonal to the scan of first reflective optical element (e.g., mirror) 28 (e.g., in the XZ plane or plane parallel thereto) to raster scan the light beam incident on the sample such as in FIG. 6.

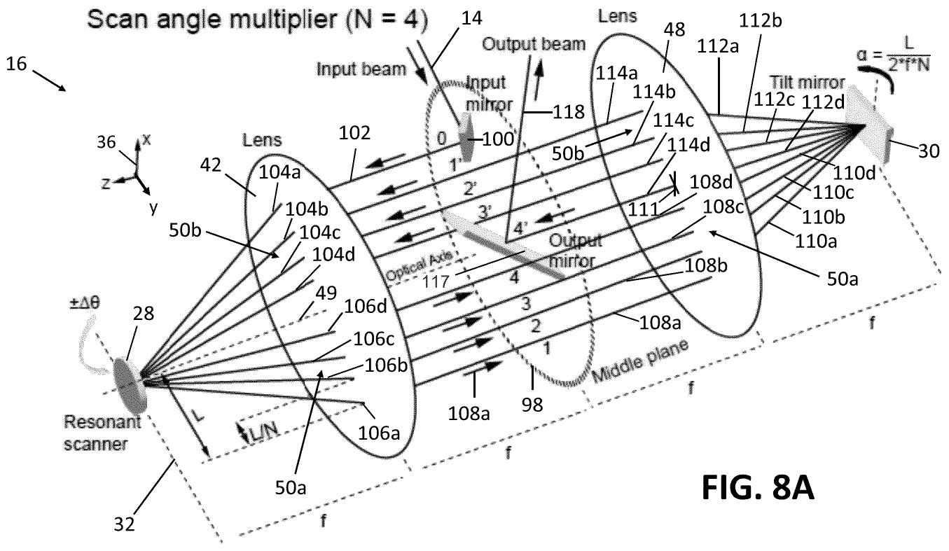

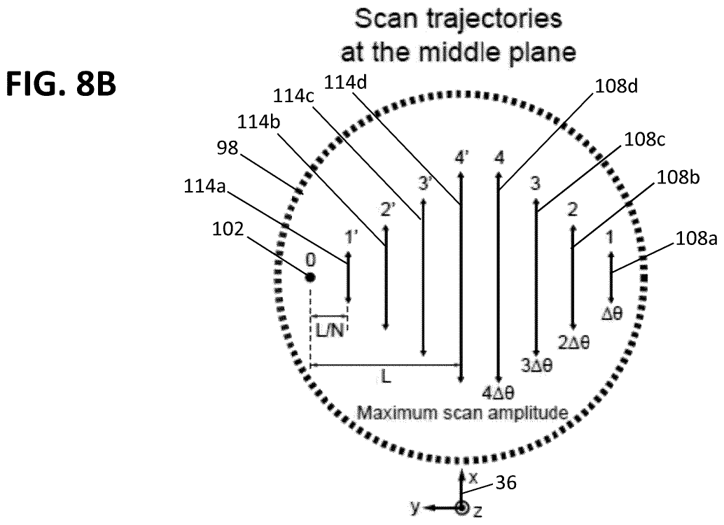

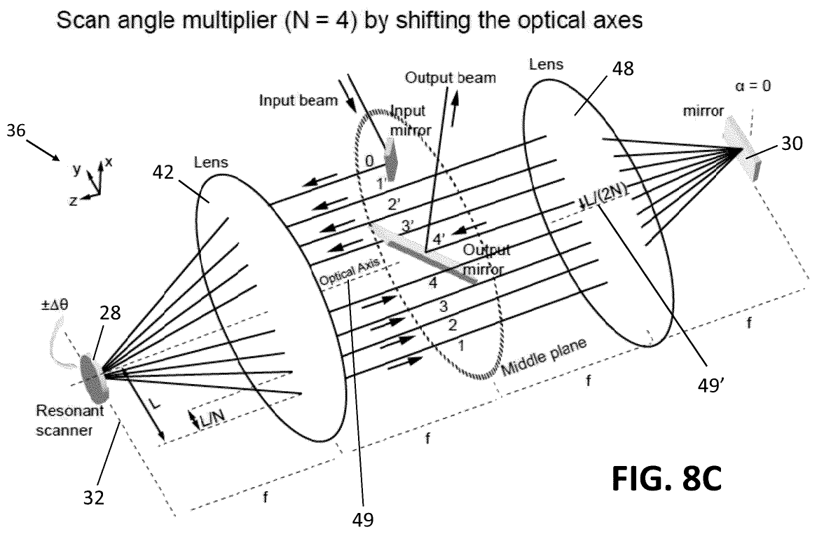

In some implementations, the normal of second reflective optical element 30 can have a fixed amount of tilt in a plane, e.g. YZ plane or plane parallel thereto, that is orthogonal to the plane, e.g., XZ plane, in which the normal to the first reflective optical element 28 is scanned. Such an offset of the normal of the second reflective optical element 30 by a fixed angle orthogonal to the scan plane of the first reflective optical element 28, can offset the optical path of the output beam with respect to the input beam such as shown in FIG. 8A. This tilt of the second reflective optical element 30 can facilitate the separation of the incoming beam from the outgoing beam as the tilt can cause the output beam to be displaced from and not overlap the input beam. As illustrated in the design shown in FIG. 8A, which is discussed below, a pick-off reflector 117 (also referred to as output mirror) may then be used to extract and redirect the output beam from the optical system 10. The pick-off reflector may comprise a mirror. In some implementations, the pick-off reflector may comprise a beamsplitter (e.g., polarizing beamsplitter or power beamsplitter). However, in some implementations, use of an input mirror and pick off reflector or output mirror may be in lieu of polarization optics (e.g., polarizing beamsplitter 74 and a quarter waveplate 84) such as shown in FIG. 6, to separate the input and output beams. Not employing a polarizing beamsplitter 74 and a quarter waveplate 84 may make the system 10 more compact, possibly reducing the footprint, potentially reducing the power loss or any combination of these.

In some implementations, this second reflective optical element or reflector 30 may be tilted in the same direction as rotation of the first reflective optical element 28 (e.g., in the XZ plane or plane parallel thereto in the example shown in FIG. 6). Such tilt, for example, with respect to the central and/or optical axis 49 and/or first reflective optical element 28 and/or first and/or second lenses 42, 48 may offset the center of the raster scan, resulting a shift of probed field-of-view on the image/sample plane.

In some designs, this second reflective optical element or mirror 30 may be configured to scan in multiple (e.g., two orthogonal) directions. The second reflective optical element or mirror 30 may, for example, comprise a 2-D (dual-axis) beam steerer or scan mirror. The 2D scan mirror 30 can scan in a direction orthogonally to the scanning of the first reflective optical element 28 to form a raster scan such as shown in FIG. 6. Additionally, this second reflective optical element 30, being a 2D beam steerer or 2D scanner, can dynamically tilt in the same direction as the first reflective optical element or beam steerer 28 scans/rotates, for example, to offset the center of the raster scan, resulting a shift of probed field-of-view on the image/sample plane.

The second reflective optical element 30 can be stationary and have a normal parallel to the central and/or optical axis 49 of the first and/or second lens 42, 48 such as shown in FIG. 3. Alternatively, in some implementations, the second reflector 30 can tip and/or tilt in one or both of these orthogonal directions (e.g., YZ or XZ planes or planes parallel thereto in the example shown). One or both of the tip and tilt angles (e.g., in the YZ or XZ planes or planes parallel thereto in the example shown) may be set and remain stationary. Alternatively, one or both of the tip and tilt angles (e.g., in the YZ or XZ planes or planes parallel thereto in the example shown) may be scanned. Other variations are possible.

FIG. 8A, for example, shows a beam scanner 16 comprising first and second reflective optical elements 28, 30 and first and second lenses 42 and 48 therebetween wherein the first reflective optical element comprises a beam steerer configured to scan in a first direction, e.g., in the X-Z plane or a plane parallel thereto. In the example shown, the first and second lenses 42, 48 are positive lenses. As illustrated, the second lens 48 is not included in an array of lenses. For example, the second lens 48 is not a lenslet in an array of lenslets. Similarly, the first lens 42 is not included in an array of lenses and is not a lenslet in an array of lenslets. Either or both of the first and/or second lenses not being included in a lens array, e.g., not comprising a lenslet in a lenslet array, may increase the field-of-view. The first and second lenses 42, 48 form a relay such as an optical relay.

Likewise, the design has similarities to the systems 10 shown in FIGS. 3A-3B, 5A and 6. In this example design, however, the second reflective optical element 30 is tilted with respect to the central axis (e.g., axis of symmetry) and/or optical axis of the first and/or second lenses 42, 48 in the orthogonal Y-Z plane or in a plane parallel thereto to which the first reflective optical element 28 is scanned. This configuration of the second reflective optical element 30 is in contrast to that shown in FIGS. 3A-3C and 5A wherein the normal to the second reflective optical element 30 is coincident with the central axis (e.g., axis of symmetry) and/or optical axis 49 of the first and/or second lenses 42, 48 as well as that shown in FIG. 6 wherein second reflective optical element is scanned in the plane normal Y-Z plane or a plane normal thereto.

As a result of this fixed tilt of the second reflective optical element 30 in the plane (Y-Z plane or plane parallel thereto) orthogonal to the scan plane (X-Z plane or plane parallel thereto) of the first reflective optical element 28, the light beam 14d received by the second reflective optical element and returned back to the first reflective optical element is reflected back through the first and second lenses 42, 48 to the second reflective optical element again. And in the design shown in FIG. 8A, as a result of this tilt of second reflective optical element 30, the light beam will reflect off of the first reflective optical element 28 and be returned back reflected back through the first and second lenses 42, 48 and to the second reflective optical element and reflected off the second reflective optical element and through the first and second lenses to the first reflective optical element multiple times for a total of four round trips. This cycling of the laser beam through the first and second lens 42, 48 and off the first and second reflective optical elements 28, 30 multiple times may result in further increase the scan angle, for example, increased multiplication of the angle scanning beyond simply doubling the scan angle of the beam. Rather, an N-fold scan angle multiplication (e.g., N times the scan angle of the beam off a scanning reflector) may be achieved. In the design shown in FIG. 8A, for example, the scan angle of the light beam reflected off the first reflective optical element 28 will be increased by four-fold. As discussed above, the range of angles scanned may be symmetric or asymmetric e.g., −13° to +13°, −8° to +18°, etc. However, the scan may be symmetric about some reference, reference line or axis and thus be referred to as ±Δθ or ±2Δθ in some cases. In various implementations, however, scan rate of the output beam is the same scan rate as the input beam is scanned. For example, the scan rate of the output beam is the same scan rate that the first reflective optical element is scanned.

In particular, in the configuration shown in FIG. 8A, the laser beam 14 is coupled into the beam scanner 16 by an input reflector or mirror 100. In FIG. 8A, a ray, the chief ray of a light beam is shown and may as such be referred to as the interchangeably as light beam, light beam portion, ray, and/or chief ray or variants thereof. As a result, as illustrated, a light beam or light beam portion (e.g., ray such as chief ray) 102 is reflected by the input mirror 100 through the second side 50b of the first lens 42. This light, referred to in FIG. 8A as 104a, is refracted by the first lens 42 so as to be incident onto the first reflective optical element 28 at an angle. Pursuant to Snell's law of reflection, this incident light 104a is therefore reflected from the first reflective optical element 28 also at an angle as illustrated by reflected light 106a. This reflected light beam or light beam portion (e.g., ray such as chief ray) 106a is incident on, transmitted through, and refracted by the first side 50a of the first lens 42. In the example shown in FIG. 8A, this reflected light 106a is refracted so as to be parallel to the central axis (e.g., axis of symmetry) and/or optical axis 49 of the first lens 42 as represented by refracted beam 108a.

FIG. 8A also depicts a “middle plane” 98 between the first and second lenses 42, 48 and shows the light beams or light beam portions (e.g., rays such as chief rays) propagating through the middle plane in FIG. 8B. For example, the incident light beam or light beam portion (e.g., ray such as chief ray) 102 reflected from the input mirror 100 is shown as a point referenced as “0” in FIG. 8B. As discussed above, the first reflective optical element 28 is also configured to scan in the X-Z plane or a plane parallel thereto. In particular, this first reflective optical element 28 scans through a range of angles, Δθ. The effect of the scanning of the light beam or light beam portion (e.g., ray such as chief ray) 106a reflected from the first reflective optical element 106a, for example, on the light beam or light beam portion (e.g., ray such as chief ray) 108a propagating through the middle plane is shown in FIG. 8B as a linear footprint “1”. This light is scanned through a first range of angles referred to herein as Δθ_{beam}, where Δθ_{beam}=2Δθ as discussed above in connection with FIGS. 2A and 2B.

This light beam or light beam portion (e.g., ray such as chief ray) 108a is incident on, transmitted through, and refracted by the first side 50a of the second lens 48. The refracted light beam or light beam portion (e.g., ray such as chief ray) 110a is incident on the second reflective optical element 30 at an angle and reflected therefrom. This reflected light beam or light beam portion (e.g., ray such as chief ray) 112a is reflected back to the second lens 48 by the second reflective optical element 30 at an angle so as to be incident on the second side 50b of the second lens. As discussed above, however, the second reflective optical element 30 is tilted in the Y-Z plane or a plane parallel thereto more toward the first side 50a of the second lens 48 than the second side 50b of the second lens. As a result, the reflected light beam or light beam portion (e.g., ray such as chief ray) 112a is incident on the second lens 48 closer to the geometric center 111, central axis (e.g., axis of symmetry) or optical axis 49 thereof than if the second reflective optical element 30 was not tilted with respect to the second lens and/or had a normal aligned with the central axis or optical axis of the second lens or parallel to the X-Z plane or in a plane parallel thereto in the example shown in FIG. 8A.

This reflected light beam or light beam portion (e.g., ray such as chief ray) 112a is incident on, transmitted through, and refracted by the second side 50b of the second lens 48. In the example shown in FIG. 8A, this light 112a is refracted so as to be parallel to the central axis and/or optical axis 49 of the second lens 48 as represented by refracted light 114a. This light beam or light beam portion (e.g., ray such as chief ray) 114a propagates to the second side 50b of the first lens 42. Unlike the examples shown in FIGS. 3A-3C, 5A, and 6 where the portion of the path of the light beam or light beam portion (e.g., ray such as chief ray) propagating from the first reflector 28 to the second reflector 30 and the portion of the path of the light beam or light beam portion (e.g., ray such as chief ray) propagating from the second reflector to the first reflector are symmetric, e.g., with respect to central and/or optical axis 49 of the first and second lenses 42, 48, however, in the example shown in FIG. 8A, the optical paths are asymmetric with respect to the central and/or optical axis 49 of the first and second lenses 42, 48. For example, the return light beam or light beam portion (e.g., ray such as chief ray) 114a propagating from the second lens 48 to the first lens 42 is closer to the central axis and/or optical axis 49 of the first and second lens (and/or mechanical centers of the first and/or second lenses) than the light beam or light beam portion (e.g., ray such as chief ray) 108a propagating from the first lens to the second lens.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprint created by the scanning beams. For example, a linear footprint 1′ of the light beam or light beam portion (e.g., ray such as chief ray) 114a propagating from the second side 50b of the second lens 48 to the second side of the first lens 48 is shown in FIG. 8B. This footprint 1′, caused by the scanning of the first mirror 28 by an amount through a range of an angles, Δθ, in the X-Z plane or a plane parallel thereto, corresponds to the scanning of the light beam or light beam portion (e.g., ray such as chief ray) 114a through the range of angle, Δθ_{beam}, in the X-Z plane or a plane parallel thereto. As discussed above, in this example, Δθ_{beam}=2Δθ. Sec for example, discussion of FIGS. 2A and 2B above. As a result, the two footprints 1 and 1′ are shown in FIG. 8B to have the same size (e.g., same length) at the middle plane 98.

This light beam or light beam portion (e.g., ray such as chief ray) 114a propagating from the second side 50b of the second lens 48 to the second side of the first lens 42 is refracted by the first lens so as to be incident onto the first reflective optical element 28 at an angle. This refracted light beam is referred to as 104b in FIG. 8A. Pursuant to Snell's law of reflection, this incident light 104b is reflected from the first reflective optical element 28 also at an angle as illustrated by reflected light 106b. As discussed above, with this second reflection off the first reflective optical element 28 the beam scan is increase by two-fold (e.g., from Δθ_{beam} to 2Δθ_{beam}). This reflected light beam or light beam portion (e.g., ray such as chief ray) 106b is incident on, transmitted through, and refracted by the first side 50a of the first lens 42. In the example shown in FIG. 8A, this light 106b is refracted so as to be parallel to the central axis and/or optical axis 49 of the first lens 42 as represented by refracted beam or light beam portion (e.g., ray such as chief ray) 108b.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprint created by the scanning beams. Likewise, a linear footprint 2 of the light beam or light beam portion (e.g., ray such as chief ray) 108b propagating from the first side 50a of the first lens 42 to the first side 50a of the second lens 48 is shown in FIG. 8B. This footprint 2, caused by the scanning of the first mirror 28 by an amount through a range of an angles, Δθ, in the X-Z plane or a plane parallel thereto, corresponds to the scanning of the light beam or light beam portion (e.g., ray such as chief ray) 108b through the range of angle, 2Δθ_{beam}, in the X-Z plane or a plane parallel thereto. As discussed above, the beam reflected off the first scanning mirror 28 is scanned through a range of angles Δθ_{beam}. Reflection of this scanning mirror a second time causes this range of angles to be doubled, e.g., 2Δθ_{beam}. As a result, this footprint 2 is depicted in FIG. 8B as having a larger size (e.g., being longer) than the footprints 1, 1′ of the previously reflected beams.

This light beam or light beam portion (e.g., ray such as chief ray) 108b continues to propagate and is incident on, transmitted through, and refracted by the first side 50a of the second lens 48. The refracted light 110b is incident on the second reflective optical element 30 at an angle and reflected therefrom. This reflected light beam or light beam portion (e.g., ray such as chief ray) 112b is reflected back to the second lens 48 by the second reflective optical element 30 at an angle so as to be incident on the second side 50b of the second lens. As discussed above, however, the second reflective optical element 30 is tilted in the Y-Z plane or a plane parallel thereto more toward the first side 50a of the second lens 48 than if the second mirror were normal to the central axis or optical axis of the second lens. As a result of this tilt, the reflected light beam or light beam portion (e.g., ray such as chief ray) 112b is incident on the second lens 48 closer to the geometric center 111 or central axis (e.g., axis of symmetry) or optical axis 49 thereof than if the second reflective optical element 30 was not tilted with respect to the second lens and/or had a normal aligned with the central axis or optical axis of the second lens or parallel to the X-Z plane or in a plane parallel thereto in the example shown in FIG. 8A.

This reflected light beam or light beam portion (e.g., ray such as chief ray) 112b is incident on, transmitted through, and refracted by the second side 50d of the second lens 48. In the example shown in FIG. 8A, this light 112b is refracted so as to be parallel to the central axis (e.g., axis of symmetry) and/or optical axis 49 of the second lens 48 as represented by refracted light 114b. This light beam or light beam portion (e.g., ray such as chief ray) 114b propagates to the second side 50b of the first lens 42. Unlike the examples shown in FIGS. 3A-3C, 5A, and 6 where the portion of the path of the light beam or light beam portion (e.g., ray such as chief ray) propagating from the first reflector 28 to the second reflector 30 and the portion of the path of the light beam or light beam portion (e.g., ray such as chief ray) propagating from the second reflector to the first reflector are symmetric, e.g., with respect to central and/or optical axis 49 of the first and second lenses 42, 48, however, in the example shown in FIG. 8A, the optical paths are asymmetric with respect to the central and/or optical axis 49 of the first and second lenses 42, 48. For example, the return light beam or light beam portion (e.g., ray such as chief ray) 114b propagating from the second lens 48 to the first lens 42 is closer to the central axis and/or optical axis 49 of the first and second lens (and/or mechanical centers of the first and/or second lenses) than the light beam or light beam portion (e.g., ray such as chief ray) 108b propagating from the first lens to the second lens.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprint created by the scanning beams. For example, a linear footprint 2′ of the light beam or light beam portion (e.g., ray such as chief ray) 114b propagating from the second side 50b of the second lens 48 to the second side of the first lens 42 is shown in FIG. 8B. This footprint 2′, caused by the scanning of the first mirror 28 by an amount through a range of an angles, Δθ, in the X-Z plane or a plane parallel thereto, corresponds to the scanning of the light beam or light beam portion (e.g., ray such as chief ray) 114b through the range of angle, 2Δθ_{beam}, in the X-Z plane or a plane parallel thereto, where Δθ_{beam}=2Δθ as discussed above. As a result, the two footprints 2 and 2′ are shown in FIG. 8B to have the same size (e.g., same length) at the middle plane 98.

This light beam or light beam portion (e.g., ray such as chief ray) 114b propagating from the second side 50b of the second lens 48 to the second side of the first lens 42 is refracted by the first lens so as to be incident onto the first reflective optical element 28 at an angle. This refracted light beam or light beam portion (e.g., ray such as chief ray) is referred to as 104c in FIG. 8A. Pursuant to Snell's law of reflection, this incident light 104c is reflected from the first reflective optical element 28 also at an angle as illustrated by reflected light 106c. As discussed above, with this additional (e.g., third) reflection off the first reflective optical element 28 the beam scan is increased to three-fold the angular scan of the scan of the beam off of the first mirror the first time (e.g., from Δθ_{beam} to 3Δθ_{beam}). This reflected light beam or light beam portion (e.g., ray such as chief ray) 106c is incident on, transmitted through, and refracted by the first side 50a of the first lens 42. In the example shown in FIG. 8A, this light 106c is refracted so as to be parallel to the central axis and/or optical axis 49 of the first lens 42 as represented by refracted light 108c.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprint created by the scanning beams. Likewise, a linear footprint 3 of the light beam or light beam portion (e.g., ray such as chief ray) 108c propagating from the first side 50a of the first lens 42 to the first side 50a of the second lens 48 is shown in FIG. 8B. This footprint 3, caused by the scanning of the first mirror 28 by an amount through a range of an angles, Δθ, in the X-Z plane or a plane parallel thereto, corresponds to the scanning of the light beam or light beam portion (e.g., ray such as chief ray) 108c through the range of angle, 3Δθ_{beam}, in the X-Z plane or a plane parallel thereto. As discussed above, the beam reflected off the first scanning mirror 28 is scanned through a range of angles Δθ_{beam}. Reflection of this scanning mirror a third time causes this range of angles to be doubled, e.g., 3Δθ_{beam}. As a result, this footprint 3 is depicted in FIG. 8B as having a larger size (e.g., being longer) than the footprints 2, 2′ of the previously reflected beams.

This light beam or light beam portion (e.g., ray such as chief ray) 108c continues to propagate and is incident on, transmitted through, and refracted by the first side of the second lens 48. The refracted light 110c is incident on the second reflective optical element 30 at an angle and reflected therefrom. This reflected light beam or light beam portion (e.g., ray such as chief ray) 112c is reflected back to the second lens 48 by the second reflective optical element 30 at an angle so as to be incident on the second side 50b of the second lens. As discussed above, however, the second reflective optical element 30 is tilted in the Y-Z plane or a plane parallel thereto more toward the first side 50a of the second lens 48 than if the second mirror were normal to the central axis or optical axis of the second lens. As a result this tilt, the reflected light beam or light beam portion (e.g., ray such as chief ray) 112c is incident on the second lens 48 closer to the geometric center 111 or central axis (e.g., axis of symmetry) or optical axis 49 thereof than if the second reflective optical element 30 was not tilted with respect to the second lens and/or had a normal aligned with the central axis or optical axis of the second lens or parallel to the X-Z plane or in a plane parallel thereto in the example shown in FIG. 8A.

This reflected light beam or light beam portion (e.g., ray such as chief ray) 112c is incident on, transmitted through, and refracted by the second side 50b of the second lens 48. In the example shown in FIG. 8A, this light 112c is refracted so as to be parallel to the central axis (e.g., axis of symmetry) and/or optical axis 49 of the second lens 48 as represented by refracted light 114c. This light beam or light beam portion (e.g., ray such as chief ray) 114c propagates to the second side 50b of the first lens 42. Unlike the examples shown in FIGS. 3A-3C, 5A, and 6 where the portion of the path of the light beam or light beam portion (e.g., ray such as chief ray) propagating from the first reflector 28 to the second reflector 30 and the portion of the path of the light beam or light beam portion (e.g., ray such as chief ray) propagating from the second reflector to the first reflector are symmetric, e.g., with respect to central and/or optical axis 49 of the first and second lenses 42, 48, however, in the example shown in FIG. 8A, the optical paths are asymmetric with respect to the central and/or optical axis 49 of the first and second lenses 42, 48. For example, the return light beam or light beam portion (e.g., ray such as chief ray) 114c propagating from the second lens 48 to the first lens 42 is closer to the central axis and/or optical axis 49 of the first and second lens (and/or mechanical centers of the first and/or second lenses) than the light beam 108c propagating from the first lens to the second lens.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprints created by the scanning beams. For example, a linear footprint 3′ of the light beam or light beam portion (e.g., ray such as chief ray) 114c propagating from the second side 50b of the second lens 48 to the second side of the first lens 42 is shown in FIG. 8B. This footprint 3′, caused by the scanning of the first mirror 28 by an amount through a range of an angles, Δθ, in the X-Z plane or a plane parallel thereto, corresponds to the scanning of the light beam or light beam portion (e.g., ray such as chief ray) 114c through the range of angles, 3Δθ_{beam}, in the X-Z plane or a plane parallel thereto, where Δθ_{beam}=2Δθ as discussed above. As a result, the two footprints 3 and 3′ are shown in FIG. 8B to have the same size (e.g., same length) at the middle plane 98.

This light beam or light beam portion (e.g., ray such as chief ray) 114c propagating from the second side 50b of the second lens 48 to the second side of the first lens 42 is refracted by the first lens so as to be incident onto the first reflective optical element 28 at an angle. This refracted light beam or light beam portion (e.g., ray such as chief ray) is referred to as 104d in FIG. 8A. Pursuant to Snell's law of reflection, this incident light 104d is reflected from the first reflective optical element 28 also at an angle as illustrated by reflected light 106d. As discussed above, with this additional (e.g., fourth) reflection off the first reflective optical element 28, the beam scan is increased to four-fold the angular scan of the scan of the beam off of the first mirror the first time (e.g., from Δθ_{beam} to 4Δθ_{beam}). This reflected light beam or light beam portion (e.g., ray such as chief ray) 106d is incident on, transmitted through, and refracted by the first side 50a of the first lens 42. In the example shown in FIG. 8A, this light 106d is refracted so as to be parallel to the central axis and/or optical axis 49 of the first lens 42 as represented by refracted light 108d.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprint created by the scanning beams. Likewise, a linear footprint 4 of the light beam or light beam portion (e.g., ray such as chief ray) 108d propagating from the first side 50a of the first lens 42 to the first side 50a of the second lens 48 is shown in FIG. 8B. This footprint 4, caused by the scanning of the first mirror 28 by an amount through a range of angles, Δθ, in the X-Z plane or a plane parallel thereto, corresponds to the scanning of the light beam or light beam portion (e.g., ray such as chief ray) 108d through the range of angles, 4Δθ_{beam}, in the X-Z plane or a plane parallel thereto. As discussed above, the beam reflected off the first scanning mirror 28 is scanned through a range of angles Δθ_{beam}. Reflection of this scanning mirror a fourth time causes this range of angles to be doubled, e.g., Δθ_{beam}. As a result, this footprint 4 is depicted in FIG. 8B as having a larger size (e.g., being longer) than the footprints 3, 3′ of the previously reflected beams or light beams portions (e.g., rays such as chief rays).

This light beam or light beam portion (e.g., ray such as chief ray) 108d continues to propagate and is incident on, transmitted through, and refracted by the first side of the second lens 48. The refracted light beam or light beam portion (e.g., ray such as chief ray) 110d is incident on the second reflective optical element 30 at an angle and reflected therefrom. This reflected light beam or light beam portion (e.g., ray such as chief ray) 112d is reflected back to the second lens 48 by the second reflective optical element 30 at an angle so as to be incident on the second side 50b of the second lens. As discussed above, however, the second reflective optical element 30 is tilted in the Y-Z plane or a plane parallel thereto more toward the first side 50a of the second lens 48 than if the second mirror were normal to the central axis (e.g., axis of symmetry) or optical axis 49 of the second lens. As a result of this tilt, the reflected light beam or light beam portion (e.g., ray such as chief ray) 112d is incident on the second lens 48 closer to the geometric center 111 or central axis (e.g., axis of symmetry) or optical axis 49 thereof than if the second reflective optical element 30 was not tilted with respect to the second lens and/or had a normal aligned with the central axis or optical axis of the second lens or parallel to the X-Z plane or in a plane parallel thereto in the example shown in FIG. 8A.

This reflected light 112d is incident on, transmitted through, and refracted by the second side 50b of the second lens 48. In the example shown in FIG. 8A, this light 112d is refracted so as to be parallel to the central axis (e.g., axis of symmetry) and/or optical axis 49 of the second lens 48 as represented by refracted beam or light beam portion (e.g., ray such as chief ray) 114d. This light beam or light beam portion (e.g., ray such as chief ray) 114d is directed toward the second side 50b of the first lens 42. Unlike the examples shown in FIGS. 3A-3C, 5A, and 6 where the portion of the path of the light beam or light beam portion (e.g., ray such as chief ray) propagating from the first reflector 28 to the second reflector 30 and the portion of the path of the light beam or light beam portion (e.g., ray such as chief ray) propagating from the second reflector to the first reflector are symmetric, e.g., with respect to central axis (e.g., axis of symmetry) and/or optical axis 49 of the first and second lenses 42, 48, however, in the example shown in FIG. 8A, the optical paths are asymmetric with respect to the central and/or optical axis 49 of the first and second lenses 42, 48. For example, the return light beam or light beam portion (e.g., ray such as chief ray) 114d propagating from the second lens 48 toward the first lens 42 is closer to the central axis (e.g., axis of symmetry) and/or optical axis 49 of the first and second lens than the light beam or light beam portion (e.g., ray such as chief ray) 108d propagating from the first lens to the second lens.

As discussed above, FIG. 8A depicts a middle plane 98 between the first and second lenses 42, 48 and FIG. 8B shows the light beams or light beam portions (e.g., rays such as chief rays) propagating through that middle plane 98 including the linear footprints created by the scanning beams. For example, a linear footprint 4′ of the light beam or light beam portion (e.g., ray such as chief ray) 114d propagating from the second side 50b of the second lens 48 toward the second side of the first lens 42 is shown in FIG. 8B. This footprint 4′, caused by the scanning of the first mirror 28 by an amount through a range of an angles, 40, in the X-Z plane or a plane parallel thereto, corresponds to the scanning of the light beam or light beam portion (e.g., ray such as chief ray) 114d through the range of angle, 4Δθ_{beam}, in the X-Z plane or a plane parallel thereto, where Δθ_{beam}=2Δθ as discussed above. As a result, the two footprints 4 and 4′ are shown in FIG. 8B to have the same size (e.g., same length) at the middle plane 98.

The design shown in FIG. 8A further includes an output mirror 116 configured to deflect the return light beam or light beam portion (e.g., ray such as chief ray) 114d propagating from the second lens 48 toward the first lens 42. This deflected beam or light beam portion (e.g., ray such as chief ray) 118 is referred to as the output beam or light beam portion (e.g., ray such as chief ray) and incorporates the increase in scan angle provided by multiple reflections off the first reflector 28 which is scanned, for example, in the X-Z plane or a plane parallel thereto. For example, if the first reflective optical element 28 is scanned through a range of angles, Δθ, the output beam 118 will be scanned through a range of angles 4Δθ_{beam} (where Δθ_{beam}=2Δθ as discussed above) in this example design shown in FIG. 8A. As discussed above, in various implementations, however, scan rate of the output beam is the same scan rate as the input beam is scanned. For example, the scan rate of the output beam is the same scan rate that the first reflective optical element is scanned.

As discussed above, to provide the multifold increase in scan angle, the second reflective optical element 30 is tilted, e.g., in the Y-Z plan or a plane parallel thereto, or about the X axis or an axis parallel thereto. Different amounts of tilt provide different amounts of angle multiplication, N. As discussed above, if the first reflector 28 is scanned through a range of angles, Δθ then a single reflection off the scanning mirror will cause the beam to scan through a range of angles Δθ_{beam}=2Δθ as discussed above. This design, however, can increase the scan angle of the output beam 118 by a factor of N such that the scan output beam is scanned through a range of angles NΔθ_{beam}. In the example above, N=4. However, the value of N may be different and can be determined by the amount of tilt of the second reflector 30 as well as other design parameters. Without subscribing to any scientific theory, in the design illustrated in FIG. 8A, the amount of tilt, α, of the second reflector 30 is set to L/(2fN), where L is the distance from the mechanical center of the first and/or second lenses 42, 48 and/or from the central axis (e.g. axis of symmetry) and/or optical axis 49 of the first and/or second lenses to the lateral position of the beam 108a passing through the lenses that is farthest away from the mechanical center and/or central and/or optical axis, f is the focal length of the first and/or second lenses, and N is the angle multiplier. In designs where the focal length of the first lens 42 and second lens 48 are different, f in this equation may be equal to the focal length of the second lens 48. In designs where the focal length of the first lens 42 and second lens 48 are the same, f is the focal length of both first and second lenses. In this design, the first and second lens 42, 48 comprise a 4-f optical relay where the first and second lens have the same focal length and are separated longitudinally (e.g., in the z-direction) from each other by the sum of the focal lens, 2f. The first mirror 28 is separated from the first lens 42 by the focal length of the first lens and the second mirror 30 is separated from the second lens 48 by the focal length of the second lens. Other designs however are possible, and the tilt angle may likewise be different. In various designs, the ratio of L/N corresponds to the lateral separation of adjacent beams or light beam portion (e.g., ray such as chief ray) 110, 112 at the second lens 48 and/or the lateral separation of adjacent beams or light beam portion (e.g., ray such as chief ray) 108, 114 between the first and second lenses. A wide range of different designs, however, are possible.

In particular, any one or more of the lenses in any of these systems described herein such as the angle multiplier shown in FIG. 8A, etc., may comprise a telecentric lens. The telecentric lens can provide that the chief rays (14c) refracted by the telecentric lens (42) are directed parallel to the optical axis of the telecentric lens.

Additionally, in an alternative design such as shown in FIG. 8C, the angle multiplier can be constructed by offsetting the optical axis, central axis (e.g., axis of symmetry) 49 and/or center (e.g., mechanical center) of the first lens 42 and the optical axis or central axis (e.g., axis of symmetry) 49′ and/or center (e.g., mechanical center) of the second lens 48 laterally with respect to each other. The axes 49, 49′ and/or centers of the two lenses 42, 48 are offset laterally with respect to each other in a direction that is the same direction as the axis of rotation over which the beam is scanned by the first reflector 28. This axis of rotation might be the axis of rotation 32 over which the first reflector 28 is rotated. In the example shown, for instance, the axes 49, 49′ of the two lenses 42, 48 are offset laterally with respect to each other in a direction along the Y axis or an axis parallel thereto. This offset may result in asymmetric propagation of rays through the system 16 and/or through the first and second lenses 42, 48, for example, with respect to the optical axis, central axis (e.g., axis of symmetry) and/or center (e.g., mechanical center) of the first lens 42 and/or with respect to the optical axis, central axis (e.g., axis of symmetry) and/or center (e.g., mechanical center) of the second lens 48. Consequently, the rays shown in the example propagating from the second lens 48 to the first lens 42 are a different distance from the optical axis or central axis (e.g., axis of symmetry) 49 and/or center (e.g., mechanical center) of the first lens 42 than the rays propagating from the first lens to the second lens. As a result, the optical path of the light going back and forth between the first and second reflectors 28, 30 and through the first and second lens 42, 48 is not symmetrical with respect to the first and second lenses and/or the axes 49, 49′ therethrough or centers thereof such that the light is redirected back and forth between the first and second reflectors multiple times. As a result of multiple reflections from the first scanning reflector 28, the angle of the scan is multiplied by a factor of N, where N corresponds to the number of times the beam (e.g., chief ray) is reflected from the first rotating reflector 28. Also, as a result of the lateral offset of the axes 49, 49′ and/or centers of the first and second lenses 42, 48 with respect to each other, the amplified scans are not overlapped in space. In the example shown, the axes 49, 49′ and/or centers of the first and second lenses 42, 48 are laterally offset with respect to each other by a distance L/2N, with the path of adjacent rays (e.g., chief rays) between the first and second lenses 42, 48 shown as being separated from each other by L/N as discussed above. In the example shown, the second mirror 30 is not tilted with respect to the optical axis or central axis (e.g., axis of symmetry) 49′, 49 of the second lens 48 and/or first lens 42. Rather, in the example shown, the normal of the second mirror 30 is parallel to the optical axis or central axis (e.g., axis of symmetry) 49′, 49 of the second lens 48 and/or first lens 42. However, in some implementations, the second mirror 30 is tipped or tilted with respect to the optical axis or central axis (e.g., axis of symmetry) 49′, 49 of the second lens 48 and/or first lens 42 in a plane in which the beam (e.g., chief ray) is scanned or a plane parallel thereto. Likewise, in various implementations, the normal of the second mirror 30 is tipped or tilted with respect to the optical axis or central axis (e.g., axis of symmetry) 49′, 49 of the second lens 48 and/or first lens 42 in the plane in which the beam (e.g., chief ray) is scanned or a plane parallel thereto. For example, the second mirror 30 may be tipped (or tilted) in the XZ plane or plane parallel thereto with the beam (e.g., chief ray) also being scanned by the first reflector 28 in the XZ plane or plane parallel thereto. Likewise, the normal of the second mirror 30 may be tipped (or tilted) with respect to the optical axis or central axis (e.g., axis of symmetry) 49′, 49 of the second lens 48 and/or first lens 42 in the XZ plane or plane parallel thereto while the beam is also scanned by the first reflector 28 in the XZ plane or plane parallel thereto. Similarly, the second reflective optical element may have a normal that is tipped (or tilted) with respect to the optical axis or central axis 49, 49′ of the first and/or second lens 42, 48 in a plane orthogonal to the axis of rotation 32 that the first reflective optical element is configured to rotate about. Such a tilt may shift the angle and/or location of the scanned beam, for example, the center of the scan.

Note that such a lateral offset of the optical axis, central axis (e.g., axis of symmetry) 49′ and/or center (e.g., mechanical center) of the second lens 48 with respect to the optical axis or central axis (e.g., axis of symmetry) 49 and/or center (e.g., mechanical center) of the first lens 42 may be included in the angle scanning systems 16 and phase modulation systems 116 shown in FIGS. 3A-3B, 5A, 6, and 9. The axes 49, 49′ and/or centers of the two lenses 42, 48 are offset laterally with respect to each other in a direction that is the same direction as the axis of rotation over which the beam is scanned by the first reflector 28. This axis of rotation might be the axis of rotation 32 over which the first reflector 28 is rotated. In the example shown in FIGS. 3A-3B, 5A, 6, and 9, for instance, the axes 49, 49′ of the two lenses 42, 48 are offset laterally with respect to each other in a direction along the Y axis or an axis parallel thereto. The offset may result in asymmetric propagations of rays through the system 16 and/or through the first and second lenses 42, 48, for example, with respect to the optical axis, central axis (e.g., axis of symmetry) 49 and/or center (e.g., mechanical center) of the first lens 42 and/or with respect to the optical axis, central axis (e.g., axis of symmetry) 49′ and/or center (e.g., mechanical center) of the second lens 48. Consequently, the rays shown in the example propagating from the second lens 48 to the first lens 42 are a different distance from the optical axis or central axis (e.g., axis of symmetry) 49 and/or center (e.g., mechanical center) of the first lens 42 than the rays propagating from the first lens to the second lens. As a result of the lateral offset of the axes 49, 49′ and/or centers of the first and second lenses 42, 48 with respect to each other, the amplified scans are not overlapped in space. Consequently, polarization optics such as polarization beamsplitters and/or quarter wave retarders need not be employed to separate the incoming and outgoing beams. Excluding such polarization optics may reduce the optical loss of the system. Excluding such polarization dependent components also may allow a wider variety of polarization states of the incident beam than the linear polarization coupled into the system 16. With regard to the system 16 shown in FIGS. 8A and 8C, other variations are also possible. For example, the scan mirror 28 and the tilt mirror 30 can be chirped mirrors. Chirped mirror may be configured to compress the broadening laser pulses. A chirped mirror may comprise, for example, a multi-layer coated mirrors (e.g., a multilayer dielectric stack) with different layers at different depths configured to reflect different wavelength of light. In the example shown, the pulsed laser beam propagates through the first and second lenses 42, 48 a total 16 times. As a result of chromatic dispersion, the pulse width will be broadened, reducing the excitation efficiency of the two-photon absorption process. Using chirped mirrors for the scan mirror and the tilt mirror can mitigate the pulse broadening.

As illustrated and discussed above in connection with the systems shown in FIGS. 8A and 8C, the input beam and the output beam are not overlapping in contrast to the system shown in FIG. 6. Such a configuration where the input and output beams are not overlapping is beneficial as the polarization components (e.g., polarizing beam splitter and the quarter wave plate) arranged to separate the two beams are not needed. As discussed above, instead a pick-off reflector or mirror may be employed to redirect the output beam. Excluding the polarization beamsplitter and quarter waveplate may potentially reduce optical loss. Excluding polarization dependent components also allows a wider variety of polarization states of the incident beam than the linear polarization coupled into the system.

As with the angle doubler, this angle multiplier may be used for and/or integrated in a laser scanning microscope 10. For example, either or both the angle doubler or the angle multiplier may be used with laser scanning microscopes 10 and/or other types of scanning microscopes or systems that employ laser scanning, such as a laser scanning confocal microscope, a two-photon microscope, a three-photon microscope, a harmonics generation microscope, a stimulated Raman scattering microscope, a coherent anti-stoke Raman scattering microscope, a photoacoustic microscope, a light sheet microscope, an optical coherent microscope, or a system for 3D printing/polymerization/machining or ranging with laser illumination and so on, or possibly non-scanning microscopes. Additionally, the systems described herein can be compatible with different kinds of beam steerers or scanners, such as the micro-electromechanical systems (MEMS) scanners or the polygonal scanners, which may benefit from angle doubling or angle multiplying.

As discussed above, the angle doubler and multiplier can be used for non-imaging applications such as 3D/2D remote sensing, laser machining, two-photon polymerization, one-photon polymerization, 3D printing and more. A wide range of variations in design, however, are possible.

As discussed above, for example, the angle doubling and angle multiplying apparatus and methods discussed herein may be used with beam steering technologies other than scanning mirrors, or technologies for non-mechanical steering of optical beams. Such technologies may include but are not limited to active diffractive optical elements such as reflective diffractive optical elements that are active as opposed to passive components. Such active diffractive optical elements include reflective acousto-optical modulators (see, e.g., “Reflective acousto-optic modulation with surface acoustic waves”, Applied Optics, Vol. 43, Issue 14, pp. 2920-2924 (2004), https://doi.org/10.1364/AO.43.002920). Other types of beam steering technologies include phase arrays such as reflective 1d or 2d phase arrays including but not limited to liquid crystal spatial light modulators, MEMS mirror arrays and electrowetting prism arrays (see e.g., “A Review of Phased Array Steering for Narrow-Band Electrooptical Systems” Proceedings of the IEEE, Volume: 97, Issue: 6, pp. 1078-1096, June 2009, DOI: 10.1109/JPROC.2009.2017218). Such beam steerers (e.g., active reflective diffractive optical elements, phase arrays, liquid crystal spatial light modulators, MEMS mirror arrays, electrowetting prism arrays, etc.), like the scanning or rotating mirrors discussed above, can be electrically connected to electrical circuitry such as control electronics that can cause the beam or beams to be reflected from the beam steerer at different angles. The electrical circuitry or control electronics may, for example, be configured to direct the light beam at different angles depending on the signal applied by the electrical circuitry thereto. As such, one or more electrical signals from the electrical circuitry may be applied to the beams steerer to scan the light beam through a first range of angles, Δθ_{beam}. Likewise, the light beam may reflect off the beam steerer N times to scan the light beam through a second range of angles N times the first range of angles, e.g., NΔθ_{beam}. Similar principles apply when the beam steerer comprises an active diffractive optical element, a phase array or a rotating mirror such as discussed above. For example, electrical circuitry may be electrically connected to active diffractive optical elements (e.g., acousto-optical modulators), phase arrays, liquid crystal spatial light modulators, MEMS mirror arrays, electrowetting prism arrays, galvanometers, piezoelectric actuators (piezos), motors, other actuators configured to move mirrors, MEMS mirrors, etc. to provide signals thereto to scan the beam steerer regardless of the type.

Additionally, the angle doubling unit and angle multiplier may, as a result of additional optical elements having wavelength dispersion, such as the beamsplitter 74 and lenses 42, 48, introduce extra dispersion to laser pulses output by the laser 12. Such dispersion may broaden the pulse width at the imaging or sample plane and potentially reduce the excitation efficiency. Therefore, pulse compensation in the laser system may be adjusted after incorporating the angle doubling unit or angle multiplier unit. The polarization beam splitter cube may, for example, introduce dispersion. Such dispersion can be mitigated by using a polarizing beam ‘plate’, instead of a beamsplitter cube. Additionally, as discussed above, chirped mirror can help mitigate the pulse broadening. A pulse compressor (e.g., chirped pulse compressor) may also reduce broadening. Other variations are possible.

For example, the pick off reflector may be located elsewhere. For example, the pick off reflector may pick off the light beam 108d propagating from the first lens 42 or from the first reflector 28 (as opposed to the light beam 114d propagating from the second lens or from the second reflector). The light maybe be picked off at any location in the system 16, so that the number of times the light is incident off the scanning reflector and the multiplication factor, N, can be changed and thus controlled. Still other variations are possible. Likewise, the configuration can be operated in reverse. For example, the input light beam could be turned by a mirror along a path closer to the central axis (axis of symmetry) and/or optical axis 49 of the first and/or second lenses 42, 48 and then move out farther from the central axis (axis of symmetry) and/or optical axis 49 with progressive passes between the first and second reflectors 28, 30. For example, the ray trace shown in FIG. 8A may be reversed.

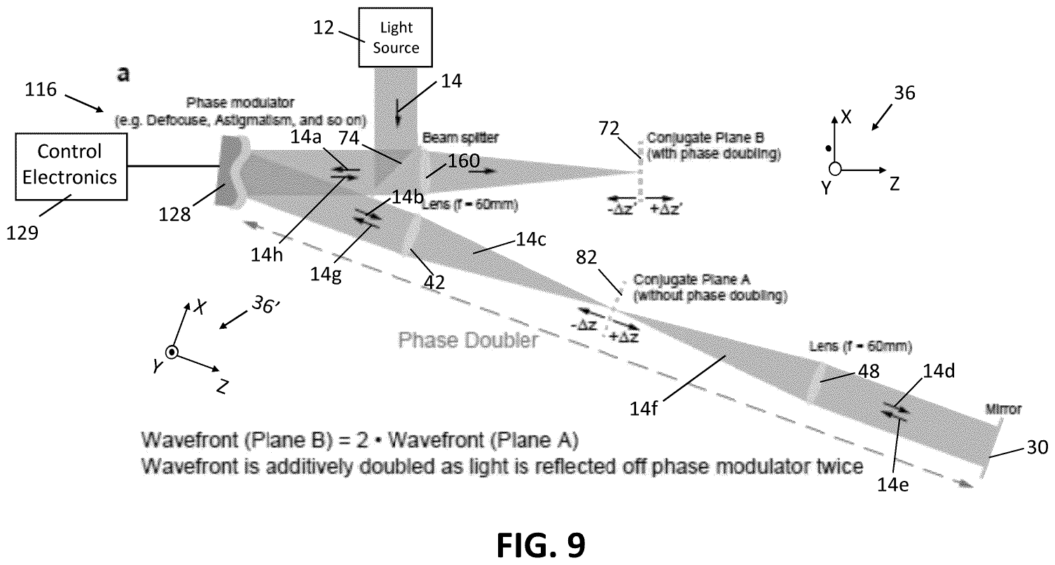

In some implementations, for example, the first reflective optical element 28 comprises a phase modulator such as a deformable mirror. FIG. 9, for example, shows a phase modulation system 116 similar to the angle doubled beam scanner 16 of FIGS. 3A-3C, 5A, and 6, comprising first and second reflective optical elements 128, 30 and first and second lenses 42 and 48 in an optical path between the first and second reflectors, wherein the first reflective optical element comprises a phase modulator.

The phase modulator 128 may comprise an adaptive optical element such as a reflective adaptive optical element like a deformable mirror. The phase modulator 128 may include a spatial light modulator such as an electrically controlled phase modulator. In some implementations, the phase modulator 128 includes a plurality of pixels, wherein different pixels comprise different reflective elements that can be configured to impart different phase shifts onto different portions of a light beam incident on the plurality of pixels and/or to vary the shape of the wavefront reflected from the phase modulator. The pixels may comprise a 2-dimensional (2D) array or a 1-dimensional (1D) array in different implementations. The phase modulator may be electrically connected to electronics or circuits such as control electronics or control circuit(s) configured to provide electrical signals to the phase modulator to modulate the amount of phase imparted on the light beam incident on the phase modulator and/or to control the shape of the wavefront reflected from the phase modulator. In some implementations, the electronics may be configured to provide electronic signals to the control the different pixels such that different pixels provide different amounts of phase shift to light incident thereon and/or are otherwise varied to alter the shape of the wavefront reflected from the phaser modulator. The phase modulator may comprise, for example, a deformable mirror, a liquid crystal spatial light modulator, or a digital micro-mirror device (DMD). The deformable mirror may comprise either a continuous mirror member on an array of actuators (e.g., piezoelectric actuators) or an array of segmented small mirrors also controlled by individual actuators. For phase modulation, the mirror surface is usually actuated at different heights, similar to how a piston works, to generate the different wavefronts. The liquid crystal based light phase modulator rotates the angle of the liquid crystals to create the phase profile using the birefringence property of the liquid crystals. A digital micro-mirror device (DMD) can modulate the phase by tilting the array of the mirrors, too. The DMD phase modulator may, for example, comprise a plurality or an array of MEMS mirrors. The phase modulator may be electrically controlled by the electronics (e.g., control electronics or control circuit(s)) such that different DMD or MEMs mirrors can be tilted by different amounts so as to provide different amounts of phase shift and/or provide a wavefront of desired shape. Although the phase modulator is shown as being reflective, in other designs the phase modulator is transmissive. The phase modulator may comprises a 2-dimensional (2D) modulator array or a 1-dimensional (1D) modulator array.

Accordingly, in various implementations, the phase modulator 128 includes one or more reflective surfaces that can be configured to be angled to reflect light therefrom to form a wavefront having a desired shape. The phase modulator may, for example, comprise a deformable mirror and/or a MEMs array and the light incident thereon may comprise a planar wavefront. By changing the shape of the deformable mirror and/or a MEMs array, for example, from a planar reflector to a spherical reflector or a reflector having localized shape for producing a spherical wavefront (e.g., a Fresnel lens shape), a spherical wavefront may be produced from a plane wave incident on the phase modulator. Accordingly, portions of the surface or individual deformable mirrors of the phase modulator may be actuated or configured to reflect the planar wavefront in a manner to produce the spherical wavefront. As discussed above, the phase modulator may comprise a 2D spatial light modulator configured to modulate phase. An example of such a 2D spatial light modulator is a 2D liquid crystal spatial light modulator configured to modulate the phase of light transmitted therethrough and/or reflected therefrom. As discussed above, the phase modulator may comprise a transmissive phase modulator that modulates the phase of light transmitted therethrough and/or a reflective phase modulator that modulates the phase of light reflected therefrom. FIG. 9 shows a reflective phase modulator and a configuration suitable for such a reflective phase modulator, however, other configurations suitable for transmissive phase modulators such as transmissive spatial light modulators like 2D liquid crystal arrays or liquid crystal spatial light modulators are possible.

The phase modulation system 116 shown in FIG. 9 is configured similar to the angle doubler 16 of FIGS. 3A-3C, 5A and 6 to increase the effect of the phase modulator, e.g., the deformable mirror or liquid crystal spatial light modulator, on the incident wavefront by reflecting the light multiple times of the phase modulator. Likewise, the shape of the wavefront produced by reflecting the incident beam 14a from the first reflective optical element 128, e.g., the deformable mirror or liquid crystal spatial light modulator, may be enhanced. Effectively, the change in the phase of the different portions of the wavefront that are modulated by the deformable mirror or liquid crystal spatial light modulator are increased, for example, are doubled. For example, if the phase of the wavefront produced by the phase shifting is Δz(x,y), the phase of the wavefront produced by the phase modulation system 116, which includes the first reflector (e.g., phase modulator) 128 comprising the phase modulator like a deformable mirror and/or liquid crystal spatial light modulator, the first and second lenses 42, 48 and the second reflector 30, produces a phase modulation of 2Δz(x,y).

In various implementations, the phase modulation on the phase modulator (such as the deformable mirror and the liquid crystal spatial light modulator) is a result of the displacement of the actuator (e.g., piezoelectric actuator) or the rotation of the liquid crystals. The wavefront (phase profile) gets doubled in the phase doubler is because the optical layout permits the light to interact (e.g., reflect off or transmit through) the phase modulator twice in a correct orientation.

As illustrated in FIG. 9, the input to the phase modulation system 116 is a light source 12 (e.g., laser or laser source) that outputs a light beam 14 (e.g., laser beam). A beamsplitter 74 may, for example, be used to optically couple the light beam 14 to the phase modulator 128. The beamsplitter 74 is shown, for example, in an optical path of the first reflective optical element, the phase modulator, 128, and the light source 12 such that the light beam 14 output by the light source can be directed to the first reflective optical element/phase modulator. In the example shown, the beamsplitter 74 is configured to reflect the light 14 from the light source 12 to direct the light beam to the first reflective optical element or phase modulator 128, although other configurations are possible. As discussed above, in some implementations, the beamsplitter 74 comprises a polarizing beamsplitter that reflects one polarization (e.g., s-polarized light) and transmits another polarization (e.g., p-polarized light). The phase modulation system 116 may further comprise polarization optics such as a quarter wave retarder (not shown) in the optical path of the first and second reflective optical elements 128, 30 and/or between the first and second lens 42, 48. See, for example, the quarter wave retarder/quarter waveplate 84 shown in FIG. 6. The quarter wave retarder 84, however, may be located elsewhere, such as between the beamsplitter 74 and the first reflective optical element (e.g., phase modulator) 128. As discussed above, with two passes through the quarter wave retarder 84, the polarization of linear polarized light may be rotated. For example, s-polarized (which is reflected by the polarization beamsplitter 74) light may be rotated 90° to become p-polarization light (which is transmitted by the polarization beamsplitter). Other configurations, however, are possible. For example, the polarization beamsplitter 74 may reflect p-polarized light and transmit s-polarization light and the quarter waveplate 84 may transform the p-polarized light into s-polarization light with two passes therethrough. Still other configurations are possible. For example, a non-polarizing beam splitter such as a power or intensity beamsplitter that splits light based on the optical power or intensity ratio (e.g., 50:50) also can be employed, especially for the liquid crystal based spatial light modulator.

As discussed above, the phase modulation system 116 comprises first and second reflective optical elements 128, 30. The first reflective optical element 128 comprises a phase modulator, for example, a reflective phase modulator such as a deformable mirror and/or a reflective spatial light modulator like a reflective liquid crystal spatial light modulator. The second reflective optical element 30 may comprise, for example, a planar mirror such as shown in FIG. 9A. First and second lenses 42, 48 are disposed in an optical path between the first and second reflective optical elements 128, 30. The first and second lenses 42, 48 may comprise positive lenses in various designs. As illustrated, the second lens 48 is not included in an array of lenses. For example, the second lens 48 is not a lenslet in an array of lenslets. Similarly, the first lens 42 is not included in an array of lenses and is not a lenslet in an array of lenslets. Either or both of the first and/or second lenses not being included in a lens array, e.g., not comprising a lenslet in a lenslet array, may increase the field-of-view. Nevertheless, in some designs, a lenslet array may be employed in such phase modulation systems 116. For example, in some such implementations, one or both the first and/or second lens 42, 48 comprises lenslets in an array of lenslets. In some designs, the first and second lenses 42, 48 may form an optical relay such as an afocal relay and thus the first and second lenses may be separated from each other by a distance, a longitudinal distance (e.g., in the z-direction or in a direction parallel to the z-axis) equal to the sum of the focal lengths of the respective first and second lenses. In the example shown, the first and second lenses 42, 48 have the same focal length, f, and the lenses are separated by a longitudinal distance of 2f. In various implementations, such as the one shown in FIGS. 3A-3C and 5A, the first reflective optical element (e.g., phase modulator) 128 is located at the front focal plane of (e.g., a focal distance away from) the first lens 42 and the second reflective optical element (e.g., planar mirror) is located at the back focal plane of (e.g., a focal distance away from) the second lens 42. In such a system, the optical relay formed by the first and second lenses 42, 48 may be referred to as a 4-f relay. Other types of relays, however, may be employed.

In the example shown, the first and/or second lenses 42, 48, have a central axis (e.g., axis of symmetry) and/or optical axis therethrough. Additionally, in the example shown in FIG. 9, the second reflective optical element or mirror 30 has a normal coincident with and/or as least in the same plane (e.g., Y-Z plane or plane parallel thereto) as the central axis and/or optical axis of the first and/or second lenses 42, 48. The normal of the mirror 30 does not necessarily need to be aligned with the optical axis or central axis (e.g., axis of symmetry) of the lens 48 or the Z-axis 36′ or an axis parallel thereto. This mirror 30 can be tilted or tipped around one or two (orthogonal) axes in a fixed angle or dynamically to shift the center of the doubled wavefront around at the imaging plane, intermediate focal planes and/or conjugate planes A and B. For example, the mirror 30 can be tipped and/or tilted with respect to the optical axis and/or central axis (e.g., axis of symmetry) of the first lens 42 or an axis parallel to either or both of these. Likewise, the mirror 30 can be tipped and/or tilted with respect to the optical axis and/or central axis (e.g., axis of symmetry) of the second lens 48 or an axis parallel to either or both of these. For example, the mirror 30 can be tilted about an axis of rotation parallel to the Y direction shown in FIG. 9. Alternately or additionally, the mirror 30 can be tipped about an axis of rotation in the XZ plane shown in FIG. 9 or a plane parallel thereto. In some implementations the mirror 30 may comprise a planar mirror. In some implementations, the mirror 30 may comprise a dual-axis mirror. FIG. 9 also shows a focal plane 82, e.g., an intermediate focal plane, between the first and second lenses 42, 48.

FIG. 9 additionally shows a lens such as lens 160 disposed to receive light reflected from the first reflective optical element or phase modulator 128 that is transmitted through the beamsplitter 74. A focal plane 72 produced by this lens 160 is also shown.

In the example depicted in FIG. 9, the focal plane 82 between the first and second lenses 42, 48 and the focal plane 72 produced by the lens 160 are conjugate planes. As indicated in the drawing shown in FIG. 9, at the focal plane 82 between the first and second lenses 42, 48, the light beam has imparted thereon the phase shift of the phase modulator 128. At the focal plane 72 produced by the lens 160, after the light has reflected off the phase modulator 128 twice, the light beam has twice or two-fold (2×) the phase shift and/or waveform deformation of the phase modulator 128.

Accordingly, a light beam 14, e.g., a laser beam, output by the light source (e.g., laser light source) 12, is directed to the beamsplitter (e.g., polarization beamsplitter or power beamsplitter) 74 and reflected therefrom to the first reflective optical element, the phase modulator 128. In various implementations, the light beam 14 is polarized such that the light beam is reflected by the polarization beamsplitter 74. The light beam 14a incident on the phase modulator 128 is reflected therefrom. This reflective light beam 14b has a phase shift and/or shape change imparted thereon by the phase modulator. Accordingly, the phase modulator 128, by providing such a phase shift and/or shape change, may alter the wavefront of the light beam 14b reflected from the phase modulator. For example, a planar wavefront may be incident on the phase modulator and the phase modulator may impart a phase or shape change on that planar wavefront to transform the planar wavefront into another wavefront such as for example a spherical wavefront, a wavefront with defocus, astigmatism, or any other arbitrary wavefront as desired. As illustrated, in the example shown in FIG. 9, the light beam 14b reflected from the phase modulator 128 is received by the first lens 42, which in this design, focuses the beam down to an intermediate focal plane 82 between the first and second lenses 42, 48. The light beam 14c continues onto the second lens 48 and is transmitted therethrough and refracted thereby. The light beam 14d transmitted through the first and second lenses 14d is incident on the second reflective optical element 30, a planar mirror in this design and reflected therefrom. The light beam 14e reflected from the second reflective optical element 30 returns to the second lens 48 and is transmitted there though. The second lens 48 is shown in FIG. 9 focusing the light beam 14f onto the intermediate focal plane 82. This light beam 14f continues to the first lens 42 and is transmitted therethrough and refracted thereby. The light beam 14g transmitted through the first lens 42 is incident on and reflected by the first reflective optical element or phase modulator 128 a second time. The light beam 14h reflected from the first reflective optical element or phase modulator 128 returns to the beamsplitter 74 and is transmitted therethough. This light reflected from the first reflective optical element 128 a second time has twice (2×) or two-fold the phase shift or shape change imparted by the phase modulator. Accordingly, if the phase modulator is set to provide a phase shift or shape change Δz(x,y) on the wavefront 14a incident on the phase modulator a first time, the phase modulation system 161 will provide a doubling of this phase shift or shape change such that 2Δz(x,y) is imparted on the wavefront in the light beam 14h reflected from the phase modulator a second time.

As illustrated, the light beam is transmitted through the beamsplitter and to the lens. As discussed above, this lens 160 is depicted as focusing the light beam 14h onto a focal plane 82, which may be an output or an intermediate focal plane 72 depending on the implementation of the phase modulation system, for example, the possible integration of the phase modulation system in a larger system. The phase of the wavefront at this focal plane 72 will include the phase shift (e.g., Δz(x,y)) imparted by the phase modulator 128 enhanced by a factor of two (e.g., 2Δz(x,y)).

Accordingly, like the angle doubling beam scanning systems 16, 16′, shown in FIGS. 3A-3C, 5A, and 6, phase doubling is possible by replacing a scan mirror or angle scanner 28 with a phase modulator (such as a spatial light modulator or a deformable mirror) 128, for example, in an optical system including an optical relay (e.g., afocal, possibly 4-f relay) and reflector 30. In this phase doubling system 116, a phase profile implemented with a phase modulator 128 can be doubled in an additive manner, as a flat wavefront of a collimated input beam 14a is modulated twice as a result of reflecting off the same phase modulator twice.

A wide range of designs and configurations are possible. For example, FIG. 9 shows a reflective phase modulator; however, a transmissive phase modulator such as a transmissive liquid crystal spatial light modulator that modulates the phase of light transmitted therethrough can be employed. Thus, the phase modulation doubling may be applied to a transmissive phase modulator. Additionally, as stated above, any one or more of the lenses in any of these systems 16 described herein such as the phase modulation system shown in FIG. 9, etc., may comprise a telecentric lens. The telecentric lens can provide that the chief rays (14c) refracted by the telecentric lens (42) are directed parallel to the optical axis or central axis (e.g., axis of symmetry) of the telecentric lens.

Also, as discussed above, the second reflector 30 in FIG. 9 can be tilted or tipped around one or two (e.g., orthogonal) axes to shift the center of the doubled wavefront at the imaging plane, the intermediate planes, or the conjugate planes.

Additionally, in some implementations, the phase modulator 128 may comprise a two-dimensional (2D) phase modulator array. In other implementations, phase modulator 128 may comprise a one-dimensional (1D) phase modulator array. In some implementations, the reflector 30 may comprise a retroreflector. In such embodiments, the phase modulator 128 may comprise a one-dimensional (1D) phase modulator array. In some implementations, the first and/or second lenses 42, 48 may comprise a telecentric lens and the phase modulator 128 may comprise a one-dimensional (1D) phase modulator array.

Additionally, the reflective optical element 28 in the system shown in FIG. 8A may comprise a phase shifter to provide an N-fold increase in phase shift. The configuration may be similar to the system 16 shown in FIG. 8A with the first reflective optical element 28 comprising a phase modulator 128 such as a deformable mirror or spatial light modulator like a liquid crystal spatial light modulator. In some such implementations, the phase modulator 128 may comprise a one-dimensional (1D) phase modulator array.

Moreover, any of the systems, devices, designs and methods described herein for doubling or increasing scan angle may be applied to increasing phase shift and/or modifying a wavefront using a phase modulator in combination with the doubling units and multiplier units described herein. Any variations and features of such apparatus and methods may be applied to the phase modulation systems as well. Likewise, a retroreflector may be used as the second reflective optical element 30 in the phase modulation system 116 and the second lens 48 may be removed. The configuration may be similar to the system 16 shown in FIG. 7A with the first reflective optical element 28 comprising a phase modulator 128 such as a deformable mirror or spatial light modulator like a liquid crystal spatial light modulator. As discussed above, the phase modulator 128 may comprise a one-dimensional (1D) phase modulator array. Additionally, in some implementations, the first lens 42 may comprise a telecentric lens. Accordingly, such a design may be similar to the system 16 shown in FIG. 7B with the first reflective optical element 28 comprising a phase modulator 128 such as a deformable mirror or spatial light modulator like a liquid crystal spatial light modulator. Again, as discussed above, in some such implementations, the phase modulator 128 may comprise a one-dimensional (1D) phase modulator array.

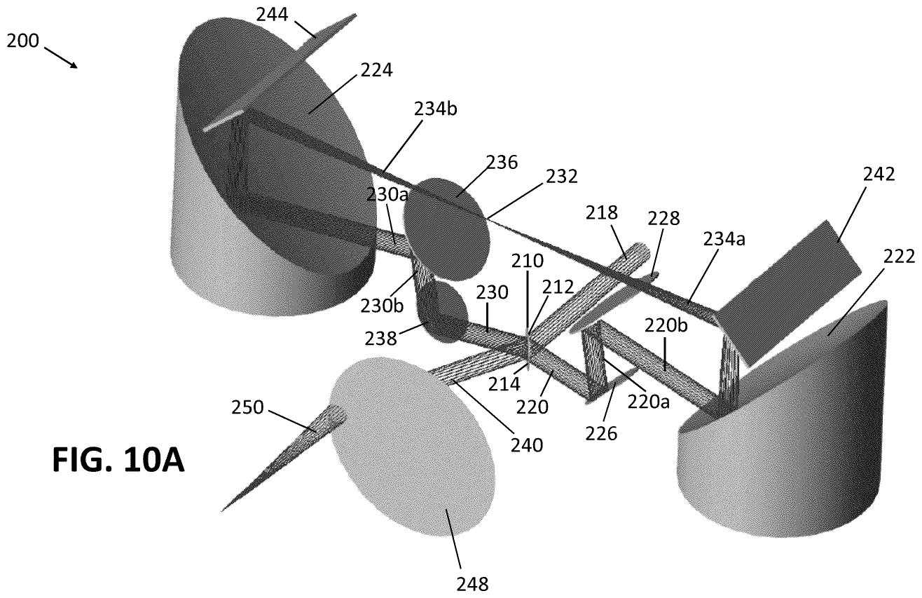

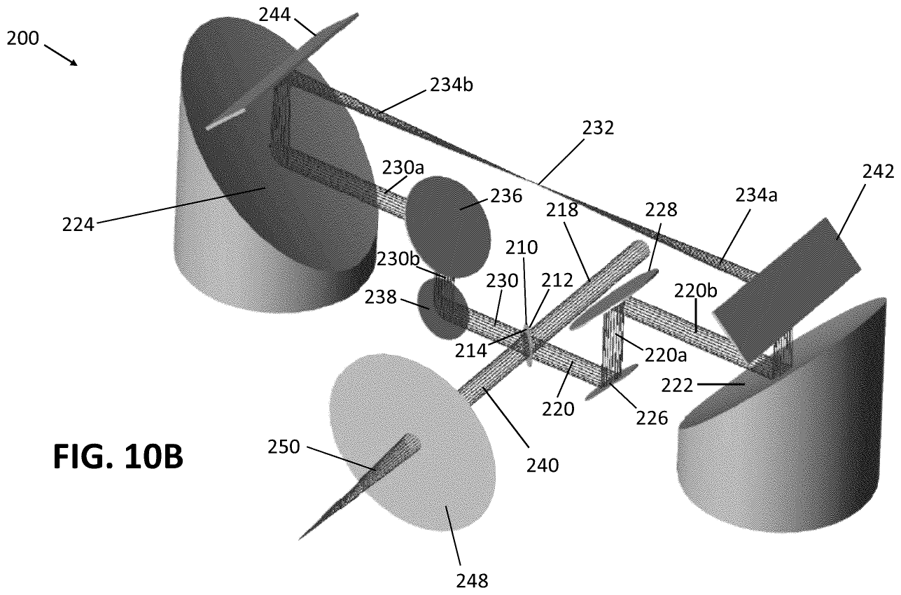

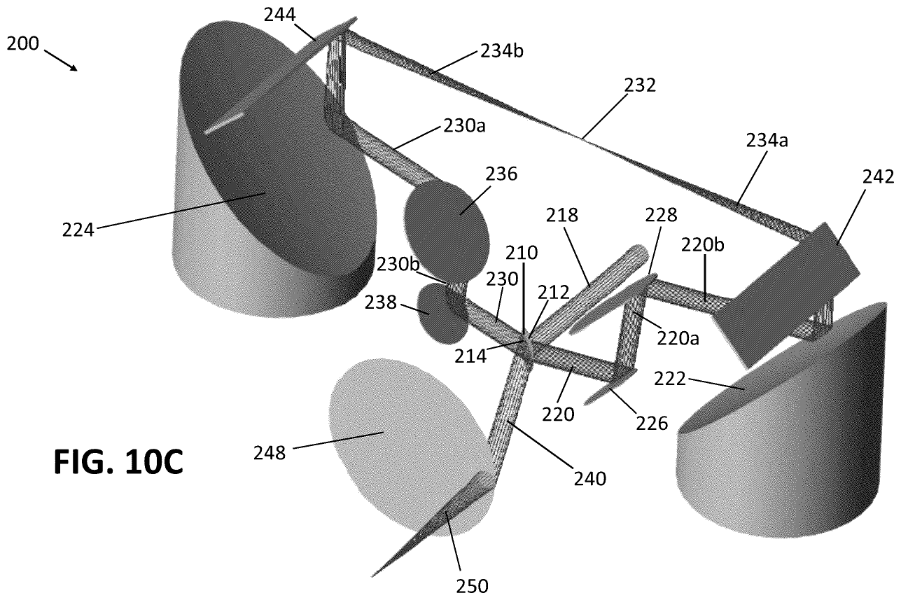

FIGS. 10A-10C depict another angle doubler design that employs a reflective optical relay (instead of a lens relay) thereby reducing the effects of chromatic dispersion. In the example system 200 shown, a two-sided mirror 210 having first and second sides 212, 214, both configured to reflect light, is rotated to provide a scanning beam. An input beam 218 reflects off the first side 212 of the rotating two-sided mirror 210 to a plurality of reflective optics configured to direct the beam 220 reflected off the first side of the double-sided mirror to the second side 214 of the two-sided mirror to reflect off the second side as well. With reflection off both the first and the second sides 212, 214 of the two-sided mirror 210, the effect of rotation of the double-sided mirror is doubled.

In the example shown, the input beam 218 is depicted as a collimated beam. The collimated beam may be provided by a light source 12, such as a laser source, such as described above. The light source 12 may comprise, for example, a laser that outputs a collimated laser beam 14 such as shown in FIG. 6. Unlike the design shown in FIG. 6, however, a beamsplitter 74 such as a polarization beamsplitter or possibly a power beamsplitter is not used to couple the light into the angle doubler 200 in this example. Nor is polarization optics like the retarder (e.g., quarter wave retarder or quarter waveplate) used. Nor is the linearly polarized light (e.g. s-polarization or p-polarization) required.

As discussed above, this collimated beam 14, 210 is directed onto a double-sided reflective optical element or a double-sided mirror 210. The double-sided mirror 210 has first and second reflective surfaces 212, 214 on opposite sides thereof. The double-sided mirror 210 may be rotated by a stage, mount, base, platform, support such as described elsewhere herein configured to rotate (e.g., tip, tilt, spin, etc.) possibly using galvanometers or other motors (including but not limited to stepper motors, voice coil motors, etc.), piezo electric elements or piezos (e.g. bimorphs) or other actuators such as described herein or otherwise. The double-sided mirror 210 may comprise, for example, a plate (e.g., a glass plate) or other substrate having first and second opposite sides with reflective coatings thereon to provide the first and second reflective surfaces 212, 214. The coatings may comprise metallization such as silver or may comprise dielectric such as dielectric interference coatings configured to reflect light such as light having the wavelength of the input beam. In some implementations, the surface itself may be reflective without having a coating thereon. For example, a polished substrate such as polished aluminum or silver substrate may be employed. Also, although a thin substrate may be lightweight and thus increase scan rates, the reflective optical element may comprise other structures. A cube or prism, for example, having reflective coating on opposite sides thereof may provide for the first and second reflective surfaces 212, 214. Other types of two-sided reflective optical elements, polished or unpolished may be employed. For example, diffractive elements that reflect and diffract light may be located on opposite sides of a substrate that may be rotated for example by a stage, mount, base, platform, support such as described elsewhere herein configured to rotate (e.g., tip, tilt, spin, etc.) the diffractive optical elements. Such a diffractive optical element (e.g., a grating) may be referred to as a passive diffractive optical element as the diffractive optical element itself does not change. As described above, such reflective diffractive optical elements may be rotated. In another configuration, two such passive reflective diffractive optical elements on respective stage, mount, base, platform, supports, that are configured to rotate (e.g., tip, tilt, spin, etc.) the passive reflective diffractive optical elements. Rotation of the passive reflective diffractive optical elements may cause light reflected therefrom to be rotated through a range of angles, 40, such as described herein.

Similarly active diffractive optical elements may be employed. Such active diffractive optical element may comprise reflective diffractive optical elements. An example of such an active diffractive optical elements is an acousto-optic modulator such as a reflective acousto-optic modulator (see, e.g., “Reflective acousto-optic modulation with surface acoustic waves”, Applied Optics, Vol. 43, Issue 14, pp. 2920-2924 (2004), https://doi.org/10.1364/AO.43.002920). A light beam incident on such an active reflective diffractive optical element may be reflected and diffracted therefrom at an angle that may be scanned by electrically controlling the active diffractive optical element. In some implementations, a pair of reflective active diffractive optical elements (e.g., reflective acousto-optic modulators) can be located on opposite side of a substrate. Such reflective active diffractive optical elements may be synchronized in various implementations. For example, the scanning of the beams reflected and diffracted on opposite sides may be synchronized. In other implementations, reflective active diffractive optical elements (e.g., reflective acousto-optic modulators) having two sides that can each reflect light (e.g., light beams) incident thereon may be used. As discussed above, the active reflective diffractive optical elements can scan the angle of the beam reflected therefrom. Such active reflective diffractive optical elements can be electrically connected to electrical circuitry that can cause the beam or beams reflected from the diffractive optical element to be reflected and diffracted therefrom at different angles. The electrical circuitry may, for example, be configured to reflect/diffract the light beam at different angles depending on the signal applied by the electrical circuitry thereto. As such, one or more electrical signals from the electrical circuitry may be applied to the active reflective diffractive optical element to scan the reflective/diffractive light beam through a range of angles, Δθ.

Accordingly, other types of beam steering technologies other than scanning mirrors, or technologies for non-mechanical steering of optical beams may be employed. Other types of beam steering technologies include phase arrays such as reflective 1d or 2d phase arrays including but not limited to liquid crystal spatial light modulators, MEMS mirror arrays and electrowetting prism arrays (see e.g., “A Review of Phased Array Steering for Narrow-Band Electrooptical Systems” Proceedings of the IEEE, Volume: 97, Issue: 6, pp. 1078-1096 June 2009, DOI: 10.1109/JPROC.2009.2017218). Once again, electronic circuitry such as control electronics may be electrically connected to such beam steerers (e.g., phase arrays, liquid crystal spatial light modulators, MEMs mirror arrays, electrowetting prism arrays, etc.) to provide signals thereto scan beams incident thereon through a range of angles, Δθ_{beam}. The electrical circuitry or control electronics may, for example, be configured to direct the light beam at different angles depending on the signal applied by the electrical circuitry thereto. As such, one or more electrical signals from the electrical circuitry may be applied to the beam steerer to scan the light beam through a first range of angles, Δθ_{beam}. Similar principles apply when the beam steerer comprises an active diffractive optical element, a phase array or a rotating mirror such as discussed above. For example, electrical circuitry may be electrically connected to active diffractive optical elements (e.g., acousto-optical modulators), phase arrays, liquid crystal spatial light modulators, MEMS mirror arrays, electrowetting prism arrays, galvanometers, piezo electric actuators (piezos), motors or other actuators configured to move mirrors, MEMS mirrors, etc. to provide signals thereto to scan the beam steerer regardless of the type.

Also, although the example design shown in FIGS. 10A-10C employs a double-sided mirror, which may comprise a monolithic structure having reflective surfaces on opposite sides thereof, the first and second surfaces 212, 214 need not be so limited. For example, separate reflective optical elements, e.g., separate mirrors, may be employed. For example, the first and second reflective surfaces 212, 214 may be on respective first and second reflective optical elements such as first and second mirrors, respectively, that rotate together. These first and second reflective optical elements, for example, mirrors, may be mounted on the same scanning mount such as a galvanometer, linear scanner, resonant scanner, etc., such that rotation of the scanning mount causes simultaneous rotation of both the first and second mirror and thus simultaneous rotation of the first and second reflective surfaces. Still other configurations are possible. For example, two independent mirrors on individual galvanometers can be rotated synchronically with the electrical control. Similarly, a pair of other types of reflectors such as 2D dual axis mirrors or mirrors that tip due to piezo actuation, voice coils or other actuators. In addition, beam scanning or deflecting can be generated with the active diffractive optical elements such as an acousto-optic modulator (e.g., a reflective acousto-optic modulator) or phase arrays or other active beam steerers. Two such beam steerers may be employed. Electronics may apply signals to such beam steerers.

As discussed, in the example shown in FIGS. 10A-10C, the double-sided mirror is mounted on a scanning mount that is configured to cause the rotation of the double-sided mirror. This scanning mount may comprise for example a galvanometer, linear scanner, resonant scanner, motor, piezo(s), or other actuators etc. The first and second reflective surfaces 212, 214 may face opposite directions such as shown in FIGS. 10A-10C. The scanning mount may rotate through a range of angles, Δθ, thereby the causing first and second reflective surfaces 212, 214 on the scanning mount to rotate through this range of angles Δθ. As discussed above, the range of angles scanned, Δθ, can be symmetric or asymmetric, e.g., −7° to +7° or −6° to +11°.

The first reflective surface 212 is disposed to receive the incoming light beam 218 from the light source 12 (e.g., laser light source) and reflect this light beam. As the first reflective surface 212 rotates through a range of angles, Δθ, with the rotation of the scanning mount, the light beam 220 reflected therefrom is scanned over a first range of angles, 2Δθ. Sec, for example, FIGS. 2A-2B, which is described above.

The beam scanner 200 shown in FIGS. 10A-10C further comprises an optical relay comprising first and second curved reflective optical elements 222, 224. These reflective optical elements 222, 224 have optical power and respective focal lengths. In some implementations, these optical elements 222, 224 comprise parabolic reflectors or parabolic mirrors having parabolically shaped reflective surfaces. In some designs, these reflectors 222, 224 are off-axis reflectors such as off-axis parabolic reflectors.

The beam scanner design shown in FIGS. 10A-10C further comprises a first group of planar reflectors or mirrors, in this example, comprising first planar reflector or mirror 226 and second planar reflector or mirror 228, to convey the light beam 220 reflected from the first reflective surface 212 on the first side of the double-sided mirror 210 to the optical relay and in particular to the first curved optical reflector 222. Although two planar mirrors are shown, more or less mirrors may be used depending on the configuration.

As illustrated, the light beam 220 reflected from the first reflective optical element 212 on the first side of the double-sided mirror 210 is reflected from the first planar reflector or mirror 226 in the first group. This reflected beam is referred to as beam 220a in FIGS. 10A-10C. This beam 220a is reflected from the second planar reflector or mirror 228 in the first group toward the first curved optical reflector 222. This beam reflected from the second planar reflector/mirror 228 and incident on the first curved optical reflector 222 is referred to as beam 220b in FIGS. 10A-10C. Although two planar mirrors are shown in this first group, more or less mirrors may be used to convey the light from the first reflective optical surface 212 to the first curved optical reflector 222 depending on the configuration. In some implementations, the first group of planar reflectors or mirrors may be employed to provide the beam 220b with a suitable height.

In various implementations such as shown in FIGS. 10A-10C, the first and second curved reflectors 222, 224 are arranged in the optical path of the light beam 220, 220a, 220b reflected from the first reflective optical surface 212 to form an optical relay. This optical relay formed by these curved reflective optical elements 222, 224 is, for example, similar to the relay formed by the first and second lenses 42 and 48 shown in FIG. 6. The reflective optical relay shown in FIGS. 10A-10C relay the light beam, referred to herein as beam 230, to the second reflective optical surface 214 on the second side of the double-sided mirror 210. In this example, however, the optical relay formed by these curved reflectors 222, 224 comprises reflective optical elements (e.g., mirrors) as opposed to refractive optical elements (e.g., lenses) thereby reducing chromatic dispersion, which may introduce pulse dispersion and broadening.

The first and second curved reflectors 222, 224 may form an afocal relay such as shown in FIGS. 10A-10C. As such, a collimated light beam 220b incident on the first curved reflector 222 may reflect off the second curved reflector 224 also as a collimated beam 230. As illustrated, in such a design, the light reflected from the first curved reflector 222 may be focused down at a location (e.g., intermediate focal plane) 232 in the optical path between first and second curved reflectors 222, 224. Beams 234a, 234b are shown as the converging beam focused down by the first curved reflector 222 onto the intermedial focal plane or focus 232 and as the beam diverging from the intermediate focal plane or focus to the second curved reflector 224, respectively.

As discussed above, for an afocal system, the first and second curved reflectors 222, 224 may have focal lengths (e.g., reflected focal lengths (RFL)) and/or be separated from each other in the optical path of the light beam 220b, 234b by the sum of the respective focal lengths (e.g., reflected focal lengths) of the two curved reflectors. In some designs such as the designs shown, the focal length such as the reflected focal length of the first and second curved reflectors 222, 224 may be the same. In such cases, the first and second curved reflector 222, 224 may be separated along the optical path by a distance of 2f or twice the reflected focal length. In some implementations, the system may comprise a 4-f system such as discussed above. Although the relay comprises a 4-f afocal relay in this example, the beam scanner design need not be so limited. The relay need not comprise a 4-f relay. For example, the focal lengths of the first and second curved reflectors 222, 224 need not be identical. Additionally, in some designs, the relay need not be an afocal relay.

As discussed above, light from the relay is directed onto the second reflective optical surface 214 on the second side of the double-sided mirror 210 and reflected therefrom. The beam reflected off the second reflective optical surface 214 on the second side of the double-sided mirror 210 is shown as beam 2Δθin FIGS. 10A-10C.

The second reflective optical surface 214 is configured to rotate through a range of angles, Δθ, with the rotation of the scanning mount on which the double-sided mirror 210 is mounted. Accordingly, the light beam 240 reflected from the second reflective optical surface 214 is scanned over a range of angles. Moreover, the light beam 240 reflected from the second reflective optical surface 214 on the second side of the double-sided mirror 210 is scanned over a second range of angles larger than said first range of angles, Δθ, over which double-sided mirror 210 and the second reflective optical surface are scanned.

As discussed above, the light beam 218 input into the laser scanner 200 is incident on the first reflective optical surface 212, which rotates through a range of angles, Δθ, with the rotation of the double-sided mirror 210 and the rotation of the scanning mount on which the double-sided mirror is mounted. Likewise, the light beam 220 reflected from the first reflective optical surface 212 is scanned over a range of angles. This range of angles over which the light beam 220 reflected from the first reflective optical surface 212 is scanned is larger than the range of angles, Δθ, over which the first reflective optical surface scanned, and for example, may be two time (2×) as large. Accordingly, in various implementations, the range of angles over which the light beam 220 reflected from the first reflective optical surface 212 is scanned is 2Δθ.

Additionally, the range of angles over which the light beam 240 reflected from the second reflective optical surface 214 is scanned is larger than the range of angles, Δθ, over which the second reflective optical surface is scanned, and for example, is two time (2×) as large. Moreover, the combination of reflection of the input beam 218 off the first reflective optical surface 212 and the reflection of the light beam 230 incident on the second reflective optical element 214 as the double-sided mirror 210 and the first and second reflective optical surfaces are rotated through a range of angles, Δθ0, result in the scanning of the light beam 240 reflected off the second reflective optical surface through a larger range of angles than either the rotation of either the first or second reflective optical surfaces alone. Reflection off both the reflective optical surfaces 212, 214 compounds (e.g., doubles) the increase in scan angle. In particular, in various implementations, the range of angles over which the light beam 240 reflected from the second reflective optical surface 214 is scanned is 4Δθ, where Δθ is the range of angle over which the first and second reflective optical surfaces 212, 214 are rotated. Similarly, the light beam 240 reflected from the second reflective optical surface 214 is scanned over a second range of angles (e.g., 4Δθ) larger than said first range of angles (e.g., 2Δθ) over which light is reflected from the first reflective optical surface 212.

The beam scanner design shown in FIGS. 10A-10C further comprises a second group of planar reflectors or mirrors, in this example, comprising a first planar reflector or mirror 236 and a second planar reflector or mirror 238, to convey the light beam from the optical relay (e.g., reflected from the second curved reflector 224) to the second reflective optical surface 214 on the second side of the double-sided mirror 210. As illustrated, the light beam reflected from the second curved reflective optical reflector 224 is directed to the first planar reflector or mirror 236 in the second group. This beam incident on the first planar reflector or mirror 236 is referred to as beam 230a in FIGS. 10A-10C. This beam 230a is reflected from the first planar reflector or mirror 236 in the second group toward the second planar reflector or mirror 238. This beam incident on the second planar reflector or mirror 238 is referred to as beam 230b and is directed toward the reflective optical surface 214 on the second side of the double-sided mirror 210. This beam reflected from the second planar reflector/mirror 238 and incident on the second reflective optical surface 214 on the second side of the double-sided mirror 210 is referred to as beam 230 in FIGS. 10A-10C. Although two planar mirrors are shown in this second group, more or less mirrors may be used to convey the light from the optical relay (e.g., the second curved reflector 224) to the second reflective optical surface 214 on the second side of the double-sided mirror 210 depending on the configuration. In some implementations, the second group of planar reflectors or mirrors may be employed to provide the beam 230 with a suitable height (e.g., to be incident on the second reflective optical element 214 on the second side of the double-sided mirror 210.

The beam scanner design shown in FIGS. 10A-10C further comprises a pair of planar reflectors or mirrors 242, 244 within the optical relay, e.g., between the first and second curved reflectors 222, 224. The first planar reflector 242 in the pair is in the optical path between the first curved reflector 222 and the focus 232. Likewise, the second planar reflector 244 in the pair is in the optical path between the focus 232 and the second curved reflector 224. This first planar reflector 242 in the pair is above the first curved reflector 222, while the second planar reflector 244 in the pair is above the second curved reflector 224. The pair of reflectors 242, 244 redirects light from the first curved reflector 222 to the second curved reflector 224. The first and second curved reflectors 222, 224 comprises off-axis reflectors to couple light to and from the first and second planar reflectors 242, 244, which are above the first and second curved reflectors 222, 224. The pair of planar reflectors 242, 244 also enables the light beam 234a, 234b to travel over some of the other optics such as the planar reflectors or mirrors 228, 236 in the first and second groups of planar reflectors or mirrors, respectively, such that the optical path of the relay is not obstructed by these optical elements in the first and second groups of planar reflectors/mirrors. Other configurations are possible.

In the example shown in FIGS. 10A-10C, the beam scanner has a symmetrical design. For example, the first and second curved reflectors 222, 224 are on opposite sides of the double-sided mirror 210 and/or the first and second reflective surfaces 212, 214. Likewise, the planar reflectors or mirrors 242, 244 within the optical relay, are on opposite sides of the double-sided mirror 210 and/or the first and second reflective surface 212, 214 and may be equal distance from the respective first and second curved reflectors 222, 224 and/or the intermediate focus 232. Similarly, the first and second groups of planar reflectors or mirrors are on opposite sides of the double-sided mirror 210 and/or the first and second reflective surface 212, 214 and may be equal distances from the first and second curved reflectors 222, 224, respectively. The first and second groups of planar reflector or mirrors may also be equal distances from the respective first and second reflective optical surfaces 212, 214 and/or double-sided mirror 210. In some implementations, the intermediate focus 232 is above (e.g., directly above) the input beam 218 and/or is the same distance to the first and second curved reflective optical elements 222, 224 as the double-sided mirror 210 and/or first and second reflective optical surfaces 212, 214 are to the first and second curved reflectors 222, 224, respectively. Other configurations are possible.

FIGS. 10A-10C show the double-sided mirror 210 and the first and second reflective surfaces 212, 214 in different positions within a scan. Similarly, the beam 240 output from the beam scanner (or rotating double sided mirror) 210 has different scan angles. FIG. 10B, for example, shows the double-sided mirror 210 and the first and second reflective surfaces 212, 214 oriented at about 45° with respect to the input beam 218, whereas FIGS. 10A and 10C shows the double-sided mirror 210 and the first and second reflective surfaces 212, 214 oriented at about 51° and 39°, respectively, e.g., 45°+6°, with respect to the input beam 218. Likewise, FIG. 10B shows the output beam 240 directed parallel to the input beam 218, while FIGS. 10A and 10C shows the output beam directed at an angle of about −24° and +24°, respectively, with respect to the input beam 218. FIGS. 10B and 10C may represent endpoints on an angular beam scan although, in other implementations, the output beam 240 may be scanned more or less.

FIGS. 10A-10C also show the movement of the various beams with rotation of the first and second reflective surfaces 212, 214 and/or the doubled-sided mirror 210. For example, beams 220 and 220a are incident on the first group of reflectors 226, 228 at different lateral positions. Similarly, the light beam 220b is incident on the first curved reflector 222 and the light beam is incident on the second curved reflector at different lateral positions. Additionally, the light beam from the first curved reflector 222 is directed on the first and second reflectors 242, 244 in the pair of reflectors at different lateral positions. Hence these mirrors are sufficiently wide. The beams 230a and 230b are also incident on the second group of reflectors 236, 238 at different lateral positions and thus need to be sufficiently large (e.g., wide).

FIGS. 10A-10C additionally show a scan lens 248 configured to receive the light beam 240 output by the beam scanner 200. This scan lens 248 has a focal length and is positioned with respect to the beam scanner 200, e.g., with respect said second reflective optical surface 214 and/or double-sided mirror 210 such that the light beam 240 output from the beam scanner 200 at a plurality of different angles is directed along the same angle, for example, along the central axis (e.g., axis of symmetry) and/or optical axis of the scan lens. FIGS. 10A-10C, for example, each show beam 250 exiting the scan lens 248 at the same angle, despite FIGS. 10A-10C showing the light beam 240 input into the scan lens at different angles. The light beam 250, however, will be positioned at different lateral positions, e.g., with respect to the central axis (e.g., axis of symmetry) and/or optical axis of the lens 248, as the angle of the beam 240 output by the beam scanner 210 is changed with angle scanning. As illustrated by FIGS. 10A-10C, the light beam 240 output by the beam scanner 200 is incident on the scan lens 248 at different locations depending on the orientation of double-sided mirror 210 and the first and second reflective optical surfaces 212, 214. Similarly, as illustrated by FIGS. 10A-10C, as the double-sided mirror 210 and the first and second reflective optical surfaces 212, 214 are rotated, the light beam 250 output by the scan lens 248 is focused on the image plane at different lateral locations. The scan lens 248 thus provides that the light beam 250 may be laterally scanned across an object such as a sample while the light beam may be incident on the sample at the same angle as the position of the beam is scanned laterally across the sample.

The scan lens 248 may also focus the light beam 250 to a focus, for example, on the sample. In some implementations, the scan lens 248 focuses the light beam onto an intermediate focal plane (similar to the intermediate focus 72 shown in FIG. 6). This intermediate focal plane may be a conjugate to the sample plane. For example, a microscope objective may image the intermediate focal plane onto a sample plane or sample. In some implementations, one or more optical relays may convey light from the intermediate focal plane to the microscope objective.

The beam scanner 200 shown in FIGS. 10A-10C can provide increased angular scanning, which may increase the field-of-view on various optical systems such as laser scanning microscopes as well as other systems that employ beam scanners. By primarily, if not solely, employing reflective optics, e.g., mirrors, as opposed to refractive optics, e.g., lenses, chromatic dispersion introduced by the beam scanner can be reduced. For pulsed laser systems such as 2-photon microscopy, which employed pulse lasers, chromatic dispersion can cause temporal broadening of the laser pulses. Decreasing chromatic dispersion introduced by the optics included in the beam scanner 200 can thus reduce resultant pulse broadening. In some implementations, the reflective optics are achromatic while in others the reflective optics are reflective across a wide wavelength range (e.g. broadband).

The system 200 may also be compact. For example, the system has the folded configuration. Mirrors are employed to redirect beams such that one or more optical paths are parallel to one or more others, thereby reducing size (e.g., footprint). In addition, the input beam 218 and the output beam 240 do not overlap in space, as opposed to the design in FIG. 3A-3C, and FIG. 6. Therefore, additional optics (e.g., polarization optics) used to separate the input beam and the output beam is not needed, which reduces the number of optical elements (e.g. polarizing beam splitter and quarter waveplate) and potentially the footprint. Furthermore, without using the polarizing dependent elements, the polarization state of the input beam 218 is not limited to a linearly polarized state.

Off-the-shelf components may also be employed, thereby reducing cost.

A wide range of variations in design are possible. As discussed above, for example, in place of a double-sided mirror 210 two separate reflective optical elements or mirrors may be mounted on the scanning mount. Instead of the first and second reflecting optical surfaces 212, 214 being on opposite sides of a single unitary double-sided mirror 210, the first and second reflecting optical surfaces may comprise respective reflective surfaces on separate first and second reflectors (e.g., mirrors) both of which are mounted on the scanning mount. The beam scanner 200 would operate as described above, with the first and second reflective optical surfaces 212, 214 rotating together by an amount, Δθ, and introducing an amount of angular rotation of 4Δθ, after completing reflection off both the first and second reflective surfaces. Also, as described above, beams having scan angles of ±4Δθ may be achieved. However, the scan angle of the output beam 240 need not be as large and/or need not be symmetrical in different implementations.

Additionally, as stated above, any one or more of the lenses in any of these systems described herein such as the angle doubler system shown in FIGS. 10a-10c, etc., may comprise a telecentric lens. The telecentric lens can provide that the chief rays (14c) refracted by the telecentric lens (42) are directed parallel to the optical axis or central axis (e.g., axis of symmetry) of the telecentric lens.

The off-axis reflectors 222, 224 need not be limited to 90° off-axis mirrors. The off-axis mirror may comprise, for example, one or more 15° off-axis reflectors, 30° off-axis reflectors, 45° off-axis reflectors, 60° off-axis reflectors, or off-axis reflectors having other angles. In such cases, the configuration of reflectors 226, 228, 242, 244, 236, 238 may also be different. Different numbers and/or arrangements of reflectors 226, 228, 242, 244, 236, 238 may be employed to accommodate different angle off-axis reflectors 222, 224. Still other variations are possible.

The phase modulation systems 116 described herein may be advantageous in reducing the requirements for phase modulators 128 such as deformable mirrors. A deformable mirror may comprise a mirror having a reflective surface adjustable using a number of actuators (e.g., piezoelectric actuator) underneath or behind the reflective surface. By applying different stroke displacements to the different actuators (e.g., piezoelectric actuator), the shape of the mirror surface can be varied. The larger the range of displacement of the stroke, the more variable surface the deformable mirror could be. The cost of the deformable mirror, however, scales with not only the number of strokes but also the maximum stroke displacement. Replacing the scanning mirror 28 with a deformable mirror 128 transforms the angle-doubling beam scanning system 16 into a phase-doubling (or stroke-doubling) phase modulation system 116. By employing the phase modulation system architecture disclosed herein, a less expensive deformable mirror (or phase modulator) 128 may be used to provide the phase shift of a more expensive deformable mirror. The stoke size of a deformable mirror may be effectively increased by a factor of two. In general, the settling time of the stroke displacement can also scale with the stroke displacement. The phase modulation system 116 disclosed herein can also decouple the displacement of the stroke from the settling time; while the stoke displacement is doubled, the settling time may remain unchanged.

As discussed above, a wide range of variations in designs are possible. For example, although chief rays have been shown in a number of the drawing, e.g., FIGS. 3A-3C, and 8A, wider beams may be propagate through the lenses 42, 48 and incident on and reflected by the reflective optical elements 28, 30. Likewise, although a portion of the light may be incident on one side of the lens or reflective optical element or surface thereof, in various implementations, the beam may be incident on, reflected from and/or propagated through both sides of the lens or reflective optical element or surface.

Similarly, although some designs includes retroreflectors, see e.g., FIGS. 7A-7C, many designs exclude retroreflectors.

Also as discussed above, the angle doubling and angle multiplying apparatus and methods discussed herein may be used with beam steering technologies other than scanning mirrors, or technologies for non-mechanical steering of optical beams. Such technologies may include but are not limited to active diffractive optical elements such as reflective diffractive optical elements that are active as opposed to passive components. Such active diffractive optical elements include reflective acousto-optical modulators (see, e.g., “Reflective acousto-optic modulation with surface acoustic waves”, Applied Optics, Vol. 43, Issue 14, pp. 2920-2924 (2004), https://doi.org/10.1364/AO.43.002920). Other types of beam steering technologies include phase arrays such as reflective 1d or 2d phase arrays including but not limited to liquid crystal spatial light modulators, MEMS mirror arrays and electrowetting prism arrays (see e.g., “A Review of Phased Array Steering for Narrow-Band Electrooptical Systems” Proceedings of the IEEE, Volume: 97, Issue: 6, pp. 1078-1096, June 2009, DOI: 10.1109/JPROC.2009.2017218). Such beam steerers (e.g., active reflective diffractive optical elements, phase arrays, liquid crystal spatial light modulators, MEMS mirror arrays, electrowetting prism arrays, etc.), like the scanning or rotating mirrors discussed above, can be electrically connected to electrical circuitry such as control electronics that can cause the beam or beams to be reflected from the beam steerer at different angles. The electrical circuitry or control electronics may, for example, be configured to direct the light beam at different angles depending on the signal applied by the electrical circuitry thereto. As such, one or more electrical signals from the electrical circuitry may be applied to the beams steerer to scan the light beam through a first range of angles, Δθ_{beam}. Similar principles apply when the beam steerer comprises an active diffractive optical element, a phase array or a rotating mirror such as discussed above. For example, electrical circuitry may be electrically connected to active diffractive optical elements (e.g., acousto-optical modulators), phase arrays, liquid crystal spatial light modulators, MEMS mirror arrays, electrowetting prism arrays, galvanometers, piezos, motors or other actuators configured to move mirrors, MEMS mirrors, etc. to provide signals thereto to scan the beam steerer regardless of the type.

### EXAMPLES

This disclosure provides various examples of devices, systems, and methods of. Some such examples include but are not limited to the following examples.

### Examples—Part 1A—Angle Doubler—Two Lenses, Second Lens not an Array

1. A beam scanner comprising:
a first reflective optical element disposed to receive a light beam and reflect said light beam a first time, said first reflective optical element configured to cause said light beam reflected therefrom said first time to be scanned over a first range of angles;
a first lens disposed to receive said light beam reflected from said first reflective optical element such that said light beam is transmitted through said first lens;
a second lens disposed to receive said light beam transmitted through said first lens, said second lens not comprising a lens array and not being included in a lens array; and
a second reflective optical element disposed to receive said light beam transmitted through said second lens and to reflect said light back to said second lens such that said light is transmitted through said first lens back to said first reflective optical element to be reflected therefrom a second time thereby being scanned over a second range of angles larger than said first range of angles.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Examples 2-6, wherein said second range of angles is four times said range of angles that said first reflective optical element is rotated.

8. The beam scanner of any of the examples above, wherein said first reflective optical element comprises a mirror configured to be rotated.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-23, wherein said beam steerer is electrically connected to control electronics configured to cause said beam reflected from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 kHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of any of Example 42, wherein said control electronics is configured to cause said second reflective optical element to be rotated.

44. The beam scanner of any of the examples above, wherein said second reflective optical element is not a retroreflector or part of a retroreflector.

45. The beam scanner of any of the examples above, wherein said first lens comprises a positive lens.

46. The beam scanner of any of the examples above, wherein said first lens does not comprise a lens array or is not included in a lens array.

47. The beam scanner of any of the examples above, wherein said beam scanner does not include a lens array.

48. The beam scanner of any of the examples above, wherein said first lens comprises a telecentric lens.

49. The beam scanner of any of the examples above, wherein said first lens has a focal length and is positioned a focal length away from said first reflective optical element.

50. The beam scanner of any of Examples 2-49, wherein said first reflective optical element is configured to rotate through said range of angles around an axis of rotation and said first lens has a focal length and is positioned a focal length away from the axis of rotation of said first reflective optical element.

51. The beam scanner of any of the examples above, wherein said first lens has a front and back and first and second sides on each of said front and back, said first lens disposed to receive a ray of light reflected from said first reflective optical element on said first side of said front of said first lens such that said ray of light is transmitted through said first side of said first lens and exits said first side on said back of said first lens.

52. The beam scanner of Example 51, wherein said second reflective optical element is disposed to receive said ray of light from said first side of said back of said first lens and to reflect said ray of light back to said first lens on said second side of said back of said lens such that said ray of light that transmitted through said first side of said first lens is transmitted through said second side of said first lens back to said first reflective optical element to be reflected therefrom a second time.

53. The beam scanner Example 52, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagate parallel to said optical axis.

54. The beam scanner of any of Examples 51-53, wherein said ray of light is a chief ray of a light beam.

### Second Lens

55. The beam scanner of any of the examples above, wherein said second lens is in an optical path between said first lens and said second reflective optical element.

56. The beam scanner of any of the examples above, wherein said second lens has a focal length and is positioned a focal length away from said second reflective optical element.

57. The beam scanner of any of the examples above, wherein said first and second lenses each have an optical axis, central axis, axis of symmetry, center, mechanical center, or any combination thereof that are offset with respect to each other in a lateral direction.

58. The beam scanner of Example 57, wherein said lateral direction is along the direction of an axis of rotation about which said light beam reflected from said first reflective optical element said first time is scanned by said first reflective optical element.

59. The beam scanner of Example 57 or 58, wherein said lateral direction is along the direction of an axis of rotation about which said first reflective optical element is rotated.

60. The beam scanner of any of Examples 57-59, further comprising a pick-off reflector to extract an output beam.

61. The beam scanner of Example 60, wherein said pick-off reflector is between said first and second lenses.

62. The beam scanner of any of the examples above, wherein said second lens comprises a telecentric lens.

63. The beam scanner of any of the examples above, wherein said second lens has a front and back and first and second sides on each of said front and back and said second lens is disposed to receive a ray of light reflected off said first reflector said first time that is transmitted through a first side of said front of said first lens such that said ray of light reflected off said first reflector and transmitted through said first side of said front to said first lens is incident on and transmitted through said first side of said second lens, reflected from said second reflector and is incident on and transmitted through said second side of said second lens and said second side of said first lens back to said first reflector.

64. The beam scanner of any of the examples above, wherein said second lens has an optical axis and a focal length and is positioned such that said ray of light reflected off said first reflector and transmitted through said first side of said front of said first lens is incident on said first side of said second lens parallel to said optical axis of said second lens and is refracted by said second lens at an angle and reflected from said second reflector at an angle with respect thereto.

65. The beam scanner of any of Example 64, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

66. The beam scanner of Example 65, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said ray of light is incident on said first reflector at an angle such that said ray of light is reflected off said first reflector said second time and scanned over said second range of angles.

67. The beam scanner of any of Examples 63-66, wherein said ray of light is a chief ray of a light beam.

### Laser

68. The beam scanner of any of the examples above, further comprising a light source configured to output said light beam that is directed to said first reflective optical element said first time.

69. The beam scanner of Example 68, further comprising a beamsplitter disposed to receive said light beam output by said light source and direct said light beam from said light source to said first reflective optical element.

70. The beam scanner of Example 69, wherein said beamsplitter is disposed to receive said light beam reflected from said first reflective optical element after being reflected by said first reflective optical element to said second reflective optical element and back to said first reflective optical element.

71. The beam scanner of Example 69 or 70, wherein said beamsplitter is disposed in an optical path between said light source and said first scanning reflector.

72. The beam scanner of any of Examples 69 to 71, wherein said beamsplitter comprises a non-polarizing beamsplitter.

73. The beam scanner of any of Examples 69 to 71, wherein said beamsplitter comprises a polarization beamsplitter.

74. The beam scanner of Example 73, further comprising a quarter wave retarder disposed between said polarization beamsplitter and said second reflective optical element configured to rotate linearly polarized light by about 90°.

75. The beam scanner of Example 74, wherein said quarter wave retarder is disposed between said first reflective optical element and said second reflective optical element.

76. The beam scanner of any of Examples 69-75, further comprising a microscope objective disposed to receive from said beamsplitter said light beam reflected from said first reflective optical element directed to said beamsplitter.

77. The beam scanner of Example 76, further comprising at least one lens in an optical path between said first reflective optical element and said microscope objective.

78. The beam scanner of Example 77, wherein said at least one lens comprises a scan lens in the optical path between said first scanning reflector and said beamsplitter.

79. The beam scanner of Example 77 or 78, wherein said at least one lens comprises a tube lens in said optical path between said beamsplitter and said microscope objective.

80. The beam scanner of Example 77 to 79, wherein said at least one lens comprises a first and second lenses that form an afocal relay between said first reflective optical element and said microscope objective.

81. The beam scanner of Example 80, wherein said first and second lenses that form an afocal relay each have focal length and said first and second lenses are separated by the sum of said focal lengths.

82. The beam scanner of Example 80 or 81, further comprising a focusing lens disposed to receive said light beam output by said light source and to focus said light beam onto a focal point of said first and second lenses of said plurality of lenses.

83. The beam scanner of any of Examples 76 to 82, further comprising an optical detector and a beamsplitter disposed in an optical path between said microscope objective and said optical detector and in an optical path between said microscope objective and said first reflective optical element.

84. The beam scanner of any of Examples 68 to 83, wherein said light source comprises a laser configured to output a laser beam that is directed to said first reflective optical element.

### Laser Scanning Microscope

85. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

86. The beam scanner of Example 85, further comprising a beamsplitter disposed in an optical path between said first reflective optical element and said microscope objective.

87. The beam scanner of any of the examples above, wherein said beam scanner is included in a laser scanning microscope.

88. The beam scanner of any of the examples above, wherein said beam scanner is included in a scanning fluorescence microscope.

89. The beam scanner of any of the examples above, wherein said beam scanner is included in a laser scanner that is not a microscope.

90. The beam scanner of any of the examples above, wherein said first reflective optical element is configured to rotate back and forth.

91. The beam scanner of any of the examples above, wherein said first reflective optical element is configured to spin around multiple times thereby rotating.

92. The beam scanner of any of the examples above, wherein said beam scanner configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

93. The beam scanner of any of the examples above, wherein said beam scanner does not include a retroreflector.

94. The beam scanner of any of Examples 1-56 and 62-93, wherein said first and second lenses each have an optical axis, central axis, axis of symmetry, center, mechanical center, or any combination thereof that are aligned with respect to each other in a lateral direction.

95. The beam scanner of any of Examples 1-56 and 62-94, wherein said first and second lenses each have an optical axis, central axis, axis of symmetry or any combination thereof that are collinear with respect to each other.

### Examples—Part 1B—Angle Doubler-Second Reflector Scanning

1. A beam scanner comprising:
a first reflective optical element disposed to receive a light beam and reflect said light beam a first time, said first reflective optical element configured to cause said light beam reflected therefrom said first time to be scanned over a first range of angles;
a first lens disposed to receive said light beam reflected from said first reflective optical element such that said light beam is transmitted through said first lens; and
a second reflective optical element disposed to receive said light beam transmitted through said first lens and to reflect said light back to said first lens such that said light is transmitted through said first lens back to said first reflective optical element to be reflected therefrom a second time thereby being scanned over a second range of angles larger than said first range of angles,
wherein said second reflective optical element is configured to cause said light beam reflected therefrom to be scanned.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles that is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Examples 2-6, wherein said second range of angles is four times said range of angles that said first reflective optical element is rotated.

8. The beam scanner of any of the examples above, wherein said first reflective optical element comprises a mirror configured to be rotated.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-23, wherein said beam steerer is electrically connected to control electronics configured to cause said beam reflective from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 kHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of any of Example 42, wherein said control electronics is configured to cause said second reflective optical element to be rotated.

44. The beam scanner of any of the examples above, wherein said second reflective optical element is not a retroreflector or part of a retroreflector.

45. The beam scanner of any of the examples above, wherein said first lens comprises a positive lens.

46. The beam scanner of any of the examples above, wherein said first lens does not comprise a lens array or is not included in a lens array.

47. The beam scanner of any of the examples above, wherein said beam scanner does not include a lens array.

48. The beam scanner of any of the examples above, wherein said first lens comprises a telecentric lens.

49. The beam scanner of any of the examples above, wherein said first lens has a focal length and is positioned a focal length away from said first reflective optical element.

50. The beam scanner of any of Examples 2-49, wherein said first reflective optical element is configured to rotate through said range of angles around an axis of rotation and said first lens has a focal length and is positioned a focal length away from the axis of rotation of said first reflective optical element.

51. The beam scanner of any of the examples above, wherein said first lens has a front and back and first and second sides on each of said front and back, said first lens disposed to receive a ray of light reflected from said first reflective optical element on said first side of said front of said first lens such that said ray of light is transmitted through said first side of said first lens and exits said first side on said back of said first lens.

52. The beam scanner of Example 51, wherein said second reflective optical element is disposed to receive said ray of light from said first side of said back of said first lens and to reflect said ray of light back to said first lens on said second side of said back of said lens such that said ray of light that transmitted through said first side of said first lens is transmitted through said second side of said first lens back to said first reflective optical element to be reflected therefrom a second time.

53. The beam scanner Example 52, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagate parallel to said optical axis.

54. The beam scanner of any of Examples 51-53, wherein said ray of light is a chief ray of a light beam.

### Second Lens

55. The beam scanner of any of the examples above, further comprising a second lens in an optical path between said first lens and said second reflective optical element.

56. The beam scanner of any of the examples above, wherein said second lens does not comprise a lens array or is not included in a lens array.

57. The beam scanner of Example 55 or 56, wherein said second lens has a focal length and is positioned a focal length away from said second reflective optical element.

58. The beam scanner of any of Examples 55-57, wherein said first and second lenses each have an optical axis, central axis, axis of symmetry, center, mechanical center, or any combination thereof that are offset with respect to each other in a lateral direction.

59. The beam scanner of Example 58, wherein said lateral direction is along the direction of an axis of rotation about which said light beam reflected from said first reflective optical element said first time is scanned.

60. The beam scanner of Example 58 or 59, wherein said lateral direction is along the direction of an axis of rotation about which said first reflective optical element is rotated.

61. The beam scanner of any of Examples 58-60, further comprising a pick-off reflector to extract an output beam.

62. The beam scanner of Example 61, wherein said pick-off reflector is between said first and second lenses.

63. The beam scanner of any Examples 55-62, wherein said second lens comprises a telecentric lens.

64. The beam scanner of any of Examples 55-63, wherein said second lens has a front and back and first and second sides on each of said front and back and said second lens is disposed to receive a ray of light reflected off said first reflector said first time that is transmitted through a first side of said front of said first lens such that said ray of light reflected off said first reflector and transmitted through said first side of said front to said first lens is incident on and transmitted through said first side of said second lens, reflected from said second reflector and is incident on and transmitted through said second side of said second lens and said second side of said first lens back to said first reflector.

65. The beam scanner of any of Examples 55-64, wherein said second lens has an optical axis and a focal length and is positioned such that said ray of light reflected off said first reflector and transmitted through said first side of said front of said first lens is incident on said first side of said second lens parallel to said optical axis of said second lens and is refracted by said second lens at an angle and reflected from said second reflector at an angle with respect thereto.

66. The beam scanner of any of Example 65, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

67. The beam scanner of Example 66, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said ray of light is incident on said first reflector at an angle such that said ray of light is reflected off said first reflector said second time and scanned over said second range of angles.

68. The beam scanner of any of Examples 64-67, wherein said ray of light is a chief ray of a light beam.

### Laser

69. The beam scanner of any of the examples above, further comprising a light source configured to output said light beam that is directed to said first reflective optical element said first time.

70. The beam scanner of Example 69, further comprising a beamsplitter disposed to receive said light beam output by said light source and direct said light beam from said light source to said first reflective optical element.

71. The beam scanner of Example 70, wherein said beamsplitter is disposed to receive said light beam reflected from said first reflective optical element after being reflected by said first reflective optical element to said second reflective optical element and back to said first reflective optical element.

72. The beam scanner of Example 70 or 71, wherein said beamsplitter is disposed in an optical path between said light source and said first scanning reflector.

73. The beam scanner of any of Examples 70 to 72, wherein said beamsplitter comprises a non-polarizing beamsplitter.

74. The beam scanner of any of Examples 70 to 72, wherein said beamsplitter comprises a polarization beamsplitter.

75. The beam scanner of Example 74, further comprising a quarter wave retarder disposed between said polarization beamsplitter and said second reflective optical element configured to rotate linearly polarized light by about 90°.

76. The beam scanner of Example 75, wherein said quarter wave retarder is disposed between said first reflective optical element and said second reflective optical element.

77. The beam scanner of any of Examples 70-76, further comprising a microscope objective disposed to receive from said beamsplitter said light beam reflected from said first reflective optical element directed to said beamsplitter.

78. The beam scanner of Example 77, further comprising at least one lens in an optical path between said first reflective optical element and said microscope objective.

79. The beam scanner of Example 78, wherein said at least one lens comprises a scan lens in the optical path between said first scanning reflector and said beamsplitter.

80. The beam scanner of Example 78 or 79, wherein said at least one lens comprises a tube lens in said optical path between said beamsplitter and said microscope objective.

81. The beam scanner of Example 78 to 80, wherein said at least one lens comprises a first and second lenses that form an afocal relay between said first reflective optical element and said microscope objective.

82. The beam scanner of Example 81, wherein said first and second lenses that form an afocal relay each have focal length and said first and second lenses are separated by the sum of said focal lengths.

83. The beam scanner of Example 81 or 82, further comprising a focusing lens disposed to receive said light beam output by said light source and to focus said light beam onto a focal point of said first and second lenses of said plurality of lenses.

84. The beam scanner of any of Examples 77 to 84, further comprising an optical detector and a beamsplitter disposed in an optical path between said microscope objective and said optical detector and in an optical path between said microscope objective and said first reflective optical element.

85. The beam scanner of any of Examples 69 to 84, wherein said light source comprises a laser configured to output a laser beam that is directed to said first reflective optical element.

### Laser Scanning Microscope

86. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

87. The beam scanner of Example 86, further comprising a beamsplitter disposed in an optical path between said first reflective optical element and said microscope objective.

88. The beam scanner of any of the examples above, wherein said beam scanner is included in a laser scanning microscope.

89. The beam scanner of any of the examples above, wherein said beam scanner is 90. The beam scanner of any of the examples above, wherein said beam scanner is included in a laser scanner that is not a microscope.

91. The beam scanner of any of the examples above, wherein said first reflective optical element is configured to rotate back and forth.

92. The beam scanner of any of the examples above, wherein said first reflective optical element is configured to spin around multiple times thereby rotating.

93. The beam scanner of any of the examples above, wherein said beam scanner is configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

94. The beam scanner of any of the examples above, wherein said second reflective optical element is not a retroreflector or part of a retroreflector.

95. The beam scanner of any of the examples above, wherein said beam scanner does not include a retroreflector.

96. The beam scanner of any of Examples 1-57 and 63-95, wherein said first and second lenses each have an optical axis, central axis, axis of symmetry, center, mechanical center, or any combination thereof that are aligned with respect to each other in a lateral direction.

97. The beam scanner of any of Examples 1-57 and 63-96, wherein said first and second lenses each have an optical axis, central axis, axis of symmetry or any combination thereof that are collinear with respect to each other.

### Examples—Part 1C—Second Reflector Tipped and/or Tilted

1. A beam scanner comprising:
a first reflective optical element disposed to receive a light beam and reflect said light beam a first time, said first reflective optical element configured to cause said light beam reflected therefrom said first time to be scanned about a first axis directed in a first direction through a first range of angles;
a lens disposed to receive said light beam reflected from said first reflective optical element such that said light beam is transmitted through said first lens; and
a second reflective optical element disposed to receive light from said lens and to reflect said light back through said lens and to said first reflective optical element to be reflected therefrom a second time,
wherein said second reflective optical element is tipped about a second axis directed orthogonal to said first direction, is tilted about a second axis directed parallel to said first direction or both.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles that is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Examples 2-6, wherein said second range of angles is four times said range of angles that said first reflective optical element is rotated.

8. The beam scanner of any of the examples above, wherein said first reflective optical element comprises a mirror configured to be rotated.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-23, wherein said beam steerer is electrically connected to control electronics configured to cause said beam reflective from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 kHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of any of Example 42, wherein said control electronics is configured to cause said second reflective optical element to be rotated.

44. The beam scanner of any of the examples above, wherein said second reflective optical element is not a retroreflector or part of a retroreflector.

45. The beam scanner of any of the examples above, wherein said first lens comprises a positive lens.

46. The beam scanner of any of the examples above, wherein said first lens does not comprise a lens array or is not included in a lens array.

47. The beam scanner of any of the examples above, wherein said beam scanner does not include a lens array.

48. The beam scanner of any of the examples above, wherein said first lens comprises a telecentric lens.

49. The beam scanner of any of the examples above, wherein said first lens has a focal length and is positioned a focal length away from said first reflective optical element.

50. The beam scanner of any of the examples above, wherein said first reflective optical element is configured to rotate through said range of angles around an axis of rotation and said first lens has a focal length and is positioned a focal length away from the axis of rotation of said first reflective optical element.

51. The beam scanner of any of the examples above, wherein said first lens has a front and back and first and second sides on each of said front and back, said first lens disposed to receive a ray of light reflected from said first reflective optical element on said first side of said front of said first lens such that said ray of light is transmitted through said first side of said first lens and exits said first side on said back of said first lens.

52. The beam scanner of Example 51, wherein said second reflective optical element is disposed to receive said ray of light from said first side of said back of said first lens and to reflect said ray of light back to said first lens on said second side of said back of said lens such that said ray of light that transmitted through said first side of said first lens is transmitted through said second side of said first lens back to said first reflective optical element to be reflected therefrom a second time.

53. The beam scanner Example 52, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagate parallel to said optical axis.

54. The beam scanner of any of Examples 51-53, wherein said ray of light is a chief ray of a light beam.

### Second Lens

55. The beam scanner of any of the examples above, further comprising a second lens in an optical path between said first lens and said second reflective optical element.

56. The beam scanner of any of the examples above, wherein said second lens does not comprise a lens array or is not included in a lens array.

57. The beam scanner of Example 55 or 56, wherein said second lens has a focal length and is positioned a focal length away from said second reflective optical element.

58. The beam scanner of any of Examples 55-57, wherein said first and second lenses each have an optical axis, central axis, axis of symmetry, center, mechanical center, or any combination thereof that are offset with respect to each other in a lateral direction.

59. The beam scanner of Example 58, wherein said lateral direction is along the direction of an axis of rotation about which said light beam reflected from said first reflective optical element said first time is scanned.

60. The beam scanner of Example 58 or 59, wherein said lateral direction is along the direction of an axis of rotation about which said first reflective optical element is rotated.

61. The beam scanner of any of Examples 58-60, further comprising a pick-off reflector to extract an output beam.

62. The beam scanner of Example 61, wherein said pick-off reflector is between said first and second lenses.

63. The beam scanner of any Examples 55-62, wherein said second lens comprises a telecentric lens.

64. The beam scanner of any of Examples 55-63, wherein said second lens has a front and back and first and second sides on each of said front and back and said second lens is disposed to receive a ray of light reflected off said first reflector said first time that is transmitted through a first side of said front of said first lens such that said ray of light reflected off said first reflector and transmitted through said first side of said front to said first lens is incident on and transmitted through said first side of said second lens, reflected from said second reflector and is incident on and transmitted through said second side of said second lens and said second side of said first lens back to said first reflector.

65. The beam scanner of any of Examples 55-64, wherein said second lens has an optical axis and a focal length and is positioned such that said ray of light reflected off said first reflector and transmitted through said first side of said front of said first lens is incident on said first side of said second lens parallel to said optical axis of said second lens and is refracted by said second lens at an angle and reflected from said second reflector at an angle with respect thereto.

66. The beam scanner of any of Example 65, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

67. The beam scanner of Example 66, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said ray of light is incident on said first reflector at an angle such that said ray of light is reflected off said first reflector said second time and scanned over said second range of angles.

68. The beam scanner of any of Examples 64-67, wherein said ray of light is a chief ray of a light beam.

### Laser

69. The beam scanner of any of the examples above, further comprising a light source configured to output said light beam that is directed to said first reflective optical element said first time.

70. The beam scanner of Example 69, further comprising a beamsplitter disposed to receive said light beam output by said light source and direct said light beam from said light source to said first reflective optical element.

71. The beam scanner of Example 70, wherein said beamsplitter is disposed to receive said light beam reflected from said first reflective optical element after being reflected by said first reflective optical element to said second reflective optical element and back to said first reflective optical element.

72. The beam scanner of Example 70 or 71, wherein said beamsplitter is disposed in an optical path between said light source and said first scanning reflector.

73. The beam scanner of any of Examples 70 to 72, wherein said beamsplitter comprises a non-polarizing beamsplitter.

74. The beam scanner of any of Examples 70 to 72, wherein said beamsplitter comprises a polarization beamsplitter.

75. The beam scanner of Example 74, further comprising a quarter wave retarder disposed between said polarization beamsplitter and said second reflective optical element configured to rotate linearly polarized light by about 90°.

76. The beam scanner of Example 75, wherein said quarter wave retarder is disposed between said first reflective optical element and said second reflective optical element.

77. The beam scanner of any of Examples 70-76, further comprising a microscope objective disposed to receive from said beamsplitter said light beam reflected from said first reflective optical element directed to said beamsplitter.

78. The beam scanner of Example 77, further comprising at least one lens in an optical path between said first reflective optical element and said microscope objective.

79. The beam scanner of Example 78, wherein said at least one lens comprises a scan lens in the optical path between said first scanning reflector and said beamsplitter.

80. The beam scanner of Example 78 or 79, wherein said at least one lens comprises a tube lens in said optical path between said beamsplitter and said microscope objective.

81. The beam scanner of Example 78 to 80, wherein said at least one lens comprises a first and second lenses that form an afocal relay between said first reflective optical element and said microscope objective.

82. The beam scanner of Example 81, wherein said first and second lenses that form an afocal relay each have focal length and said first and second lenses are separated by the sum of said focal lengths.

83. The beam scanner of Example 81 or 82, further comprising a focusing lens disposed to receive said light beam output by said light source and to focus said light beam onto a focal point of said first and second lenses of said plurality of lenses.

84. The beam scanner of any of Examples 77 to 84, further comprising an optical detector and a beamsplitter disposed in an optical path between said microscope objective and said optical detector and in an optical path between said microscope objective and said first reflective optical element.

85. The beam scanner of any of Examples 69 to 84, wherein said light source comprises a laser configured to output a laser beam that is directed to said first reflective optical element.

### Laser Scanning Microscope

86. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

87. The beam scanner of Example 86, further comprising a beamsplitter disposed in an optical path between said first reflective optical element and said microscope objective.

88. The beam scanner of any of the examples above, wherein said beam scanner is included in a laser scanning microscope.

89. The beam scanner of any of the examples above, wherein said beam scanner is included in a scanning fluorescence microscope.

90. The beam scanner of any of the examples above, wherein said beam scanner is included in a laser scanner that is not a microscope.

91. The beam scanner of any of the examples above, wherein said first reflective optical element is configured to rotate back and forth.

92. The beam scanner of any of the examples above, wherein said first reflective optical element is configured to spin around multiple times thereby rotating.

93. The beam scanner of any of the examples above, wherein said beam scanner configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

94. The beam scanner of any of the examples above, wherein said first reflective optical element is configured to rotate about an axis of rotation is said first direction through a range of angles such that said light beam reflected therefrom said first time is scanned over said first range of angles.

95. The beam scanner of Example 94, wherein said second reflective optical element is tipped about a second axis directed orthogonal to said first direction.

96. The beam scanner of Example 94 or 95, wherein said second reflective optical element is tilted about a second axis directed parallel to said first direction.

97. The beam scanner of any of Examples 94-96, wherein said second reflective optical element is tilted such that said second reflective optical element has a normal angled with respect to a central axis, axis of symmetry, or optical axis of said second lens.

98. The beam scanner of any of Examples 94-97, wherein said second reflective optical element is oriented such that said normal is in a plane parallel to said first direction (Y direction).

99. The beam scanner of any of Examples 94-98, wherein said second reflective optical element is tilted about an axis in said first direction.

100. The beam scanner of any of Examples 94-99, wherein said second reflective optical element is tipped and tilted along orthogonal planes.

101. The beam scanner of any of Examples 94-100, wherein said second reflective optical element is tipped and tilted about orthogonal axes.

102. The beam scanner of any of the examples above, wherein said second reflective optical element is not a retroreflector or part of a retroreflector.

103. The beam scanner of any of the examples above, wherein said beam scanner does not include a retroreflector.

104. The beam scanner of any of Examples 1-57 and 63-103, wherein said first and second lenses each have an optical axis, central axis, axis of symmetry, center, mechanical center, or any combination thereof that are aligned with respect to each other in a lateral direction.

105. The beam scanner of any of Examples 1-57 and 63-104, wherein said first and second lenses each have an optical axis, central axis, axis of symmetry or any combination thereof that are collinear with respect to each other.

### Examples—Part 1D—Angle Doubler (Not Lenslet Array and Not Retroreflector)

1. A beam scanner comprising:
a first reflective optical element disposed to receive a light beam and reflect said light beam a first time, said first reflective optical element configured to cause said light beam reflected therefrom said first time to be scanned over a first range of angles; a first lens disposed to receive said light beam reflected from said first reflective optical element such that said light beam is transmitted through said lens; and
a second reflective optical element disposed to receive said light beam transmitted through said first lens and to reflect said light back to said first lens such that said light is transmitted through said lens back to said first reflective optical element to be reflected therefrom a second time thereby being scanned over a second range of angles larger than said first range of angles,
wherein said first lens does is not a lens array or is not included in a lens array, and
wherein said second reflective optical element is not a retroreflector or part of a retroreflector.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles that is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Examples 2-6, wherein said second range of angles is four times said range of angles that said first reflective optical element is rotated.

8. The beam scanner of any of the examples above, wherein said first reflective optical element comprises a mirror configured to be rotated.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-23, wherein said beam steerer is electrically connected to control electronics configured to cause said beam reflective from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 KHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of any of Example 42, wherein said control electronics is configured to cause said second reflective optical element to be rotated.

44. The beam scanner of any of the examples above, wherein said first lens comprises a positive lens.

45. The beam scanner of any of the examples above, wherein said beam scanner does not include a lens array.

46. The beam scanner of any of the examples above, wherein said first lens comprises a telecentric lens.

47. The beam scanner of any of the examples above, wherein said first lens has a focal length and is positioned a focal length away from said first reflective optical element.

48. The beam scanner of any of the examples above, wherein said first reflective optical element is configured to rotate through said range of angles around an axis of rotation and said first lens has a focal length and is positioned a focal length away from the axis of rotation of said first reflective optical element.

49. The beam scanner of any of the examples above, wherein said first lens has a front and back and first and second sides on each of said front and back, said first lens disposed to receive a ray of light reflected from said first reflective optical element on said first side of said front of said first lens such that said ray of light is transmitted through said first side of said first lens and exits said first side on said back of said first lens.

50. The beam scanner of Example 49, wherein said second reflective optical element is disposed to receive said ray of light from said first side of said back of said first lens and to reflect said ray of light back to said first lens on said second side of said back of said lens such that said ray of light that transmitted through said first side of said first lens is transmitted through said second side of said first lens back to said first reflective optical element to be reflected therefrom a second time.

51. The beam scanner Example 50, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagate parallel to said optical axis.

52. The beam scanner of any of Examples 49-51, wherein said ray of light is a chief ray of a light beam.

### Second Lens

53. The beam scanner of any of the examples above, further comprising a second lens in an optical path between said first lens and said second reflective optical element.

54. The beam scanner of any of the examples above, wherein said second lens does not comprise a lens array or is not included in a lens array.

55. The beam scanner of Example 53 or 54, wherein said second lens has a focal length and is positioned a focal length away from said second reflective optical element.

56. The beam scanner of any of Examples 53 to 55, wherein said first and second lenses each have an optical axis, central axis, axis of symmetry, center, mechanical center, or any combination thereof that are offset with respect to each other in a lateral direction.

57. The beam scanner of Example 56, wherein said lateral direction is along the direction of an axis of rotation about which said light beam reflected from said first reflective optical element said first time is scanned.

58. The beam scanner of Example 56 or 57, wherein said lateral direction is along the direction of an axis of rotation about which said first reflective optical element is rotated.

59. The beam scanner of any of Examples 56-58, further comprising a pick-off reflector to extract an output beam.

60. The beam scanner of Example 59, wherein said pick-off reflector is between said first and second lenses.

61. The beam scanner of any Examples 53-61, wherein said second lens comprises a telecentric lens.

62. The beam scanner of any of Examples 53-61, wherein said second lens has a front and back and first and second sides on each of said front and back and said second lens is disposed to receive a ray of light reflected off said first reflector said first time that is transmitted through a first side of said front of said first lens such that said ray of light reflected off said first reflector and transmitted through said first side of said front to said first lens is incident on and transmitted through said first side of said second lens, reflected from said second reflector and is incident on and transmitted through said second side of said second lens and said second side of said first lens back to said first reflector.

63. The beam scanner of any of Examples 53-62, wherein said second lens has an optical axis and a focal length and is positioned such that said ray of light reflected off said first reflector and transmitted through said first side of said front of said first lens is incident on said first side of said second lens parallel to said optical axis of said second lens and is refracted by said second lens at an angle and reflected from said second reflector at an angle with respect thereto.

64. The beam scanner of any of Example 63, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

65. The beam scanner of Example 64, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said ray of light is incident on said first reflector at an angle such that said ray of light is reflected off said first reflector said second time and scanned over said second range of angles.

66. The beam scanner of any of Examples 62-65, wherein said ray of light is a chief ray of a light beam.

### Laser

67. The beam scanner of any of the examples above, further comprising a light source configured to output said light beam that is directed to said first reflective optical element said first time.

68. The beam scanner of Example 67 further comprising a beamsplitter disposed to receive said light beam output by said light source and direct said light beam from said light source to said first reflective optical element.

69. The beam scanner of Example 68, wherein said beamsplitter is disposed to receive said light beam reflected from said first reflective optical element after being reflected by said first reflective optical element to said second reflective optical element and back to said first reflective optical element.

70. The beam scanner of Example 68 or 69, wherein said beamsplitter is disposed in an optical path between said light source and said first scanning reflector.

71. The beam scanner of any of Examples 68 to 69, wherein said beamsplitter comprises a non-polarizing beamsplitter.

72. The beam scanner of any of Examples 68 to 69, wherein said beamsplitter comprises a polarization beamsplitter.

73. The beam scanner of Example 72, further comprising a quarter wave retarder disposed between said polarization beamsplitter and said second reflective optical element configured to rotate linearly polarized light by about 90°.

74. The beam scanner of Example 73, wherein said quarter wave retarder is disposed between said first reflective optical element and said second reflective optical element.

75. The beam scanner of any of Examples 68-74, further comprising a microscope objective disposed to receive from said beamsplitter said light beam reflected from said first reflective optical element directed to said beamsplitter.

76. The beam scanner of Example 75, further comprising at least one lens in an optical path between said first reflective optical element and said microscope objective.

77. The beam scanner of Example 76, wherein said at least one lens comprises a scan lens in the optical path between said first scanning reflector and said beamsplitter.

78. The beam scanner of Example 76 or 77, wherein said at least one lens comprises a tube lens in said optical path between said beamsplitter and said microscope objective.

79. The beam scanner of Example 76 to 78, wherein said at least one lens comprises a first and second lenses that form an afocal relay between said first reflective optical element and said microscope objective.

80. The beam scanner of Example 79, wherein said first and second lenses that form an afocal relay each have focal length and said first and second lenses are separated by the sum of said focal lengths.

81. The beam scanner of Example 79 or 80, further comprising a focusing lens disposed to receive said light beam output by said light source and to focus said light beam onto a focal point of said first and second lenses of said plurality of lenses.

82. The beam scanner of any of Examples 75 to 81, further comprising an optical detector and a beamsplitter disposed in an optical path between said microscope objective and said optical detector and in an optical path between said microscope objective and said first reflective optical element.

83. The beam scanner of any of Examples 67 to 82, wherein said light source comprises a laser configured to output a laser beam that is directed to said first reflective optical element.

### Laser Scanning Microscope

84. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

85. The beam scanner of Example 84, further comprising a beamsplitter disposed in an optical path between said first reflective optical element and said microscope objective.

86. The beam scanner of any of the examples above, wherein said beam scanner is included in a laser scanning microscope.

87. The beam scanner of any of the examples above, wherein said beam scanner is included in a scanning fluorescence microscope.

88. The beam scanner of any of the examples above, wherein said beam scanner is included in a laser scanner that is not a microscope.

89. The beam scanner of any of the examples above, wherein said first reflective optical element is configured to rotate back and forth.

90. The beam scanner of any of the examples above, wherein said first reflective optical element is configured to spin around multiple times thereby rotating.

91. The beam scanner of any of the examples above, wherein said beam scanner configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

92. The beam scanner of any of the examples above, wherein said beam scanner does not include a retroreflector.

93. The beam scanner of any of Examples 1-55 and 60-92, wherein said first and second lenses each have an optical axis, central axis, axis of symmetry, center, mechanical center, or any combination thereof that are aligned with respect to each other in a lateral direction.

94. The beam scanner of any of Examples 1-55 and 60-93, wherein said first and second lenses each have an optical axis, central axis, axis of symmetry or any combination thereof that are collinear with respect to each other.

### Examples—Part 1E—Doubler (Not Change Rate of Scan and Not Retroreflector)

1. A beam scanner comprising:
a first reflective optical element disposed to receive a light beam and reflect said light beam a first time, said first reflective optical element configured to cause said light beam reflected therefrom said first time to be scanned over a first range of angles at a first scan rate;
a first lens disposed to receive said light beam reflected from said first reflective optical element such that said light beam is transmitted through said first lens; and
a second reflective optical element disposed to receive said light beam transmitted through said first lens and to reflect said light back to said first lens such that said light is transmitted through said first lens back to said first reflective optical element to be reflected therefrom a second time to cause said light beam to be reflected off said first reflective optical element said second time to be scanned over a second range of angles larger than said first range of angles at a second scan rate,
wherein said second scan rate is the same as the first scan rate, and
wherein said second reflective optical element is not a retroreflector or part of a retroreflector.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles that is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Examples 2-6, wherein said second range of angles is four times said range of angles that said first reflective optical element is rotated.

8. The beam scanner of any of the examples above, wherein said first reflective optical element comprises a mirror.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-23, wherein said beam steerer is electrically connected to control electronics configured to cause said beam reflective from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 kHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of any of Example 42, wherein said control electronics is configured to cause said second reflective optical element to be rotated.

44. The beam scanner of any of the examples above, wherein said first lens comprises a positive lens.

45. The beam scanner of any of the examples above, wherein said first lens does not comprise a lens array or is not included in a lens array.

46. The beam scanner of any of the examples above, wherein said beam scanner does not include a lens array.

47. The beam scanner of any of the examples above, wherein said first lens comprises a telecentric lens.

48. The beam scanner of any of the examples above, wherein said first lens has a focal length and is positioned a focal length away from said first reflective optical element.

49. The beam scanner of any of the examples above, wherein said first reflective optical element is configured to rotate through said range of angles around an axis of rotation and said first lens has a focal length and is positioned a focal length away from the axis of rotation of said first reflective optical element.

50. The beam scanner of any of the examples above, wherein said first lens has a front and back and first and second sides on each of said front and back, said first lens disposed to receive a ray of light reflected from said first reflective optical element on said first side of said front of said first lens such that said ray of light is transmitted through said first side of said first lens and exits said first side on said back of said first lens.

51. The beam scanner of Example 50, wherein said second reflective optical element is disposed to receive said ray of light from said first side of said back of said first lens and to reflect said ray of light back to said first lens on said second side of said back of said lens such that said ray of light that transmitted through said first side of said first lens is transmitted through said second side of said first lens back to said first reflective optical element to be reflected therefrom a second time.

52. The beam scanner Example 51, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagate parallel to said optical axis.

53. The beam scanner of any of Examples 50-52, wherein said ray of light is a chief ray of a light beam.

### Second Lens

54. The beam scanner of any of the examples above, further comprising a second lens in an optical path between said first lens and said second reflective optical element.

55. The beam scanner of any of the examples above, wherein said second lens does not comprise a lens array or is not included in a lens array.

56. The beam scanner of Example 54 or 55, wherein said second lens has a focal length and is positioned a focal length away from said second reflective optical element.

57. The beam scanner of any of Examples 54-56, wherein said first and second lenses each have an optical axis, central axis, axis of symmetry, center, mechanical center, or any combination thereof that are offset with respect to each other in a lateral direction.

58. The beam scanner of Example 57, wherein said lateral direction is along the direction of an axis of rotation about which said light beam reflected from said first reflective optical element said first time is scanned.

59. The beam scanner of Example 57 or 58, wherein said lateral direction is along the direction of an axis of rotation about which said first reflective optical element is rotated.

60. The beam scanner of any of Examples 57-59, further comprising a pick-off reflector to extract an output beam.

61. The beam scanner of Example 60, wherein said pick-off reflector is between said first and second lenses.

62. The beam scanner of any Examples 54-61, wherein said second lens comprises a telecentric lens.

63. The beam scanner of any of Examples 54-62, wherein said second lens has a front and back and first and second sides on each of said front and back and said second lens is disposed to receive a ray of light reflected off said first reflector said first time that is transmitted through a first side of said front of said first lens such that said ray of light reflected off said first reflector and transmitted through said first side of said front to said first lens is incident on and transmitted through said first side of said second lens, reflected from said second reflector and is incident on and transmitted through said second side of said second lens and said second side of said first lens back to said first reflector.

64. The beam scanner of any of Examples 54-63, wherein said second lens has an optical axis and a focal length and is positioned such that said ray of light reflected off said first reflector and transmitted through said first side of said front of said first lens is incident on said first side of said second lens parallel to said optical axis of said second lens and is refracted by said second lens at an angle and reflected from said second reflector at an angle with respect thereto.

65. The beam scanner of any of Example 64, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

66. The beam scanner of Example 65, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said ray of light is incident on said first reflector at an angle such that said ray of light is reflected off said first reflector said second time and scanned over said second range of angles.

67. The beam scanner of any of Examples 63-66, wherein said ray of light is a chief ray of a light beam.

### Laser

68. The beam scanner of any of the examples above, further comprising a light source configured to output said light beam that is directed to said first reflective optical element said first time.

69. The beam scanner of Example 68, further comprising a beamsplitter disposed to receive said light beam output by said light source and direct said light beam from said light source to said first reflective optical element.

70. The beam scanner of Example 69, wherein said beamsplitter is disposed to receive said light beam reflected from said first reflective optical element after being reflected by said first reflective optical element to said second reflective optical element and back to said first reflective optical element.

71. The beam scanner of Example 69 or 70, wherein said beamsplitter is disposed in an optical path between said light source and said first scanning reflector.

72. The beam scanner of any of Examples 69 to 71, wherein said beamsplitter comprises a non-polarizing beamsplitter.

73. The beam scanner of any of Examples 69 to 71, wherein said beamsplitter comprises a polarization beamsplitter.

74. The beam scanner of Example 73, further comprising a quarter wave retarder disposed between said polarization beamsplitter and said second reflective optical element configured to rotate linearly polarized light by about 90°.

75. The beam scanner of Example 74, wherein said quarter wave retarder is disposed between said first reflective optical element and said second reflective optical element.

76. The beam scanner of any of Examples 69-75, further comprising a microscope objective disposed to receive from said beamsplitter said light beam reflected from said first reflective optical element directed to said beamsplitter.

77. The beam scanner of Example 76, further comprising at least one lens in an optical path between said first reflective optical element and said microscope objective.

78. The beam scanner of Example 77, wherein said at least one lens comprises ascan lens in the optical path between said first scanning reflector and said beamsplitter. scan lens in the optical path between said first scanning reflector and said beamsplitter.

79. The beam scanner of Example 77 or 78, wherein said at least one lens comprises a tube lens in said optical path between said beamsplitter and said microscope objective.

80. The beam scanner of any of Examples 77 to 79, wherein said at least one lens comprises a first and second lenses that form an afocal relay between said first reflective optical element and said microscope objective.

81. The beam scanner of Example 80, wherein said first and second lenses that form an afocal relay each have focal length and said first and second lenses are separated by the sum of said focal lengths.

82. The beam scanner of Example 80 or 81, further comprising a focusing lens disposed to receive said light beam output by said light source and to focus said light beam onto a focal point of said first and second lenses of said plurality of lenses.

83. The beam scanner of any of Examples 76 to 83, further comprising an optical detector and a beamsplitter disposed in an optical path between said microscope objective and said optical detector and in an optical path between said microscope objective and said first reflective optical element.

84. The beam scanner of any of Examples 68 to 83, wherein said light source comprises a laser configured to output a laser beam that is directed to said first reflective optical element.

### Laser Scanning Microscope

85. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

86. The beam scanner of Example 85, further comprising a beamsplitter disposed in an optical path between said first reflective optical element and said microscope objective.

87. The beam scanner of any of the examples above, wherein said beam scanner is included in a laser scanning microscope.

88. The beam scanner of any of the examples above, wherein said beam scanner is 89. The beam scanner of any of the examples above, wherein said beam scanner is included in a laser scanner that is not a microscope.

90. The beam scanner of any of the examples above, wherein said first reflective optical element is configured to rotate back and forth.

91. The beam scanner of any of the examples above, wherein said first reflective optical element is configured to spin around multiple times thereby rotating.

92. The beam scanner of any of Examples 1-56 and 62-91, wherein said first and second lenses each have an optical axis, central axis, axis of symmetry, center, mechanical center, or any combination thereof that are aligned with respect to each other in a lateral direction.

93. The beam scanner of any of Examples 1-56 and 62-92, wherein said first and second lenses each have an optical axis, central axis, axis of symmetry or any combination thereof that are collinear with respect to each other.

### Examples—Part 1F—Angle Doubler (Not Lens Array and Light Reflect Off Second Reflector at Angle—i.e., Not Retroreflector)

1. A beam scanner comprising:
a first reflective optical element disposed to receive a light beam and reflect said light beam a first time, said first reflective optical element configured to cause said light beam reflected therefrom said first time is scanned over a first range of angles;
a first lens disposed to receive said light beam reflected from said first reflective optical element such that said light beam is transmitted through said first lens; and
a second reflective optical element disposed to receive said light beam transmitted through said lens and to reflect said light back to said lens such that said light is transmitted through said lens back to said first reflective optical element to be reflected therefrom a second time to be scanned over a second range of angles larger than said first range of angles,
wherein said lens does not comprise a lens array and is not included in a lens array, and
wherein said light beam transmitted through said lens is reflected off said second reflective optical element back toward said lens at an angle with respect to the light beam incident on said second reflective optical element.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles that is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Example 2-6, wherein said second range of angles is four times said range of angles that said first reflective optical element is rotated.

8. The beam scanner of any of the examples above, wherein said first reflective optical element comprises a mirror configured to be rotated.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-24, wherein said beam steerer is electrically connected to control electronics configured to cause said beam reflective from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 kHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of any of Example 42, wherein said control electronics is configured to cause said second reflective optical element to be rotated.

44. The beam scanner of any of the examples above, wherein said second reflective optical element is not a retroreflector or part of a retroreflector.

45. The beam scanner of any of the examples above, wherein said lens comprises a positive lens.

46. The beam scanner of any of the examples above, wherein said lens does not include a retroreflector.

47. The beam scanner of any of the examples above, wherein said beam scanner does not include a lens array.

48. The beam scanner of any of the examples above, wherein said first lens comprises a telecentric lens.

49. The beam scanner of any of the examples above, wherein said lens has a focal length and is positioned a focal length away from said first reflective optical element.

50. The beam scanner of any of the examples above, wherein said first reflective optical element is configured to rotate through said range of angles around an axis of rotation and said first lens has a focal length and is positioned a focal length away from the axis of rotation of said first reflective optical element.

### Second Lens

51. The beam scanner of any of the examples above, further comprising a second lens in an optical path between said lens and said second reflective optical element.

52. The beam scanner of any of the examples above, wherein said second lens does not comprise a lens array or is not included in a lens array.

53. The beam scanner of Example 51 or 52, wherein said second lens has a focal length and is positioned a focal length away from said second reflective optical element.

54. The beam scanner of Example 51 or 52, wherein said lens and second lens each have an optical axis, central axis, axis of symmetry, center, mechanical center, or any combination thereof that are offset with respect to each other in a lateral direction.

55. The beam scanner of Example 54, wherein said lateral direction is along the direction of an axis of rotation about which said light beam reflected from said first reflective optical element said first time is scanned.

56. The beam scanner of Example 54 or 55, wherein said lateral direction is along the direction of an axis of rotation about which said first reflective optical element is rotated.

57. The beam scanner of any of Examples 54-56, further comprising a pick-off reflector to extract an output beam.

58. The beam scanner of Example 57, wherein said pick-off reflector is between said lens and said second lens.

59. The beam scanner of any Examples 51-58, wherein said second lens comprises a telecentric lens.

### Laser

60. The beam scanner of any of the examples above, further comprising a light source configured to output said light beam that is directed to said first reflective optical element said first time.

61. The beam scanner of Example 50, further comprising a beamsplitter disposed to receive said light beam output by said light source and direct said light beam from said light source to said first reflective optical element.

62. The beam scanner of Example 61, wherein said beamsplitter is disposed to receive said light beam reflected from said first reflective optical element after being reflected by said first reflective optical element to said second reflective optical element and back to said first reflective optical element.

63. The beam scanner of Example 61 or 62, wherein said beamsplitter is disposed in an optical path between said light source and said first scanning reflector.

64. The beam scanner of any of Examples 61 to 63, wherein said beamsplitter comprises a non-polarizing beamsplitter.

65. The beam scanner of any of Examples 61 to 63, wherein said beamsplitter comprises a polarization beamsplitter.

66. The beam scanner of Example 65, further comprising a quarter wave retarder disposed between said polarization beamsplitter and said second reflective optical element configured to rotate linearly polarized light by about 90°.

67. The beam scanner of Example 66, wherein said quarter wave retarder is disposed between said first reflective optical element and said second reflective optical element.

68. The beam scanner of any of Examples 61-67, further comprising a microscope objective disposed to receive from said beamsplitter said light beam reflected from said first reflective optical element directed to said beamsplitter.

69. The beam scanner of Example 68, further comprising at least one lens in an optical path between said first reflective optical element and said microscope objective.

70. The beam scanner of Example 69, wherein said at least one lens comprises a scan lens in the optical path between said first scanning reflector and said beamsplitter.

71. The beam scanner of Example 69 or 70, wherein said at least one lens comprises a tube lens in said optical path between said beamsplitter and said microscope objective.

72. The beam scanner of Example 69 to 71, wherein said at least one lens comprises a first and second lenses that form an afocal relay between said first reflective optical element and said microscope objective.

73. The beam scanner of Example 72, wherein said first and second lenses that form an afocal relay each have focal length and said first and second lenses are separated by the sum of said focal lengths.

74. The beam scanner of Example 72 or 73, further comprising a focusing lens disposed to receive said light beam output by said light source and to focus said light beam onto a focal point of said first and second lenses of said plurality of lenses.

75. The beam scanner of any of Examples 68 to 73, further comprising an optical detector and a beamsplitter disposed in an optical path between said microscope objective and said optical detector and in an optical path between said microscope objective and said first reflective optical element.

76. The beam scanner of any of Examples 61 to 73, wherein said light source comprises a laser configured to output a laser beam that is directed to said first reflective optical element.

### Laser Scanning Microscope

77. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

78. The beam scanner of Example 77, further comprising a beamsplitter disposed in an optical path between said first reflective optical element and said microscope objective.

79. The beam scanner of any of the examples above, wherein said beam scanner is included in a laser scanning microscope.

80. The beam scanner of any of the examples above, wherein said beam scanner is included in a scanning fluorescence microscope.

81. The beam scanner of any of the examples above, wherein said beam scanner is included in a laser scanner that is not a microscope.

82. The beam scanner of any of the examples above, wherein said first reflective optical element is configured to rotate back and forth.

83. The beam scanner of any of the examples above, wherein said first reflective optical element is configured to spin around multiple times thereby rotating.

84. The beam scanner of any of the examples above, wherein said beam scanner configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

85. The beam scanner of any of the examples above, wherein said angle is greater than 5°.

86. The beam scanner of any of the examples above, wherein said angle is greater than 10°.

87. The beam scanner of any of the examples above, wherein said angle is greater than 15°.

88. The beam scanner of any of the examples above, wherein said angle is greater than 20°.

89. The beam scanner of any of Examples 1-53 and 59-103, wherein said first and second lenses each have an optical axis, central axis, axis of symmetry, center, mechanical center, or any combination thereof that are aligned with respect to each other in a lateral direction.

90. The beam scanner of any of Examples 1-53 and 59-104, wherein said first and second lenses each have an optical axis, central axis, axis of symmetry or any combination thereof that are collinear with respect to each other.

### Examples—Part 2—Angle Doubler (Scanning Mirror and Curved Mirror)

1. A beam scanner comprising:
a first reflective optical element disposed to receive a light beam and reflect said light beam a first time, said first reflective optical element configured to cause said light beam reflected therefrom said first time is scanned over a first range of angles;
a second reflective optical element disposed in an optical path of said first reflective optical element to receive said light beam from first reflective optical element;
third curved reflective optical element in the optical path between the first reflective optical element and said second reflective optical element such that said light beam reflected from said first reflective optical element is incident on and reflected by said third curved reflective optical element,
wherein said second reflective optical element and third curved reflective optical element are disposed with respect to each other and the first reflective optical element such that said second reflective optical element receives said light beam from said third curved reflective optical element and reflects said light back to said third curved reflective optical element to the first reflective optical element to be reflected therefrom a second time to be scanned over a second range of angles that larger than said first range of angles.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles that is larger than said range of angles that said first reflective optical element is rotated.

4. The beam scanner of Example 2 or 3, wherein said first range of angles is twice said range of angles that said first reflective optical element is rotated.

5. The beam scanner of any of the examples above, wherein rotation of said first reflective optical element through said range of angles causes the light beam reflected off said first reflective optical element said second time to be scanned over said second range of angles larger than said first range of angles.

6. The beam scanner of any of the examples above, wherein the second range of angles is two times the first range of angles.

7. The beam scanner of any of Example 2-6, wherein said second range of angles is four times said range of angles that said first reflective optical element is rotated.

8. The beam scanner of any of the examples above, wherein said first reflective optical element comprises a mirror configured to be rotated.

9. The beam scanner of any of the examples above, wherein said first reflective optical element comprises a planar mirror.

10. The beam scanner of any of the examples above, wherein said first reflective optical element comprises a resonant scanning mirror and/or a linear scanning mirror.

11. The beam scanner of any of the examples above, further comprising a galvanometer, motor, piezoelectric actuator, or other actuator configured to rotate said first reflective optical element to scan said first reflective optical element through said range of angles.

12. The beam scanner of any of the examples above, wherein said first reflective optical element is configured to scan through said range of angles at a scan rate of at least 1 kHz.

13. The beam scanner of any of the examples above, wherein said first reflective optical element is configured to scan through said range of angles at a scan rate from 1 kHz to 100 kHz.

14. The beam scanner of any of the examples above, wherein said first reflective optical element is configured to scan a beam through said first range of angles at a scan rate of at least 1 kHz.

15. The beam scanner of any of the examples above, wherein said first reflective optical element is configured to scan a beam through said first range of angles at a scan rate from 1 kHz to 100 kHz.

16. The beam scanner of any of the examples above, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of any of the examples above, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of any of the examples above, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of any of Examples 18-24, wherein said beam steerer is electrically connected to control electronics configured to cause said beam reflective from said first reflective optical element to be scanned.

25. The beam scanner of any of the examples above, further comprising control electronics configured to cause said beam reflected from said first reflective optical element to be scanned.

26. The beam scanner of any of Example 25, wherein said control electronics is configured to cause said first reflective optical element to be rotated.

27. The beam scanner of any of the examples above, wherein said second reflective optical element is configured to rotate such that said light beam reflected therefrom is scanned.

28. The beam scanner of any of the examples above, wherein said second reflective optical element comprises a mirror.

29. The beam scanner of any of the examples above, wherein said second reflective optical element comprises a planar mirror.

30. The beam scanner of any of the examples above, wherein said second reflective optical element is configured to be scanned.

31. The beam scanner of any of the examples above, wherein said second reflective optical element is configured to be rotated by a galvanometer, motor, piezoelectric actuator or other actuator.

32. The beam scanner of any of the examples above, wherein said second reflective optical element comprises a MEMs mirror.

33. The beam scanner of any of the examples above, wherein said second reflective optical element comprises a dual axis mirror.

34. The beam scanner of any of the examples above, wherein said second reflective optical element is configured to scan through said a range of angles at a scan rate from 2 Hz to 100 KHz.

35. The beam scanner of any of the examples above, wherein said second reflective optical element is configured to scan a beam at a scan rate from 2 Hz to 100 kHz.

36. The beam scanner of any of the examples above, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of any of Examples 36-40, wherein said beam steerer is electrically connected to control electronics configured to cause the beam reflected from said second reflective optical element to be scanned.

42. The beam scanner of any of the examples above, further comprising control electronics configured to cause said beam reflected from said second reflective optical element to be scanned.

43. The beam scanner of Example 42, wherein said control electronics is configured to cause said second reflective optical element to be rotated.

44. The beam scanner of any of the examples above, wherein said second reflective optical element is not a retroreflector or part of a retroreflector.

45. The beam scanner of any of the examples above, wherein said beam scanner does not include a lens array.

46. The beam scanner of any of the examples above, wherein said first lens comprises a telecentric lens.

### Laser

47. The beam scanner of any of the examples above, further comprising a light source configured to output said light beam that is directed to said first reflective optical element said first time.

48. The beam scanner of Example 47, further comprising a beamsplitter disposed to receive said light beam output by said light source and direct said light beam from said light source to said first reflective optical element.

49. The beam scanner of Example 48, wherein said beamsplitter is disposed to receive said light beam reflected from said first reflective optical element after being reflected by said first reflective optical element to said second reflective optical element and back to said first reflective optical element.

50. The beam scanner of Example 48 or 49, wherein said beamsplitter is disposed in an optical path between said light source and said first scanning reflector.

51. The beam scanner of any of Examples 48 to 50, wherein said beamsplitter comprises a non-polarizing beamsplitter.

52. The beam scanner of any of Examples 48 to 50, wherein said beamsplitter comprises a polarization beamsplitter.

53. The beam scanner of Example 52, further comprising a quarter wave retarder disposed between said polarization beamsplitter and said second reflective optical element configured to rotate linearly polarized light by about 90°.

54. The beam scanner of Example 53, wherein said quarter wave retarder is disposed between said first reflective optical element and said second reflective optical element.

55. The beam scanner of any of Examples 48-54, further comprising a microscope objective disposed to receive from said beamsplitter said light beam reflected from said first reflective optical element directed to said beamsplitter.

56. The beam scanner of Example 55, further comprising at least one lens in an optical path between said first reflective optical element and said microscope objective.

57. The beam scanner of Example 56, wherein said at least one lens comprises a scan lens in the optical path between said first scanning reflector and said beamsplitter.

58. The beam scanner of Example 56 or 57, wherein said at least one lens comprises a tube lens in said optical path between said beamsplitter and said microscope objective.

59. The beam scanner of any of Example 56 to 58, wherein said at least one lens comprises a first and second lenses that form an afocal relay between said first reflective optical element and said microscope objective.

60. The beam scanner of Example 59, wherein said first and second lenses that form an afocal relay each have focal length and said first and second lenses are separated by the sum of said focal lengths.

61. The beam scanner of Example 58 or 60, further comprising a focusing lens disposed to receive said light beam output by said light source and to focus said light beam onto a focal point of said first and second lenses of said plurality of lenses.

62. The beam scanner of any of Examples 55 to 61, further comprising an optical detector and a beamsplitter disposed in an optical path between said microscope objective and said optical detector and in an optical path between said microscope objective and said first reflective optical element.

63. The beam scanner of any of Examples 47 to 62, wherein said light source comprises a laser configured to output a laser beam that is directed to said first reflective optical element.

### Laser Scanning Microscope

64. The beam scanner of any of the examples above, further comprising a microscope objective disposed to receive said light beam reflected from said first reflective optical element said second time after being reflected by said first reflective optical element said first time to said second reflective optical element and back to said first reflective optical element said second time.

65. The beam scanner of Example 64, further comprising a beamsplitter disposed in an optical path between said first reflective optical element and said microscope objective.

66. The beam scanner of any of the examples above, wherein said beam scanner is included in a laser scanning microscope.

67. The beam scanner of any of the examples above, wherein said beam scanner is included in a scanning fluorescense microscope.

68. The beam scanner of any of the examples above, wherein said beam scanner is included in a laser scanner that is not a microscope.

69. The beam scanner of any of the examples above, wherein said first reflective optical element is configured to rotate back and forth.

70. The beam scanner of any of the examples above, wherein said first reflective optical element is configured to spin around multiple times thereby rotating.

71. The beam scanner of any of the examples above, wherein said beam scanner configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

72. The beam scanner of any of the examples above, wherein said third curved reflective optical element comprises a concave mirror.

73. The beam scanner of any of the examples above, wherein said third curved reflective optical element comprises a parabolic mirror.

74. The beam scanner of any of the examples above, wherein the beam scanner causes said light beam to be reflected off said first reflective optical element said second time to be scanned over a second range of angles that is two times that first range of angles.

75. The beam scanner of any of the examples above, wherein said second reflective optical element is not a retroreflector or part of a retroreflector.

### Examples—Part 3—Phase Doubler (Lens)

1. A phase modulation system comprising:
a phase modulator disposed to receive a light beam a first time, said phase modulator configured to impart different phase shifts on different portions of said light beam;
a first lens disposed to receive said light beam from said phase modulator such that said light beam is transmitted through said first lens and exits said first lens; and
a reflective optical element disposed to receive said light beam from said first lens and to reflect said light back to said first lens such that said light that is transmitted through said first lens is transmitted through said first lens back toward said phase modulator a second time,
wherein the phase shift of said phase modulator causes said light received and modulated by said phase modulator said second time to have phase shifts larger than the phase shifts imparted by the phase modulator the first time.

2. The phase modulation system of Example 1, wherein said phase modulator comprises an array of phase modulators.

3. The phase modulation system of Example 1 or 2, wherein said phase modulator comprises a reflective phase modulator.

4. The phase modulation system of Example 1 or 2, wherein said phase modulator comprises a transmissive phase modulator.

5. The phase modulation system of any of the examples above, wherein said phase modulator comprises a deformable mirror or a liquid crystal spatial light modulator.

6. The phase modulation system of any of the examples above, wherein the phase shift of said phase modulator cause said light received and modulated by said phase modulator said second time to have phase shifts twice as much as the phase shifts imparted by the phase modulator the first time.

7. The phase modulation system of any of the examples above, wherein said phase modulator comprises a 2D phase modulator array.

8. The phase modulation system of any of the examples above, wherein said reflective optical element comprises a retroreflector.

9. The phase modulation system of any of the examples above, wherein said reflective optical element is configured to be tilted about a first axis.

10. The phase modulation system of any of the examples above, wherein said reflective optical element is configured to be tipped about a second axis different than the first axis.

11. The phase modulation system of any of the examples above, wherein said reflective optical element is configured to be tipped and tilted about orthogonal axes.

12. The phase modulation system of any of the examples above, wherein said first lens does not comprise a lens array or is not included in a lens array.

13. The phase modulation system of any of the examples above, wherein said phase modulation system does not include a lens array.

14. The phase modulation system of any of the examples above, wherein said phase modulation system includes a lens array.

15. The phase modulation system of any of the examples above, wherein said phase modulation system includes a telecentric lens.

16. The phase modulation system of any of the examples above, wherein said first lens comprises a telecentric lens.

17. The phase modulation system of any of the examples above, wherein said first lens is included in a lens array.

18. The phase modulation system of any of the examples above, wherein said second lens is included in a lens array.

19. The phase modulation system of any of the examples above, wherein said second lens comprises a telecentric lens.

20. The phase modulation system of any of Examples 1-6 and 8-19, wherein said phase modulator comprises a 1D phase modulator array.

### Retroreflector

21. The phase modulator system of any of the examples above, wherein said reflective optical element is a retroreflector.

22. The phase modulator system of Example 21, wherein said retroreflector is a roof mirror.

23. The phase modulator system of Example 21 or 22, wherein said retroreflector is configured such that said light beam reflected from said phase modulator the first time is incident on and transmitted through a first side of said first lens to said retroreflector and reflected to and transmitted through a second side of said first lens.

24. The phase modulator system of Example 23, wherein said light beam reflected from said first reflective optical element said first time that is incident on and transmitted through said first side of said first lens to said retroreflector is a collimated beam when incident on said first side of said first lens.

25. The phase modulator system of Example 24, wherein said collimated light beam incident on said first side of said first lens is refracted by said first side of said first lens to be a converging beam directed toward said retroreflector.

26. The phase modulator system of Example 25, wherein said converging beam directed toward said retroreflector is a diverging beam when reflected from said retroreflector and incident on said second side of said first lens.

27. The phase modulator system of Example 26, wherein said diverging beam from said retroreflector is collimated by said second side of said first lens and directed back toward said first reflector.

### Examples—Part 4—Angle Multiplier (Scanning Mirror and Lenses)

1. A beam scanner comprising:
a first reflective optical element disposed to receive a light beam and reflect said light beam a first time, said first reflective optical element configured to cause said light beam reflected therefrom said first time to be scanned about a first axis directed in a first direction over a first range of angles;
a first lens disposed to receive said light beam reflected from said first reflective optical element such that said light beam is transmitted through said first lens;
a second lens disposed to receive said light beam from said first lens such that said light beam is transmitted through said second lens; and
a second reflective optical element disposed to receive said light beam from said second lens and to reflect said light back to said second lens, said first and second lenses aligned with respect each other such that said light beam reflected off said second reflective optical element to said second lens is transmitted through the second lens and propagates onto and through the first lens such that said light beam is transmitted through said second lens and the first lens back to said first reflective optical element to be reflected therefrom a second time, wherein said second reflective optical element is tilted about a second axis that is directed along a different second direction than said first direction of said first axis.

2. The beam scanner of Example 1, wherein said first lens has a focal length and is positioned a focal length away from said first reflective optical element.

3. The beam scanner of Example 1, wherein said first lens has a focal length and is positioned a focal length away from said first axis.

4. The beam scanner of any of Examples 1-3, wherein said second lens has a focal length and is positioned a focal length away from said second reflective optical element.

5. The beam scanner of any of Examples 1-3, wherein said second lens has a focal length and is positioned a focal length away from said second axis of said second reflective optical element.

6. The beam scanner of any of any of the examples above, wherein said second reflective optical element is tilted such that light beam propagates between said first and second reflective optical elements multiple times such that said light beam reflects of said first reflector N times, where N is an integer greater than and equal to 1.

7. The beam scanner of Example 6, wherein said first reflective optical element causes said light beam reflected of said first reflective optical element N times to be scanned over a second range of angles that is N times the first range of angles.

8. The beam scanner of Example 6 or 7, further comprising a pickoff reflector configured to redirect the light beam reflected off the second reflective optical element such that said light beam after having reflected of the first reflective optical elements at least N times does not reach the first reflective optical element.

9. The beam scanner of Example 6 or 7, further comprising a pickoff reflector configured to redirect the light beam reflected off the first reflective optical element such that said light beam after having reflected of the first reflective optical elements at least N times does not reach the second reflective optical element.

10. The beam scanner of Example 8 or 9, wherein pick-off reflector comprises a mirror or beamsplitter.

11. The beam scanner of any of Examples 8-10, wherein said first reflective optical element causes said light beam redirected by said pickoff reflector to be scanned over a second range of angles that is N times the first range of angles.

12. The beam scanner of any of the examples above, wherein the beam scanner causes said light beam reflected by said first reflective optical element N times to be scanned over said second range of angles by an amount, NΔθ_{beam}, that is N times the said first range of angles that said light beam reflected off the said first reflective optical element said first time is scanned through.

13. The beam scanner of any of Examples 6-12, wherein N is 2.

14. The beam scanner of any of Examples 6-12, wherein N is 3.

15. The beam scanner of any of Examples 6-12, wherein N is 4.

16. The beam scanner of any of Examples 6-12, wherein N is 5.

17. The beam scanner of any of Examples 6-12, wherein N is 6.

18. The beam scanner of any of Examples 6-12, wherein N is an integer from 5-10.

19. The beam scanner of any of Examples 6-12, wherein N is an integer from 10-15.

20. The beam scanner of any of Examples 6-12, wherein N is an integer from 10-20.

21. The beam scanner of any of Examples 6-12, wherein N is an integer from 20-50.

22. The beam scanner of any of Examples 6-12, wherein N is an integer from 50-100.

23. The beam scanner of any of Examples 6-12, wherein N is an integer from 100-1000.

24. The beam scanner of any of the examples above, wherein said first lens has a geometric center and edges about said first lens and said second lens has a geometric center and edges about said second lens, and light passes through said first and second lenses increasingly closer to said geometric center of said first lens and said geometric center of said second lens with increasing number of times that said light is reflected from said first reflective optical element toward said first lens.

25. The beam scanner of any of any of the examples above, wherein said light passes through said first and second lenses increasingly closer to an optical axis of said first lens and an optical axis of said second lens with increasing number of times that said light is reflected from said first reflective optical element toward said first lens.

26. The beam scanner of any of examples above, wherein said first lens has a geometric center and edges about said first lens and said second lens has a geometric center and edges about said second lens, and light passes through said first and second lenses increasingly farther from said geometric center of said first lens and said geometric center of said second lens with increasing number of times that said light is reflected from said first reflective optical element toward said first lens.

27. The beam scanner of any of any of the examples above, wherein said light passes through said first and second lenses increasingly farther from an optical axis of said first lens and an optical axis of said second lens with increasing number of times that said light is reflected from said first reflective optical element toward said first lens.

28. The beam scanner of any of the examples above, wherein the rotation of said first reflective optical element causes said light beam to be scanned over an increasingly large angular range with increasing number of times that said light beam is reflected from said first reflective optical element toward said first lens.

29. The beam scanner of any of said examples above, wherein said first lens has an optical axis and second reflective optical element has a normal and is tilted such that said normal is angled with respect to said optical axis of said first lens.

30. The beam scanner of any of said examples above, wherein said second lens has an optical axis and second reflective optical element has a normal and is tilted such that said normal is angled with respect to said optical axis of said second lens.

31. The beam scanner of any of the examples above, wherein said first reflective optical element is configured to rotate back and forth.

32. The beam scanner of any of the examples above, wherein said first reflective optical element is configured to spin around multiple times thereby rotating.

33. The beam scanner of any of the examples above, wherein said first lens has a front and back and first and second sides on each of said front and back, and said first lens is disposed to receive a ray of light reflected from said first reflective optical element on said first side of said front of said first lens such that said ray of light is transmitted through said first side of said first lens and exits said first side on said back of said first lens.

34. The beam scanner of Example 33 wherein said second lens has a front and back and first and second sides on each of said front and back, and said second lens is disposed to receive said ray of light from said first lens on said first side of said front of said second lens such that said ray of light is transmitted through said first side of said second lens and exits said first side on said back of said second lens.

35. The beam scanner of Example 34, wherein said second reflective optical element is disposed to receive said ray of light from said first side of said back of said second lens and to reflect said ray of light back to said second lens on said second side of said back of said second lens, and said first and second lenses are aligned with respect each other such that said laser beam reflected off said second reflective optical element to said second side of said back of said second lens is transmitted through the second side of the second lens and propagates onto and through the second side of the first lens such that said ray of light that is transmitted through said second side of said second lens and the second side of the first lens back to said first reflective optical element to be reflected therefrom a second time.

36. The beam scanner of Example 35, wherein said first and second reflective optical elements are arranged with respect to each other and said second reflective optical element is tilted about said second axis such that said ray of light incident on said first reflective optical element said second time is reflected back to the first side of said first lens and transmitted therethrough to and through the first side of the second lens and is reflected off the second reflective optical element a second time back to the second side of the second lens and transmitted therethrough onto said first reflective optical element to be reflected therefrom repeating this cycle a total of N times.

37. The beam scanner of Example 36, wherein the beam scanner causes said light beam to be scanned through an increasingly larger angular range with increasing number of times that said ray of light is reflected from said first reflective optical element toward said first side of said first lens.

38. The beam scanner of any Examples 33-37, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagates parallel to said optical axis.

39. The beam scanner of Example 38, wherein said second lens has an optical axis and a focal length and is positioned such that said ray of light reflected off said first reflector and transmitted through said first side of said front to said first lens is incident on said first side of said second lens parallel to said optical axis of said second lens and is refracted by said second lens at an angle and reflected from said second reflector at an angle with respect thereto and with respect to said second lens and the optical axis thereof.

40. The beam scanner of Example 39, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

41. The beam scanner of Example 40, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said light is incident on said first reflector at an angle such that said light is reflected off said first reflector said second time and scanned over a range of angles larger than said first range of angles, 2Δθ.

42. The beam scanner of Example 40, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said light is incident on said first reflector at an angle such that said light is reflected off said first reflector the Nth time and scanned over a range of angles NΔθ.

43. The beam scanner of any of Examples 33-41, wherein said ray of light is a chief ray of a light beam.

### Examples—Part 5—Reflective Angle Doubler with Double Sided Reflector

1. A beam scanner comprising:
first and second reflective surfaces facing different directions, said first reflective surface disposed to receive a light beam and reflect said light beam, said first reflective surface configured to cause said light beam to be scanned through a first range of angles; and
a plurality of reflectors arranged to reflect said light beam reflected from said first reflective surface to said second reflective surface,
wherein said second reflective surface is configured to cause said light beam reflected from said second reflective surface is scanned over a second range of angles larger than said first range of angles.

2. The beam scanner of Example 1, wherein said first and second reflective surfaces face opposite directions.

3. The beam scanner of Example 1, wherein said first and second reflective surfaces are on opposite sides of a double-sided mirror, said double-side mirror configured to be rotated.

4. The beam scanner of Example 3, wherein said double-sided mirror comprises a glass plate metalized on opposite sides.

5. The beam scanner of Example 2 or 3, further comprising a platform configured to rotate said double-sided mirror.

6. The beam scanner of Example 5, wherein said separate platforms comprise at least one galvanometer, motor, piezoelectric actuator or other actuator.

7. The beam scanner of Example 1 or 2, wherein said first and second reflective surfaces are on respective first and second reflective optical elements.

8. The beam scanner of Example 7, wherein said first and second reflective optical elements comprises respective first and second mirrors.

9. The beam scanner of Example 7, wherein said first and second reflective optical elements comprises respective first and second diffractive optical elements.

10. The beam scanner of Examples 7-9, further comprising a platform configured to rotate said first and second reflective optical elements.

11. The beam scanner of Example 10, wherein said platform comprise at least one galvanometer, motor, piezoelectric actuator or other actuator.

12. The beam scanner of Examples 7-9, further comprising separate platform configured to rotate said first and second reflective optical elements, respectively.

13. The beam scanner of Example 12, wherein said separate platforms comprise at least one galvanometer, motor, piezoelectric actuator or other actuator.

14. The beam scanner of any of the examples above, wherein said first reflective surface is configured to rotate through a range of angles such that said light beam reflected therefrom is scanned over a first range of angles twice the range of angles that said first reflective surface is rotated.

15. The beam scanner of any of the examples above, wherein said second reflective surface is configured to rotate through a range of angles, with said rotation of said scanning mount such that said light beam reflected therefrom is scanned over a second range of angles four times the range of angles that said second reflective surface is rotated.

16. The beam scanner of any of the examples above, wherein said first and second surfaces are on first and second beam steerers.

17. The beam scanner of Example 16, wherein said beam steerers comprises a rotating mirrors.

18. The beam scanner of Example 16, wherein said beam steerers comprises MEMs mirrors.

19. The beam scanner of Example 16, wherein said beam steerers comprises an active diffractive optical elements or a phase arrays.

20. The beam scanner of Example 18, wherein said beam steerers comprise acousto-optical modulators.

21. The beam scanner of Example 18, wherein said beam steerers comprises a liquid crystal spatial light modulators, MEMS mirror arrays, or an electrowetting prism arrays.

22. The beam scanner of any of the examples above, wherein said plurality of reflectors comprises a relay comprising first and second curved mirrors.

23. The beam scanner of any of the examples above, wherein said plurality of reflectors comprises an afocal relay comprising first and second curved mirrors having focal lengths, said first and second curved relays separated an optical path having a distance that is the sum of their reflected focal lengths.

24. The beam scanner of Example 22 or 23, wherein said first and second curved mirrors the same reflected focal lengths, f, and are separated an optical path by a distance of 2f.

25. The beam scanner of any of Examples 22-24, wherein said first and second curved mirrors comprise 90° off-axis mirrors.

26. The beam scanner of any of Examples 22-24, wherein said first and second curved mirrors comprise off-axis reflectors, said off-axis mirror not comprising a 90° off-axis reflectors.

27. The beam scanner of any of Examples 22-26, wherein said first and second curved mirrors comprise off-axis parabolic reflectors.

28. The beam scanner of any of Examples 22-27, wherein said plurality of reflectors comprise a pair of reflectors in an optical path between said first reflective surface and said first curved mirror.

29. The beam scanner of any of Examples 22-28, wherein said plurality of reflectors comprise a pair of planar reflectors in an optical path between said first reflective surface and said first curved reflector.

30. The beam scanner of any of Examples 22-29, wherein said plurality of reflectors comprise a pair of reflectors in an optical path between said first and second curved reflectors.

31. The beam scanner of any of Examples 22-29, wherein said plurality of reflectors comprise a pair of planar reflectors in an optical path between said first and second curved reflectors.

32. The beam scanner of any of Examples 22-31, wherein said plurality of reflectors comprise a pair of reflectors in an optical path between said second curved reflector and said second reflective surface.

33. The beam scanner of any of Examples 22-31, wherein said plurality of reflectors comprise a pair of planar reflectors in an optical path between said second curved reflector and said second reflective surface.

34. The beam scanner of any of the examples above, further comprising a scan lens disposed with respect to said second reflective surface to receive a light beam therefrom.

### Examples—Part 6—Angle Multiplier (Scanning Mirror and Lenses)

1. A beam scanner comprising:
a first reflective optical element disposed to receive a light beam and reflect said light beam a first time, said first reflective optical element configured to cause said light beam reflected therefrom said first time to scanned about a first axis directed in a first direction through a range of angles;
a first lens disposed to receive said light beam reflected from said first reflective optical element such that said light beam is transmitted through said first lens, said first lens having a first optical axis or first central axis therethrough or first center thereof;
a second lens disposed to receive said light beam from said first lens such that said light beam is transmitted through said second lens, said second lens having a second optical axis or second central axis therethrough or second center thereof; and
a second reflective optical element disposed to receive said light beam from said second lens and to reflect said light back to said second lens, said first and second lenses arranged with respect each other such that said light beam reflected off said second reflective optical element to said second lens is transmitted through the second lens and propagates onto and through the first lens such that said light beam is transmitted through said second lens and the first lens back to said first reflective optical element to be reflected therefrom a second time,
wherein said second optical axis or second central axis therethrough or second center thereof is laterally offset with respect to said first optical axis or first central axis or first center in a direction parallel to said first axis about which said first reflector is rotated.

2. The beam scanner of Example 1, wherein said first lens has a focal length and is positioned a focal length away from said first reflective optical element.

3. The beam scanner of Example 1, wherein said first lens has a focal length and is positioned a focal length away from said first axis.

4. The beam scanner of any of Examples 1-3, wherein said second lens has a focal length and is positioned a focal length away from said second reflective optical element.

5. The beam scanner of any of any of the examples above, wherein said light beam propagates between said first and second reflective optical elements multiple times such that said light beam reflects of said first reflector N times, where N is an integer greater than and equal to 1.

6. The beam scanner of Example 5, wherein said first reflective optical element causes said light beam reflected of said first reflective optical element N times to be scanned over a second range of angles that is N times the first range of angles.

7. The beam scanner of Example 5 or 6, further comprising a pickoff reflector configured to redirect the light beam reflected off the second reflective optical element such that said light beam after having reflected of the first reflective optical elements at least N times does not reach the first reflective optical element.

8. The beam scanner of Examples 5, 6 or 7, further comprising a pickoff reflector configured to redirect the light beam reflected off the first reflective optical element such that said light beam after having reflected of the first reflective optical elements at least N times does not reach the second reflective optical element.

9. The beam scanner of Example 7 or 8, wherein pick-off reflector comprises a mirror or beamsplitter.

10. The beam scanner of any of Examples 7-9, wherein said first reflective optical element causes said light beam redirected by said pickoff reflector to be scanned over a second range of angles that is N times the first range of angles.

11. The beam scanner of any of Examples 6-10, wherein beam scanner causes said light beam reflected by said first reflective optical element N times to be scanned over said second range of angles by an amount, NΔθ_{beam}, that is N times the said first range of angles, Δθ_{beam}, that said light beam reflected off the said first reflective optical element said first time is scanned through.

12. The beam scanner of any of Examples 6-11, wherein N is 2.

13. The beam scanner of any of Examples 6-11, wherein N is 3.

14. The beam scanner of any of Examples 6-11, wherein N is 4.

15. The beam scanner of any of Examples 6-11, wherein N is 5.

16. The beam scanner of any of Examples 6-11, wherein N is 6.

17. The beam scanner of any of Examples 6-11, wherein N is an integer from 5-10.

18. The beam scanner of any of Examples 6-11, wherein N is an integer from 10-15.

19. The beam scanner of any of Examples 6-11, wherein N is an integer from 10-20.

20. The beam scanner of any of Examples 6-11, wherein N is an integer from 20-50.

21. The beam scanner of any of Examples 6-11, wherein N is an integer from 50-100.

22. The beam scanner of any of Examples 6-11, wherein N is an integer from 100-1000.

23. The beam scanner of any of the examples above, wherein said first lens has a geometric center and edges about said first lens and said second lens has a geometric center and edges about said second lens, and light passes through said first and second lenses increasingly closer to said geometric center of said first lens and said geometric center of said second lens with increasing number of times that said light is reflected from said first reflective optical element toward said first lens.

24. The beam scanner of any of any of the examples above, wherein said light passes through said first and second lenses increasingly closer to an optical axis of said first lens and an optical axis of said second lens with increasing number of times that said light is reflected from said first reflective optical element toward said first lens.

25. The beam scanner of any of the examples above, wherein said first lens has a geometric center and edges about said first lens and said second lens has a geometric center and edges about said second lens, and light passes through said first and second lenses increasingly farther from said geometric center of said first lens and said geometric center of said second lens with increasing number of times that said light is reflected from said first reflective optical element toward said first lens.

26. The beam scanner of any of any of the examples above, wherein said light passes through said first and second lenses increasingly farther from an optical axis of said first lens and an optical axis of said second lens with increasing number of times that said light is reflected from said first reflective optical element toward said first lens.

27. The beam scanner of any of the examples above, wherein the beam scanner causes said light beam to be scanned over an increasingly large angular range with increasing number of times that said light beam is reflected from said first reflective optical element toward said first lens.

28. The beam scanner of any of said examples above, wherein said second reflective optical element has a normal that is tilted with respect to said optical axis or central axis of said first lens in a plane orthogonal to said first axis.

29. The beam scanner of any of said examples above, wherein said second reflective optical element has a normal that is tilted with respect to said optical axis or central axis of said second lens in a plane orthogonal to said first axis.

30. The beam scanner of any of said examples above, wherein said second reflective optical element has a normal that is tilted with respect to said optical axis or central axis of said first lens in the plane in which said beam of light reflected from said first reflective optical element is scanned or is tilted with respect to said optical axis or central axis of said first lens in a plane parallel to the plane in which said beam of light reflected from said first reflective optical element is scanned.

31. The beam scanner of any of said examples above, wherein said second reflective optical element has a normal that is tilted with respect to said optical axis or central axis of said second lens in the plane in which said beam of light reflected from said first reflective optical element is scanned or is tilted with respect to said optical axis or central axis of said first lens in a plane parallel to the plane in which said beam of light reflected from said first reflective optical element is scanned.

32. The beam scanner of any of said examples above, wherein said second reflective optical element has a normal parallel to said optical axis or central axis of said second lens.

33. The beam scanner of any of said examples above, wherein said second reflective optical element has a normal that is parallel to said optical axis or central axis of said first lens.

34. The beam scanner of any of the examples above, wherein said first reflective optical element is configured to rotate back and forth.

35. The beam scanner of any of the examples above, wherein said first reflective optical element is configured to spin around multiple times thereby rotating.

36. The beam scanner of any of the examples above, wherein said first reflective optical element is configured to rotate through a range of angles such that said light beam reflected therefrom said first time is scanned over said first range of angles.

37. The beam scanner of any of the examples above, wherein said first reflective optical element is configured to rotate about an axis of rotation parallel to said first optical axis.

38. The beam scanner of Example 37, wherein said second optical axis or second central axis therethrough or second center thereof is laterally offset with respect to said first optical axis or first central axis or first center in a direction parallel to said first axis about which said first reflector is rotated.

### Part 7—Angle Doubler—Two Lenses, Second Lens Not an Array

1. A beam scanner comprising:
a first reflective optical element disposed to receive a light beam and reflect said light beam a first time, said first reflective optical element configured to cause said light beam reflected therefrom said first time to be scanned over a first range of angles;
a first lens disposed to receive said light beam reflected from said first reflective optical element such that said light beam is transmitted through said first lens;
a second lens disposed to receive said light beam transmitted through said first lens, said second lens not comprising a lens array and not being included in a lens array; and
a second reflective optical element disposed to receive said light beam transmitted through said second lens and to reflect said light back to said second lens such that said light is transmitted through said first lens back to said first reflective optical element to be reflected therefrom a second time thereby being scanned over a second range of angles larger than said first range of angles.

2. The beam scanner of Example 1, wherein said first reflective optical element is configured to rotate through a range of angles such that said light beam reflected therefrom said first time is scanned over said first range of angles.

3. The beam scanner of Example 2, wherein said first range of angles is larger than said range of angles that said first reflective optical element is rotated.

4. The beam scanner of Example 2, wherein said first range of angles is twice said range of angles that said first reflective optical element is rotated.

5. The beam scanner of Example 1, wherein rotation of said first reflective optical element through said range of angles causes the light beam reflected off said first reflective optical element said second time to be scanned over said second range of angles larger than said first range of angles.

6. The beam scanner of Example 1, wherein the second range of angles is two times the first range of angles.

7. The beam scanner of Example 2, wherein said second range of angles is four times said range of angles that said first reflective optical element is rotated.

8. The beam scanner of Example 1, wherein said first reflective optical element comprises a mirror configured to be rotated.

9. The beam scanner of Example 1, wherein said first reflective optical element comprises a planar mirror.

10. The beam scanner of Example 1, wherein said first reflective optical element comprises a resonant scanning mirror and/or a linear scanning mirror.

11. The beam scanner of Example 1, further comprising a galvanometer, motor, piezoelectric actuator, or other actuator configured to rotate said first reflective optical element to scan said first reflective optical element through said range of angles.

12. The beam scanner of Example 1, wherein said first reflective optical element is configured to scan through said range of angles at a scan rate of at least 1 kHz.

13. The beam scanner of Example 1, wherein said first reflective optical element is configured to scan through said range of angles at a scan rate from 1 kHz to 100 kHz.

14. The beam scanner of Example 1, wherein said first reflective optical element is configured to scan a beam through said first range of angles at a scan rate of at least 1 kHz.

15. The beam scanner of Example 1, wherein said first reflective optical element is configured to scan a beam through said first range of angles at a scan rate from 1 kHz to 100 kHz.

16. The beam scanner of Example 1, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

17. The beam scanner of Example 1, wherein said first reflective optical element is configured to be scanned about a first axis oriented in a first direction (Y direction) and said second reflective optical element is configured to be scanned about a second axis oriented in a second direction (X direction) that is orthogonal to the first direction.

18. The beam scanner of Example 1, wherein said first reflective optical element comprises a beam steerer.

19. The beam scanner of Example 18, wherein said beam steerer comprises a rotating mirror.

20. The beam scanner of Example 18, wherein said beam steerer comprises a MEMs mirror.

21. The beam scanner of Example 18, wherein said beam steerer comprises an active diffractive optical element or a phase array.

22. The beam scanner of Example 18, wherein said beam steerer comprises an acousto-optical modulator.

23. The beam scanner of Example 18, wherein said beam steerer comprises a liquid crystal spatial light modulator, MEMS mirror array, or an electrowetting prism arrays.

24. The beam scanner of Example 18, wherein said beam steerer is electrically connected to control electronics configured to cause said beam reflected from said first reflective optical element to be scanned.

25. The beam scanner of Example 1, further comprising control electronics configured to cause said beam reflected from said first reflective optical element to be scanned.

26. The beam scanner of Example 25, wherein said control electronics is configured to cause said first reflective optical element to be rotated.

27. The beam scanner of Example 1, wherein said second reflective optical element is configured to rotate such that said light beam reflected therefrom is scanned.

28. The beam scanner of Example 1, wherein said second reflective optical element comprises a mirror.

29. The beam scanner of Example 1, wherein said second reflective optical element comprises a planar mirror.

30. The beam scanner of Example 1, wherein said second reflective optical element is configured to be scanned.

31. The beam scanner of Example 1, wherein said second reflective optical element is configured to be rotated by a galvanometer, motor, piezoelectric actuator or other actuator.

32. The beam scanner of Example 1, wherein said second reflective optical element comprises a MEMs mirror.

33. The beam scanner of Example 1, wherein said second reflective optical element comprises a dual axis mirror.

34. The beam scanner of Example 1, wherein said second reflective optical element is configured to scan through said a range of angles at a scan rate from 2 Hz to 100 kHz.

35. The beam scanner of Example 1, wherein said second reflective optical element is configured to scan a beam at a scan rate from 2 Hz to 100 kHz.

36. The beam scanner of Example 1, wherein said second reflective optical element comprises a beam steerer.

37. The beam scanner of Example 36, wherein said beam steerer comprises a rotating mirror.

38. The beam scanner of Example 36, wherein said beam steerer comprises an active diffractive optical element or a phase array.

39. The beam scanner of Example 36, wherein said beam steerer comprises an acousto-optical modulator.

40. The beam scanner of Example 36, wherein said beam steerer comprises a liquid crystal spatial light modulator, MEMS mirror array, or an electrowetting prism array.

41. The beam scanner of Example 36, wherein said beam steerer is electrically connected to control electronics configured to cause the beam reflected from said second reflective optical element to be scanned.

42. The beam scanner of Example 1, further comprising control electronics configured to cause said beam reflected from said second reflective optical element to be scanned.

43. The beam scanner of Example 42, wherein said control electronics is configured to cause said second reflective optical element to be rotated.

44. The beam scanner of Example 1, wherein said second reflective optical element is not a retroreflector or part of a retroreflector.

45. The beam scanner of Example 1, wherein said first lens comprises a positive lens.

46. The beam scanner of Example 1, wherein said first lens does not comprise a lens array or is not included in a lens array.

47. The beam scanner of Example 1, wherein said beam scanner does not include a lens array.

48. The beam scanner of Example 1, wherein said first lens comprises a telecentric lens.

49. The beam scanner of Example 1, wherein said first lens has a focal length and is positioned a focal length away from said first reflective optical element.

50. The beam scanner of Example 2, wherein said first reflective optical element is configured to rotate through said range of angles around an axis of rotation and said first lens has a focal length and is positioned a focal length away from the axis of rotation of said first reflective optical element.

51. The beam scanner of Example 1, wherein said first lens has a front and back and first and second sides on each of said front and back, said first lens disposed to receive a ray of light reflected from said first reflective optical element on said first side of said front of said first lens such that said ray of light is transmitted through said first side of said first lens and exits said first side on said back of said first lens.

52. The beam scanner of Example 51, wherein said second reflective optical element is disposed to receive said ray of light from said first side of said back of said first lens and to reflect said ray of light back to said first lens on said second side of said back of said lens such that said ray of light that transmitted through said first side of said first lens is transmitted through said second side of said first lens back to said first reflective optical element to be reflected therefrom a second time.

53. The beam scanner Example 52, wherein said first lens has an optical axis and a focal length and said first lens is positioned with respect to said first reflective optical element such that said ray of light reflected off said first reflective optical element to said first side of said front of said first lens said first time is incident on said first side of the front of said first lens at an angle and is refracted by said first lens such that said ray of light that is incident on said first side of said front of said first lens exits said first side of said back of said first lens and propagate parallel to said optical axis.

54. The beam scanner of Example 51, wherein said ray of light is a chief ray of a light beam.

### Second Lens

55. The beam scanner of Example 1, wherein said second lens is in an optical path between said first lens and said second reflective optical element.

56. The beam scanner of Example 1, wherein said second lens has a focal length and is positioned a focal length away from said second reflective optical element.

57. The beam scanner of Example 1, wherein said first and second lenses each have an optical axis, central axis, axis of symmetry, center, mechanical center, or any combination thereof that are offset with respect to each other in a lateral direction.

58. The beam scanner of Example 57, wherein said lateral direction is along the direction of an axis of rotation about which said light beam reflected from said first reflective optical element said first time is scanned by said first reflective optical element.

59. The beam scanner of Example 57, wherein said lateral direction is along the direction of an axis of rotation about which said first reflective optical element is rotated.

60. The beam scanner of Example 57, further comprising a pick-off reflector to extract an output beam.

61. The beam scanner of Example 60, wherein said pick-off reflector is between said first and second lenses.

62. The beam scanner of Example 1, wherein said second lens comprises a telecentric lens.

63. The beam scanner of Example 1, wherein said second lens has a front and back and first and second sides on each of said front and back and said second lens is disposed to receive a ray of light reflected off said first reflector said first time that is transmitted through a first side of said front of said first lens such that said ray of light reflected off said first reflector and transmitted through said first side of said front to said first lens is incident on and transmitted through said first side of said second lens, reflected from said second reflector and is incident on and transmitted through said second side of said second lens and said second side of said first lens back to said first reflector.

64. The beam scanner of Example 1, wherein said second lens has an optical axis and a focal length and is positioned such that said ray of light reflected off said first reflector and transmitted through said first side of said front of said first lens is incident on said first side of said second lens parallel to said optical axis of said second lens and is refracted by said second lens at an angle and reflected from said second reflector at an angle with respect thereto.

65. The beam scanner of Example 64, wherein said ray of light reflected from said second reflector at an angle with respect thereto is incident on said second side of said second lens at an angle and refracted by said second lens parallel to the optical axis of said second lens and propagated to said first lens and is incident on said second side of said first lens parallel to the optical axis of said first lens.

66. The beam scanner of Example 65, wherein said ray of light reflected from said second reflector at an angle with respect thereto that is transmitted through said second side of said second lens and propagated from said second lens to said first lens parallel to the optical axis of said first and second lenses is transmitted through and refracted by said first lens such that said ray of light is incident on said first reflector at an angle such that said ray of light is reflected off said first reflector said second time and scanned over said second range of angles.

67. The beam scanner of Example 63, wherein said ray of light is a chief ray of a light beam.

### Laser

68. The beam scanner of Example 1, further comprising a light source configured to output said light beam that is directed to said first reflective optical element said first time.

69. The beam scanner of Example 68, further comprising a beamsplitter disposed to receive said light beam output by said light source and direct said light beam from said light source to said first reflective optical element.

70. The beam scanner of Example 69, wherein said beamsplitter is disposed to receive said light beam reflected from said first reflective optical element after being reflected by said first reflective optical element to said second reflective optical element and back to said first reflective optical element.

71. The beam scanner of Example 69, wherein said beamsplitter is disposed in an optical path between said light source and said first scanning reflector.

72. The beam scanner of Example 69, wherein said beamsplitter comprises a non-polarizing beamsplitter.

73. The beam scanner of Example 69, wherein said beamsplitter comprises a polarization beamsplitter.

74. The beam scanner of Example 73, further comprising a quarter wave retarder disposed between said polarization beamsplitter and said second reflective optical element configured to rotate linearly polarized light by about 90°.

75. The beam scanner of Example 74, wherein said quarter wave retarder is disposed between said first reflective optical element and said second reflective optical element.

76. The beam scanner of Example 69, further comprising a microscope objective disposed to receive from said beamsplitter said light beam reflected from said first reflective optical element directed to said beamsplitter.

77. The beam scanner of Example 76, further comprising at least one lens in an optical path between said first reflective optical element and said microscope objective.

78. The beam scanner of Example 77, wherein said at least one lens comprises a scan lens in the optical path between said first scanning reflector and said beamsplitter.

79. The beam scanner of Example 77, wherein said at least one lens comprises a tube lens in said optical path between said beamsplitter and said microscope objective.

80. The beam scanner of Example 77, wherein said at least one lens comprises a first and second lenses that form an afocal relay between said first reflective optical element and said microscope objective.

81. The beam scanner of Example 80, wherein said first and second lenses that form an afocal relay each have focal length and said first and second lenses are separated by the sum of said focal lengths.

82. The beam scanner of Example 80, further comprising a focusing lens disposed to receive said light beam output by said light source and to focus said light beam onto a focal point of said first and second lenses of said plurality of lenses.

83. The beam scanner of Example 76, further comprising an optical detector and a beamsplitter disposed in an optical path between said microscope objective and said optical detector and in an optical path between said microscope objective and said first reflective optical element.

84. The beam scanner of Example 68, wherein said light source comprises a laser configured to output a laser beam that is directed to said first reflective optical element.

### Laser Scanning Microscope

85. The beam scanner of Example 1, further comprising a microscope objective disposed to receive said light beam reflected from said first reflective optical element said second time after being reflected by said first reflective optical element said first time to said second reflective optical element and back to said first reflective optical element said second time.

86. The beam scanner of Example 85, further comprising a beamsplitter disposed in an optical path between said first reflective optical element and said microscope objective.

87. The beam scanner of Example 1, wherein said beam scanner is included in a laser scanning microscope.

88. The beam scanner of Example 1, wherein said beam scanner is included in a scanning fluorescence microscope.

89. The beam scanner of Example 1, wherein said beam scanner is included in a laser scanner that is not a microscope.

90. The beam scanner of Example 1, wherein said first reflective optical element is configured to rotate back and forth.

91. The beam scanner of Example 1, wherein said first reflective optical element is configured to spin around multiple times thereby rotating.

92. The beam scanner of Example 1, wherein said beam scanner configured such that said light beam reflected therefrom said first time is scanned over said first range of angles at said first scan rate, and said light beam reflected off said first reflective optical element said second time is scanned over said second range of angles at a second scan rate, wherein second scan rate is the same as the first scan rate.

93. The beam scanner of Example 1, wherein said beam scanner does not include a retroreflector.

94. The beam scanner of Example 1, wherein said first and second lenses each have an optical axis, central axis, axis of symmetry, center, mechanical center, or any combination thereof that are aligned with respect to each other in a lateral direction.

95. The beam scanner of Example 1, wherein said first and second lenses each have an optical axis, central axis, axis of symmetry or any combination thereof that are collinear with respect to each other.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. A beam scanner comprising:
a first reflective optical element disposed to receive a light beam and reflect said light beam a first time, said first reflective optical element configured to cause said light beam reflected therefrom said first time to be scanned over a first range of angles;
a first lens disposed to receive said light beam reflected from said first reflective optical element such that said light beam is transmitted through said first lens;
a second lens disposed to receive said light beam transmitted through said first lens, said second lens not comprising a lens array and not being included in a lens array; and
a second reflective optical element disposed to receive said light beam transmitted through said second lens and to reflect said light back to said second lens such that said light is transmitted through said first lens back to said first reflective optical element to be reflected therefrom a second time thereby being scanned over a second range of angles larger than said first range of angles.

2. The beam scanner of claim 1, wherein said first reflective optical element is configured to rotate through a range of angles such that said light beam reflected therefrom said first time is scanned over said first range of angles.

3. The beam scanner of claim 2, wherein said first range of angles is twice said range of angles that said first reflective optical element is rotated.

4. The beam scanner of claim 2, wherein said second range of angles is four times said range of angles that said first reflective optical element is rotated.

5. The beam scanner of claim 1, wherein said first reflective optical element is configured to scan through said range of angles at a scan rate from 1 kHz to 100 kHz.

6. The beam scanner of claim 1, wherein said first reflective optical element is configured to scan a beam about a first axis oriented in a first direction (Y direction) and said second reflective optical element is configured to scan said beam about a second axis oriented in a second direction (X direction) that is orthogonal to the first direction.

7. The beam scanner of claim 1, wherein said first reflective optical element comprises a beam steerer.

8. The beam scanner of claim 1, wherein said first lens does not comprise a lens array or is not included in a lens array.

9. The beam scanner of claim 1, wherein said second reflective optical element comprises a mirror.

10. The beam scanner of claim 1, wherein said second reflective optical element is configured to be rotated by a galvanometer, motor, piezoelectric actuator or other actuator.

11. The beam scanner of claim 1, wherein said second reflective optical element comprises a MEMs mirror.

12. The beam scanner of claim 1, wherein said second reflective optical element is not a retroreflector or part of a retroreflector.

13. The beam scanner of claim 1, further comprising a microscope objective disposed to receive said light beam reflected from said first reflective optical element said second time after being reflected by said first reflective optical element said first time to said second reflective optical element and back to said first reflective optical element said second time.

14. The beam scanner of claim 1, wherein said beam scanner is included in a laser scanning microscope.

15. The beam scanner of claim 1, wherein said beam scanner is included in a scanning fluorescence microscope.
